(19) United States
(12) Patent Application Publication
(10) Pub. No.: US 2014/0176007 A1
(43) Pub. Date: Jun. 26, 2014

(54) LIGHT EMITTING APPARATUS FOR METHOD OF MANUFACTURING AND USING THE SAME

(71) Applicant: Alva Systems Inc., Alameda, CA (US)

(72) Inventors: Bradford K. Whitaker, San Francisco, CA (US); Kenneth Brwonlee, Alameda, CA (US); Michael Brownlee, Alameda, CA (US)

(21) Appl. No.: 14/192,707

(22) Filed: Feb. 27, 2014

Related U.S. Application Data
(63) Continuation of application No. 13/372,485, filed on Feb. 13, 2012, now abandoned.
(60) Provisional application No. 61/442,329, filed on Feb. 14, 2011.
(60) Provisional application No. 61/453,364, filed on Mar. 16, 2011.

(51) Int. Cl. H05B 37/02

(52) U.S. Cl. CPC H05B 37/02
USPC 315/291

(57) ABSTRACT

An apparatus includes a load circuit operatively coupled to a controller circuit through a drive circuit. The drive circuit provides a drive signal to the load circuit in response to receiving a digital indication from the controller circuit. The load circuit includes first and second light emitting sub-circuits connected in parallel. The first and second light emitting sub-circuits provide first and second spectrums of light, respectively.

### CROSS-REFERENCE TO RELATED APPLICATIONS

This application is a continuation of U.S. patent application Ser. No. 13/372,485, which was filed on Feb. 13, 2012, which claims a benefit of priority from U.S. Provisional Application No. 61/442,329 filed Feb. 14, 2011 and U.S. Provisional Application No. 61,453,364, filed Mar. 16, 2011 and are incorporated by reference in this application in their entirety.

### BACKGROUND OF THE INVENTION

1. Field of the Invention

This invention relates generally to electrical circuits which emit light.

2. Description of the Related Art

It is desirable to provide different spectrums of light for many different applications, such as lighting. Some lighting systems include high power light emitters, such as incandescent and fluorescent lights, and others include lower power light emitters, such as light emitting diodes (LEDs). Examples of lighting systems which include LEDs are disclosed in U.S. Pat. Nos. 7,161,311, 7,274,160, 7,321,203 and 7,572,028, as well as U.S. Patent Application No. 20070103942. While these lighting systems may be useful for their intended purposes, it is highly desirable to have a lighting system which can provide more controllable lighting.

### BRIEF SUMMARY OF THE INVENTION

The present invention is directed to a light emitting apparatus which provides more controllable lighting. The novel features of the invention are set forth with particularity in the appended claims. The invention will be best understood from the following description when read in conjunction with the accompanying drawings. Various embodiments of the light emitting apparatus are disclosed. In one embodiment, the light emitting apparatus includes a controller circuit configured to generate a control signal including a first portion for a first light intensity and a second portion for a second light intensity. A drive circuit generates a composite drive signal based on the control signal. The composite drive signal includes a first waveform greater than a zero voltage based on the first portion of the control signal and a second waveform less than the zero voltage based on the second portion of the control signal. A load circuit is coupled to the drive circuit and is configured to illumine a first portion of a light emitting device based on the first waveform and illumine a second portion of the light emitting device based on the second waveform.

### BRIEF DESCRIPTION OF THE DRAWINGS

Like reference characters are used throughout the several views of the drawings.

FIGS. 1a and 1b are block diagrams of embodiments of a light emitting apparatus.

FIG. 1c is a block diagram of one embodiment of a controller circuit of the light emitting apparatus of FIGS. 1a and 1b.

FIGS. 1d and 1e are perspective and top views, respectively, of one embodiment of the controller circuit of FIG. 1c.

FIGS. 1f, 1g and 1h are block diagrams of other embodiments of the light emitting apparatus of FIGS. 1a and 1b.

FIG. 2a is a graph which includes examples of a positive unipolar analog signal S_{AC1} and negative unipolar analog signal S_{AC2}.

FIG. 2b is a graph of an example of a bipolar analog signal S_{AC3}.

FIG. 2c is a graph which includes examples of a positive unipolar digital signal S_{DC1} and negative unipolar digital signal S_{DC2}.

FIG. 2d is a graph of an example of a bipolar digital signal S_{DC3}.

FIG. 2e is a graph of an example of a positive unipolar digital signal S_{DC4} having a fifty percent (50%) duty cycle.

FIG. 2f is a graph of an example of a positive unipolar digital signal S_{DC5} having a duty cycle that is less than fifty percent (50%).

FIG. 2g is a graph of an example of a positive unipolar digital signal S_{DC6} having a duty cycle that is greater than fifty percent (50%).

FIG. 2h is a graph of an example of positive unipolar digital signal S_{DC6} having a duty cycle that is equal to fifty percent (=50%).

FIG. 2i is a graph of an example of positive unipolar digital signal S_{DC7} having a duty cycle that is equal to fifty percent (=50%).

FIG. 2j is a graph 146c of an example of positive bipolar digital signal S_{DC9} having a duty cycle that is equal to fifty percent (=50%).

FIG. 3a is a more detailed block diagram of an embodiment of the light emitting apparatus of FIG. 1b.

FIG. 3b is a more detailed block diagram of an embodiment of the light emitting apparatus of FIG. 1b.

FIG. 3c is an embodiment of a load circuit.

FIG. 4a is a circuit diagram of one embodiment of the light emitting apparatus of FIG. 3a.

FIG. 4b is a circuit diagram of one embodiment of the load circuit of FIG. 4a, wherein N=5 and M=1 so that diode string D_{A} includes five diodes D_{A1}, D_{A2}, D_{A3}, D_{A4} and D_{A5} connected in series and diode string D_{B} includes one diode D_{B1}.

FIG. 4c is a circuit diagram of another embodiment of the load circuit of FIG. 4a, wherein N=5 and M=1 so that diode string D_{A} includes five diodes D_{A1}, D_{A2}, D_{A3}, D_{A4} and D_{A5} connected in series and diode string D_{B} includes one diode D_{B1}.

FIG. 4d is a circuit diagram of another embodiment of the light emitting apparatus of FIG. 4a.

FIG. 4e is a circuit diagram of another embodiment of the load circuit of FIG. 4a, wherein N=5 and M=1 so that diode string D_{A} includes five diodes D_{A1}, D_{A2}, D_{A3}, D_{A4} and D_{A5} connected in series and diode string D_{B} includes one diode D_{B1}.

FIG. 5a is a circuit diagram of another embodiment of the light emitting apparatus of FIG. 3.

FIG. 5b is a circuit diagram of one embodiment of the load circuit of FIG. 5a, wherein N=3 and M=2 and L=1 so that diode string D_{A} includes three diodes D_{A1}, D_{A2} and D_{A3} connected in series and diode string D_{B} includes two diodes D_{B1} and D_{B2} connected in series and diode string D_{C} includes one diode D_{C1}.

FIG. 6a is a circuit diagram of another embodiment of the light emitting apparatus of FIG. 3.

FIG. 6b is a circuit diagram of one embodiment of the load circuit of FIG. 6a, wherein N=2 and M=3 and L=2 so that diode string D_{A} includes two diodes D_{A1} and D_{A2} connected in series and diode string D_{B} includes three diodes D_{B1}, D_{B2} and D_{B3} connected in series and diode string D_{C} includes two diodes D_{C1} and D_{C2}.

FIGS. 7, 8a and 8b are circuit diagrams of embodiments of a light emitting apparatus.

FIG. 9 is a circuit diagram of one embodiment of a load circuit.

FIGS. 10a, 10b, 10c and 10d are graphs of examples of multi-level D_{C} signal S_{DC10}, S_{DC11}, S_{DC12} and S_{DC13}, respectively.

FIG. 11a is a graph of an example of a positive unipolar digital signal S_{DC7} having a fifty percent (50%) duty cycle.

FIG. 11b is a graph of an example of a digital signal S_{Digital1} shown with positive unipolar digital signal S_{DC7a} (in phantom) of FIG. 11a.

FIG. 11c is a graph of an example of a digital signal S_{Digital2} shown with positive unipolar digital signal S_{DC7b} (in phantom) of FIG. 11a.

FIG. 11d is a graph of an example of a digital signal S_{Digital3} shown with positive unipolar digital signal S_{DC7c} (in phantom) of FIG. 11a.

FIG. 12a is a graph of an example of a bipolar digital signal S_{DC8}.

FIG. 12b is a graph of an example of a digital signal S_{Digital4} shown with signal S_{DC8a} (in phantom) and S_{DC8b} (in phantom) of FIG. 12a.

FIG. 12c is a graph of an example of a digital signal S_{Digital5} shown with signal S_{DC8c} (in phantom) and S_{DC8d} (in phantom) of FIG. 12a.

FIG. 12d is a graph of an example of a digital signal S_{Digital6} shown with signal S_{DC8e} (in phantom) and S_{DC8f} (in phantom) of FIG. 12a.

FIG. 13a is a graph of an example of a digital signal S_{Digital7} shown with signal S_{DC8a} (in phantom) and S_{DC8b} (in phantom) of FIG. 12a.

FIG. 13b is a graph of an example of a digital signal S_{Digital8} shown with signal S_{DC8c} (in phantom) and S_{DC8d} (in phantom) of FIG. 12a.

FIG. 13c is a graph of an example of a digital signal S_{Digital9} shown with signal S_{DC8e} (in phantom) and S_{DC8f} (in phantom) of FIG. 12a.

### DETAILED DESCRIPTION OF THE INVENTION

Some embodiments of the present invention are directed towards a lighting system which emulates an incandescent lamp's dimming characteristic of shifting from a colder color to a warmer color when dimmed. The dimming occurs in a controlled manner so that the amount of warm and cold colors provided is controlled, and can be adjusted. In some embodiments, the lighting system includes only two conductors, so that the lighting system can be retrofitted to existing lighting systems.

In some embodiments, the emulation is achieved by using a pulse wave modulated (PWM) dimming controller and its associated LED lamp. The controller is modified by adding a switching circuit, which provides a variable duty cycle signal and voltage potential reversing PWM signal. Different frequency spectrum (colors) yellow (warm color) LED's and white (cool color) LED's can be included in the LED lamp, and these LED's are connected in reverse polarity so that they react to the PWM signal respective of polarity (direction).

One example of this application is, as the controller dims, the cooler color LEDs receive a reduced duty cycle signal, and the warmer LEDs receives a PWM signal at a low duty cycle through the reverse polarity. As the lamp dims further, the duty cycle of the cooler color LED's continues to decrease and the warmer LED duty cycle increases, which provides a warmer color from the Lamp. The duty cycles may also be varied and controlled to energize the LED's for other beneficial effects, such as cooler component temperatures, excitation in response to a communication signal, among other effects.

It should be noted that conventional circuit symbols are included in the drawings to denote circuit elements, such as transistors and resistors. The circuit elements can be discrete circuit elements and integrated circuit elements. Discrete circuit elements are typically mounted onto a circuit board, such as a printed circuit board (PCB), and integrated circuit components are typically formed with an integrated circuit on a piece of semiconductor material.

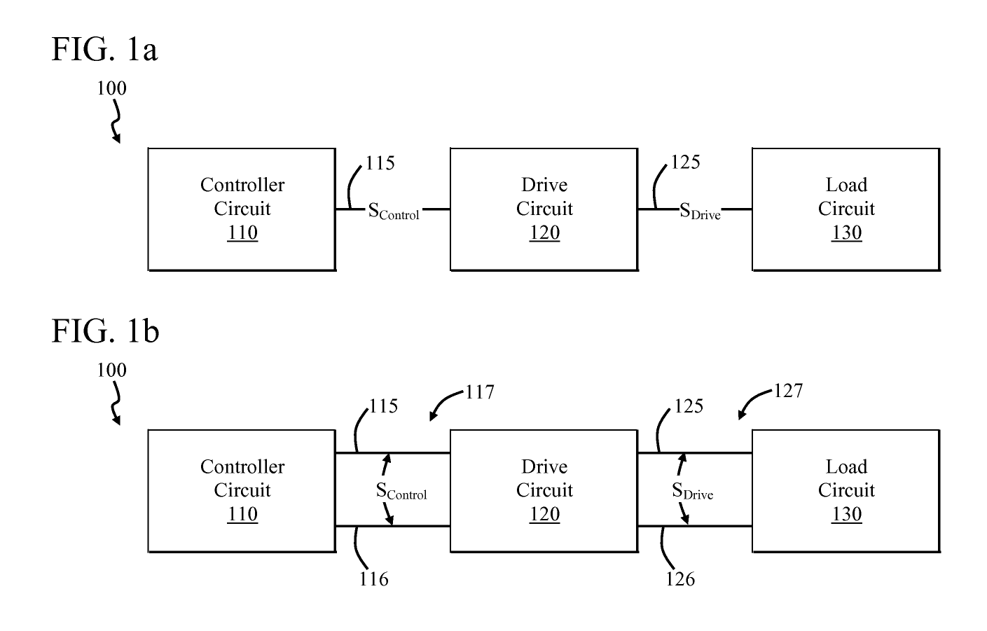

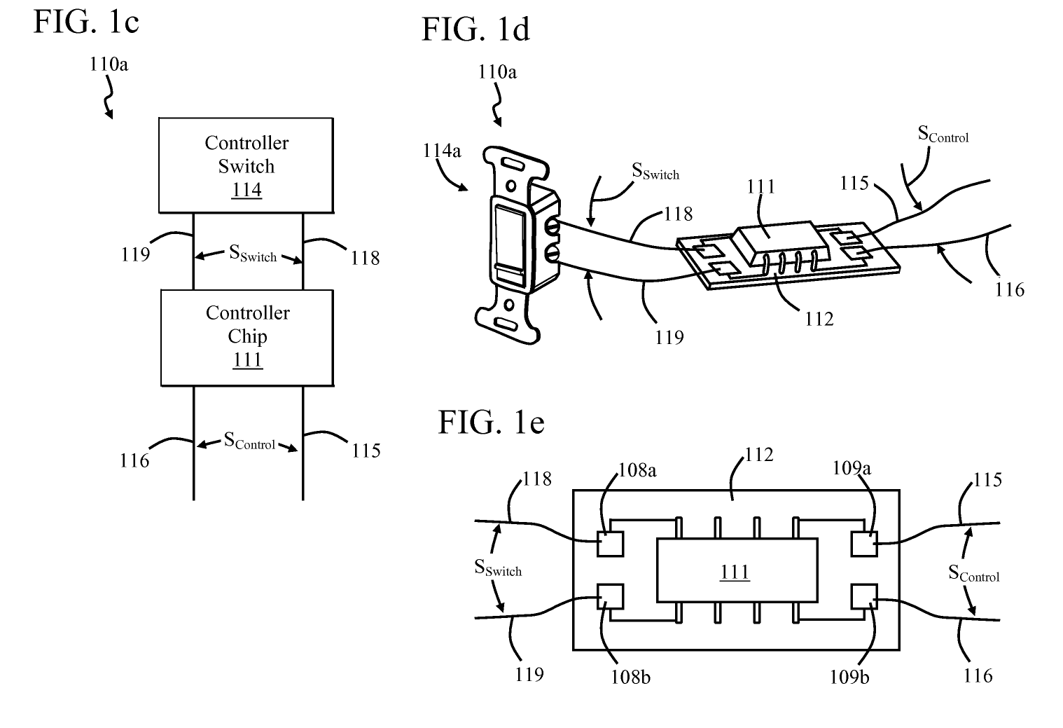

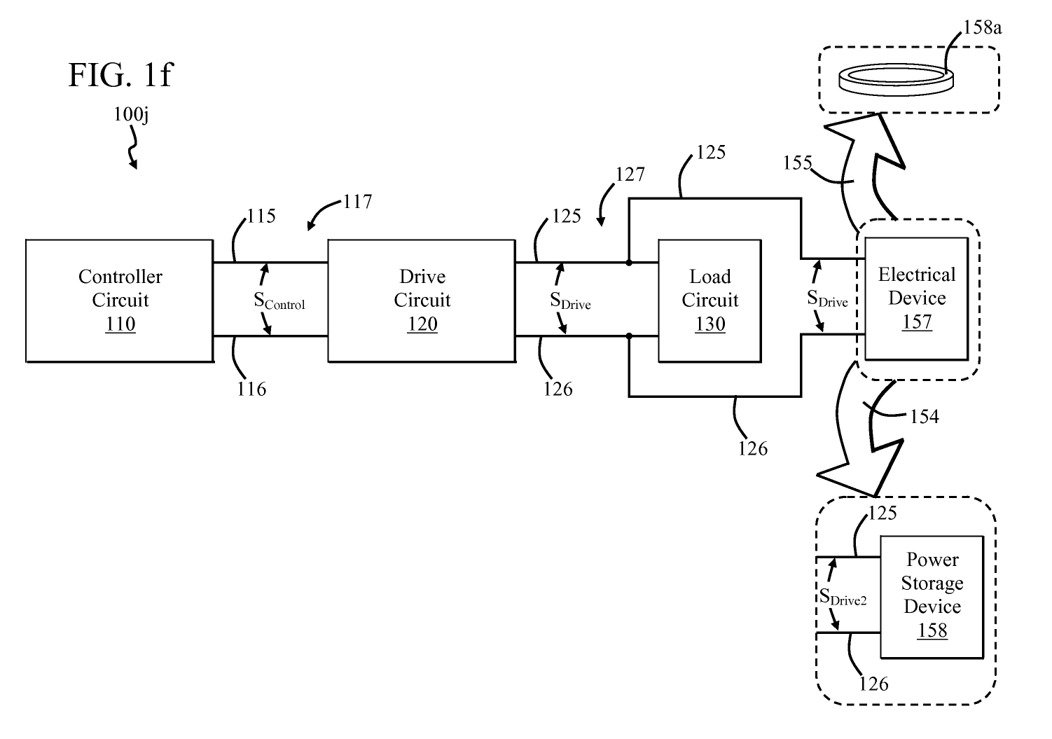

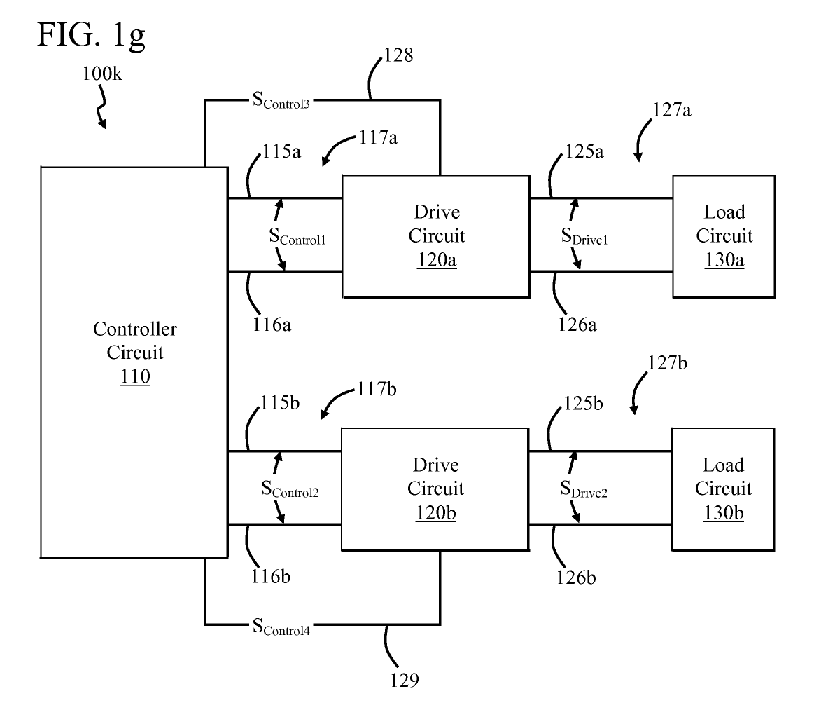

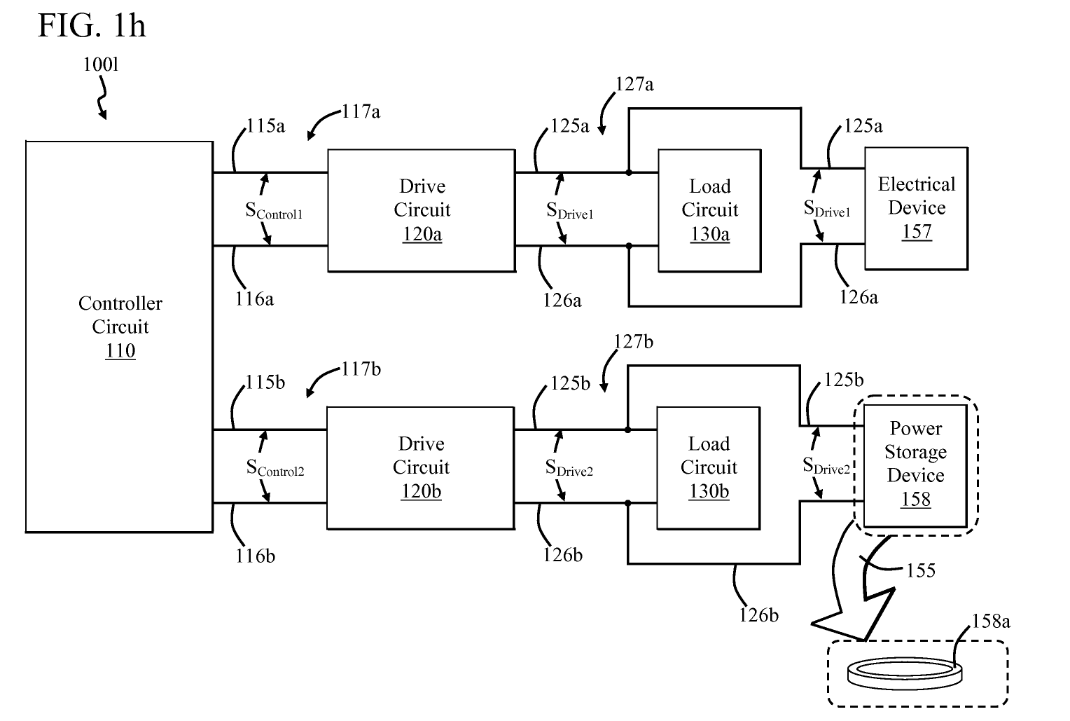

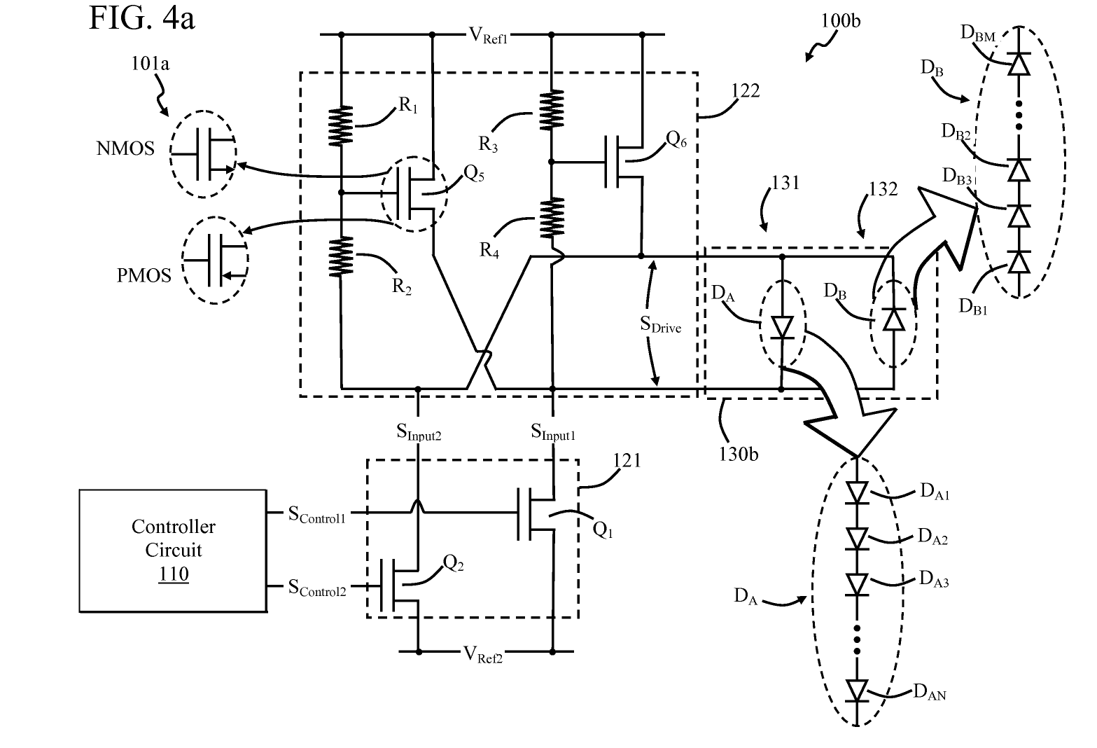

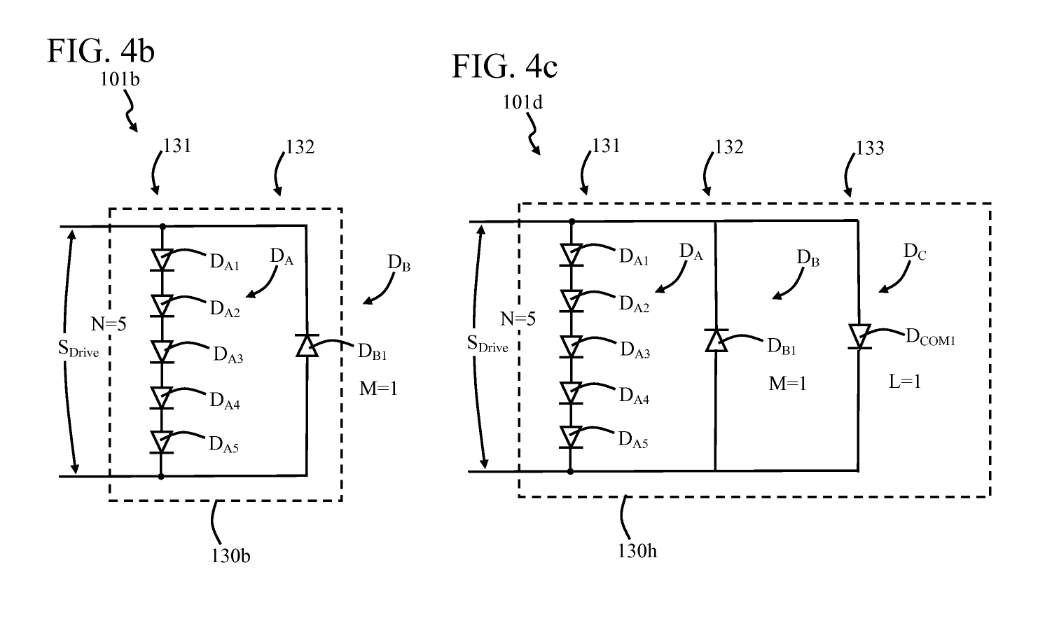

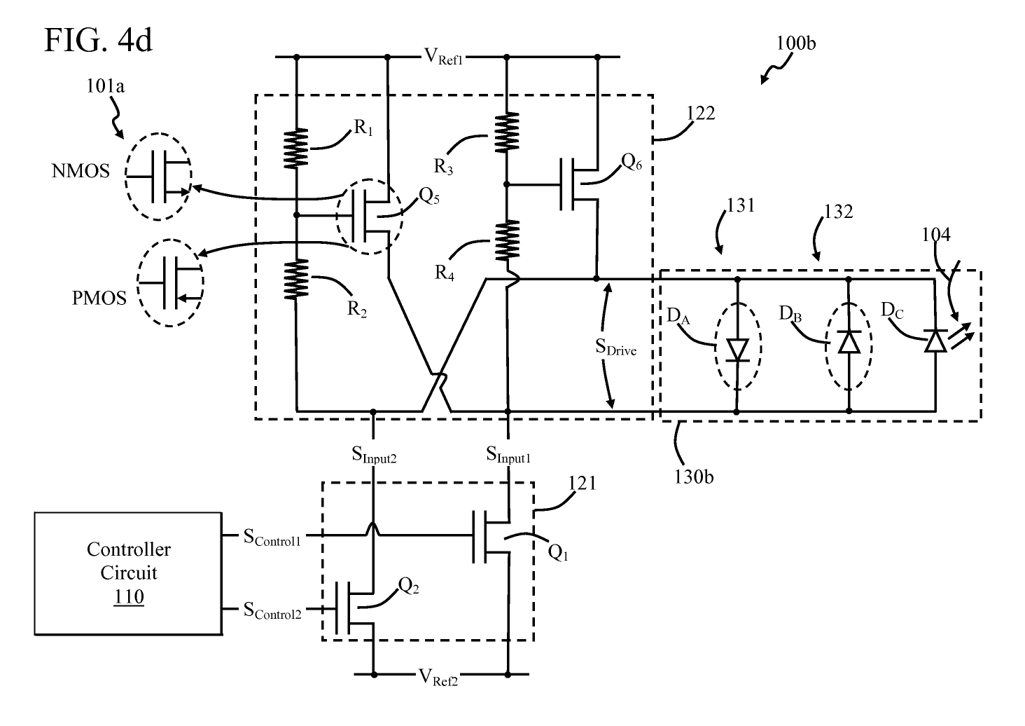

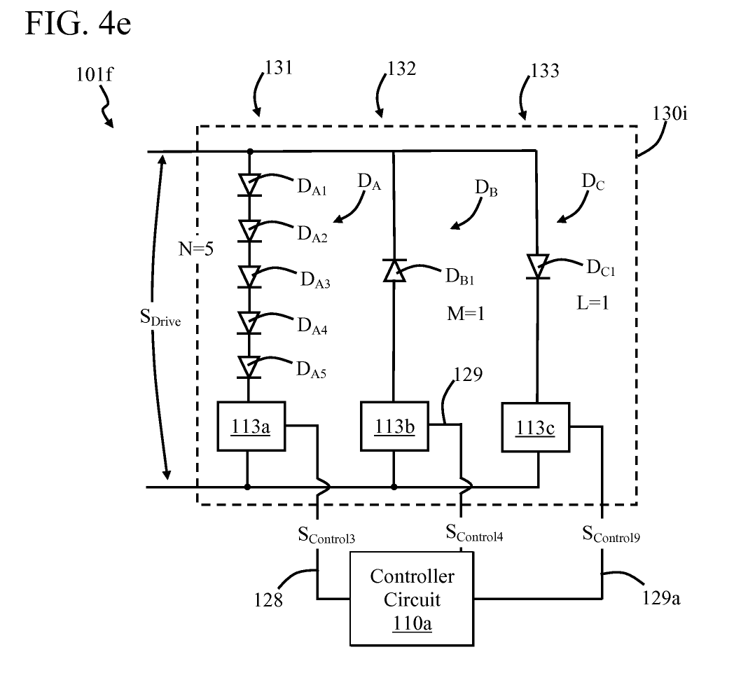

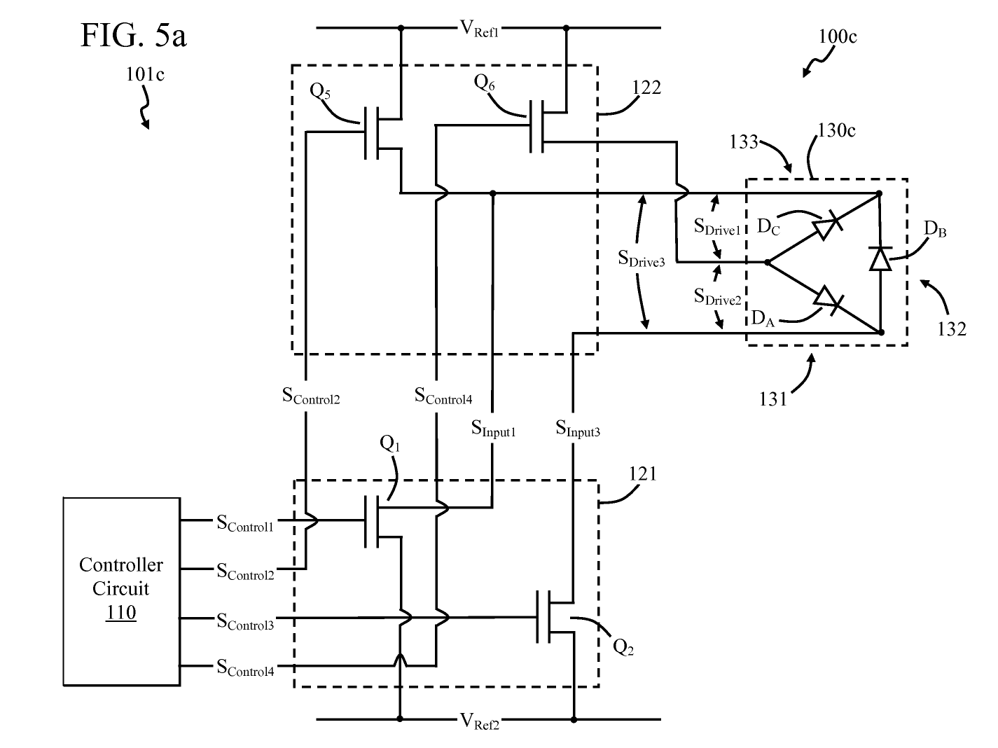

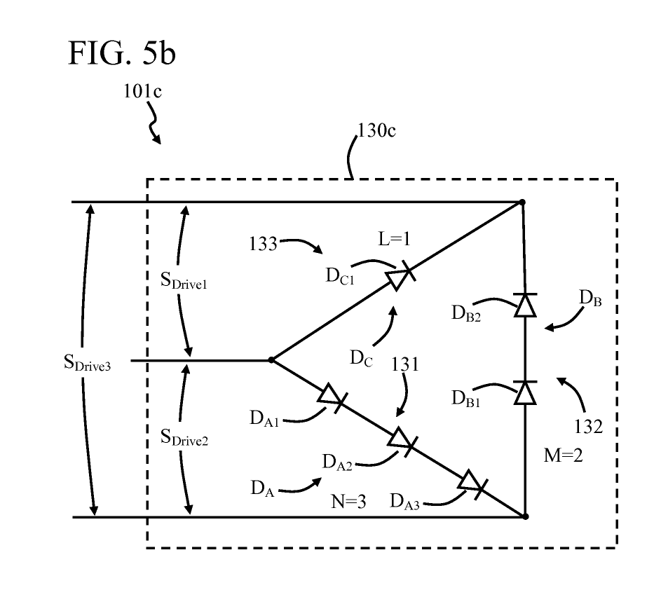

FIGS. 1a and 1b are block diagrams of embodiments of a light emitting apparatus 100. It should be noted that light emitting apparatus is powered by a power signal, which is not shown for simplicity. The power signal can be provided to light emitting apparatus 100 in many different ways. In some embodiments, the power to light emitting apparatus 100 is provided by an electrical system of a building. For example, most buildings are wired to provide an AC signal at an electrical outlet. Hence, the power signal provided to light emitting apparatus 100 can be from the AC signal of the building. In some situations, the AC signal is a 120 VAC signal and the power signal provided to light emitting apparatus 100 is a corresponding D_{C} signal that is provided by an AC-to-DC converter. However, the AC-to-DC converter is not shown for simplicity. An example of an AC-to-DC converter is disclosed in U.S. patent application Ser. No. 12/553,893, filed on Sep. 3, 2009, the contents of which are incorporated herein by reference as though fully set forth herein. Examples of AC-to-DC converters are disclosed in U.S. Pat. Nos. 5,347,211, 6,643,158, 6,650,560, 6,700,808, 6,775,163, 6,791,853 and 6,903,950, the contents of all of which are incorporated by reference as though fully set forth herein. An example of the DC signal will be discussed in more detail below, such as in FIG. 4a, wherein the DC signal is established by establishing voltages V_{Ref1} and V_{Ref2}.

In these embodiments, light emitting apparatus 100 includes a load circuit 130 operatively coupled to a controller circuit 110 through a drive circuit 120. Drive circuit 120 provides a drive signal S_{Drive} to load circuit 130 in response to a digital indication from controller circuit 110. The digital indication can be of many different types, such as a digital signal. In FIGS. 1a and 1b, the digital indication corresponds to a digital control signal, denoted as digital control signal S_{Control}.

In some embodiments, the digital indication is adjustable in response to a dimmer signal provided to controller circuit 110. The dimmer signal can be provided to controller circuit 110 in many different ways, such as by using a dimmer switch. A dimmer switch is used to adjust the intensity of a lamp. An example of a dimmer switch is disclosed in the above-referenced U.S. patent application Ser. No. 12/553,893.

The digital indication can be provided to drive circuit 120 from controller circuit 110 in many different ways. In FIG. 1a, the digital indication is provided to drive circuit 120 from controller circuit 110 through a conductive line 115 so that digital control signal S_{Control} corresponds to a first current flow. Further, in FIG. 1a, the drive signal S_{Drive} is provided to load circuit 130 from drive circuit 120 through a conductive line 125 so that the drive signal S_{Drive} corresponds to a second current flow. It should be noted that a current flow has units of Amperes.

In FIG. 1b, the digital indication is provided to drive circuit 120 from controller circuit 110 through a pair of conductive lines 117, which includes conductive lines 115 and 116, so that the digital control signal S_{Control} corresponds to a potential difference between conductive lines 115 and 116. Further, in FIG. 1b, the drive signal S_{Drive} is provided to load circuit 130 from drive circuit 120 through a pair of conductive lines 127, which includes conductive lines 125 and 126, so that the drive signal S_{Drive} corresponds to a potential difference between conductive lines 125 and 126. It should be noted that the potential difference is sometimes referred to as a voltage and has units of volts.

In some embodiments, the digital indication is a bipolar digital control signal and, in some embodiments, the drive signal is a bipolar digital drive signal. The drive circuit provides the bipolar digital drive signal in response to receiving the bipolar digital control signal provided by the controller circuit. In some embodiments, the bipolar digital drive signal is adjustable in response to adjusting the bipolar digital control signal. For example, in some embodiments, the duty cycle of the bipolar digital drive signal is adjustable in response to adjusting the duty cycle of the bipolar digital control signal. Further, in some embodiments, the frequency of the bipolar digital drive signal is adjustable in response to adjusting the frequency of the bipolar digital control signal.

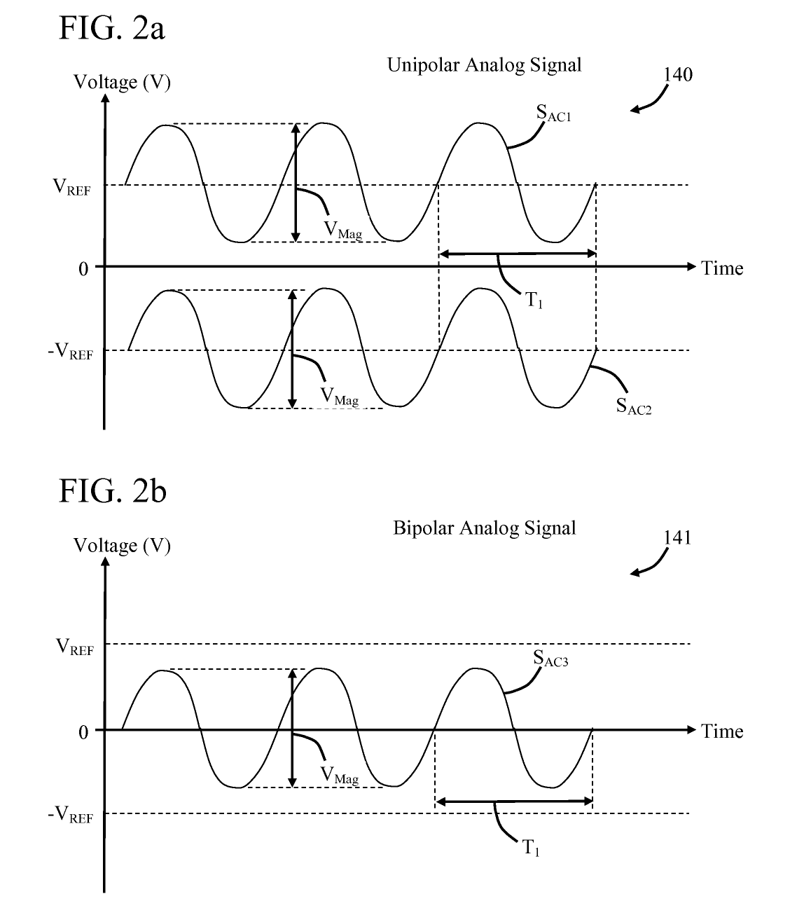

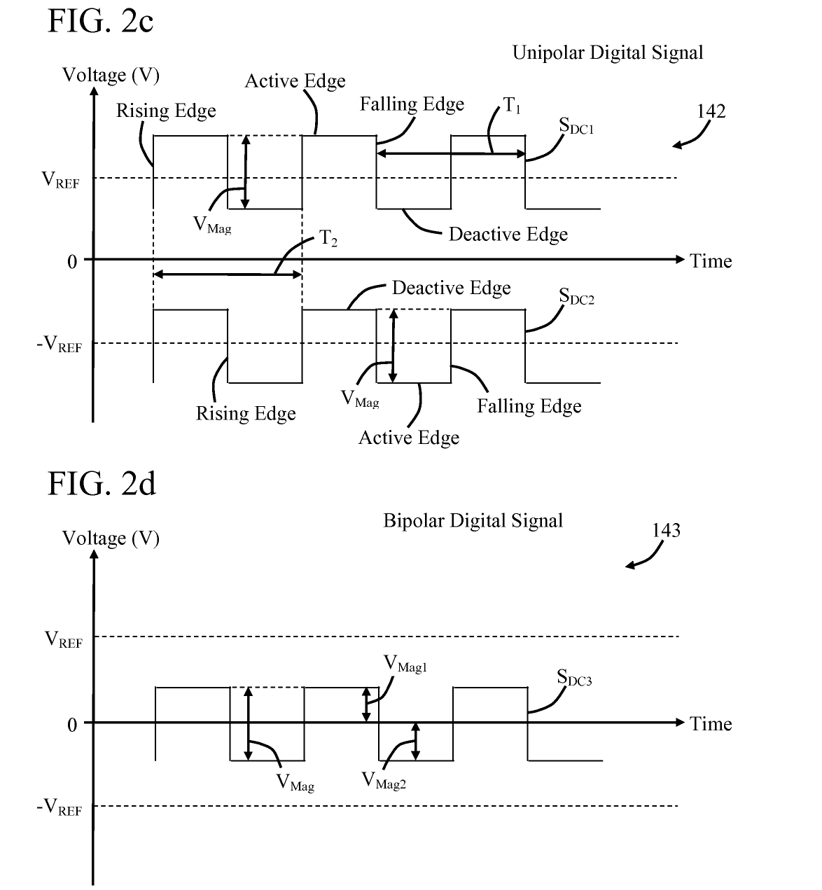

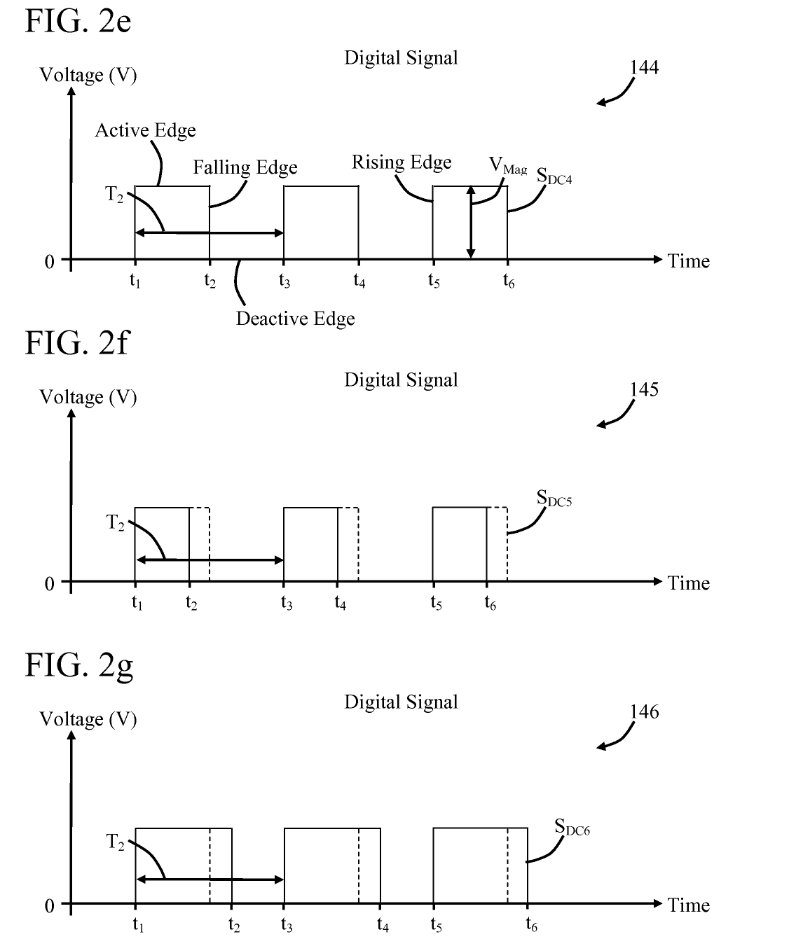

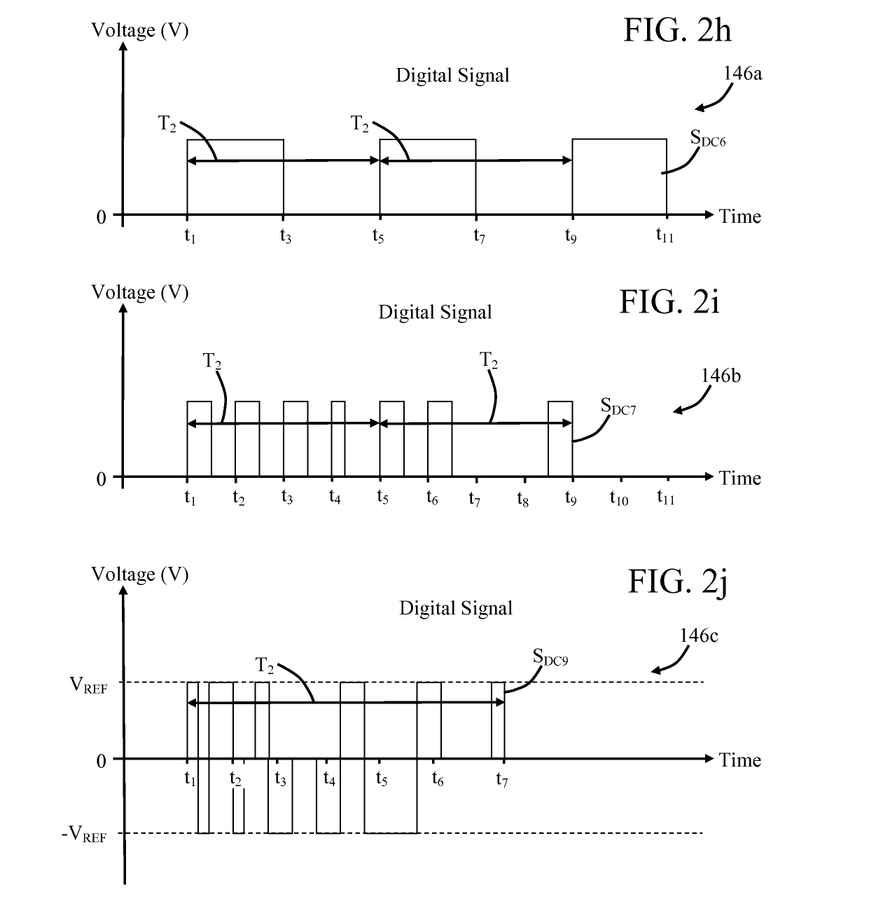

It should be noted that, in general, analog and digital signals are provided by analog and digital circuits, respectively. Information regarding analog signals is provided in more detail below with FIGS. 2a and 2b, and information regarding digital signals is provided in more detail below with FIGS. 2c, 2d, 2e, 2f and 2g. The digital signal can be of many different types, such as a unipolar digital signal and bipolar digital signal. Information regarding unipolar and bipolar digital signals is provided in more detail below with FIGS. 2c and 2d.

Load circuit 130 can be of many different types. In some embodiments, load circuit 130 includes a motor, such as an electrical motor. In some embodiments, load circuit 130 includes a linear variable differential transformer (LVDT). In some embodiments, load circuit 130 includes power storage device, such as a battery, capacitor and inductor. The inductor can be of many different types, such as a solenoid of a fan.

In the embodiments of FIGS. 1a and 1b, load circuit 130 includes a light emitting circuit, wherein the light emitting circuit includes a light emitting device, such as a light emitting diode (LED). A light emitting diode includes a pn junction formed by adjacent n-type and p-type semiconductor material layers, wherein the p-type semiconductor material layer corresponds to an anode and the n-type semiconductor material layer corresponds to a cathode. The LED flows light in response to driving a potential difference between the anode and cathode to a voltage value equal to or greater than a diode threshold voltage value. The LED is activated in response to driving the potential difference between the anode and cathode to the voltage value equal to or greater than the diode threshold voltage value. Hence, an activated LED flows light.

Further, the LED does not flow light in response to driving the potential difference between the anode and cathode to a voltage value less than the diode threshold voltage value. The LED is deactivated in response to driving the potential difference between the anode and cathode to the voltage value less than the diode threshold voltage value. Hence, a deactivated LED does not flow light. The diode threshold voltage value depends on many different properties of the LED, such as the material of the n-type and p-type semiconductor material layers. LEDs are provided by many different manufacturers, such as Cree, Inc. and Nichia Corporation. It should be noted that the diode threshold voltage value can be in many different voltage ranges. In some examples, the diode threshold voltage value is between two volts (2 V) and twenty-five volts (25 V). In one particular example, the diode threshold voltage value is twelve volts (12 V). In another example, the diode threshold voltage value is twenty-four volts (24 V). In another example, the diode threshold voltage value is three volts (3 V).

In some embodiments, load circuit 130 provides first and second frequency spectrums of light in response to receiving a bipolar digital drive signal S_{Drive} from drive circuit 120. The first and second frequency spectrums of light can be adjusted in response to adjusting bipolar digital drive signal S_{Drive}. Bipolar digital drive signal S_{Drive} can be adjusted in many different ways, such as by adjusting digital control signal S_{Control}. In this way, light emitting apparatus 100 provides controllable lighting. It should be noted that the frequency spectrum of light corresponds to the color of the light.

In some embodiments, the amount of light provided by load circuit 130 is adjustable in response to adjusting a duty cycle of drive signal S_{Drive}. The amount of light provided by load circuit 130 increases and decreases in response to decreasing and increasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100 provides controllable lighting.

FIG. 1c is a block diagram of one embodiment of controller circuit 110, which is denoted as controller circuit 110a. In this embodiment, controller circuit 110a includes a controller switch 114 operatively coupled to a controller chip 111. In particular, controller circuit 110a includes conductive lines 118 and 119 which connect controller switch 114 and controller chip 111 so that a switch signal S_{Switch} can flow therebetween. Controller chip 111 can be of many different types, such as a microcontroller. More information regarding microcontrollers is provided below. Controller chip 111 moves between activated and deactivated conditions in response to moving controller switch 114 between activated and deactivated positions, respectively. In this way, controller switch 114 is operatively coupled to controller chip 111. Controller switch 114 can be of many different types, such as an ON/OFF light switch and dimmer switch. An embodiment in which controller switch 114 is a dimmer switch will be discussed in more detail with FIGS. 1d and 1e.

In some embodiments, control switch 114 is operatively coupled to the wiring of a building. It should be noted that switch signal S_{Switch} can be a DC signal, which is provided in response to stepping down the AC power signal provided to the building. More information regarding AC and DC signals, as well as providing a DC signal from the AC signal of a building, can be found in the above-referenced U.S. patent application Ser. No. 12/553,893.

In operation, controller chip 111 establishes control signal S_{Control} between conductive lines 115 and 116 in response to adjusting switch signal S_{Switch}. In this embodiment, switch signal S_{Switch} is adjusted in response to adjusting controller switch 114. In one mode of operation, control signal S_{Control} is driven to a first predetermined value in response to moving controller switch 114 to the activated position. Further, control signal S_{Control} is driven to a second predetermined value in response to moving controller switch 114 to the deactivated position. In this way, controller chip 111 establishes control signal S_{Control} between conductive lines 115 and 116 in response to adjusting switch signal S_{Switch}. It should be noted that, in some embodiments, control signal S_{Control} is a digital control signal.

FIGS. 1d and 1e are perspective and top views, respectively, of one embodiment of controller circuit 110a of FIG. 1c. In this embodiment, controller switch 114 is embodied as a dimmer switch 114a, and controller chip 111 is carried by a circuit board 112. Circuit board 112 carries input contact pads 108a and 108b and output contact pads 109a and 109b. Conductive lines 118 and 119 are connected to corresponding terminals of dimmer switch 114a and input contact pads 108a and 108b, respectively. Contact pads 108a and 108b are connected to separate leads of controller chip 111. Conductive lines 115 and 116 are connected to output contact pads 109a and 109b, respectively, and contact pads 109a and 109b are connected to separate leads of controller chip 111.

In operation, controller chip 111 establishes control signal S_{Control} between conductive lines 115 and 116 in response to adjusting switch signal S_{Switch}. In this embodiment, switch signal S_{Switch} is adjusted in response to adjusting dimmer switch 114a. In one mode of operation, control signal S_{Control} is driven to a first predetermined value in response to moving controller switch 114 to the activated position. Further, control signal S_{Control} is driven to a second predetermined value in response to moving controller switch 114 to the deactivated position. In this way, controller chip 111 establishes control signal S_{Control} between conductive lines 115 and 116 in response to adjusting switch signal S_{Switch}. It should be noted that the value of switch signal S_{Switch} varies between voltage values because controller switch 114 is embodied as dimmer switch 114a. Hence, control signal S_{Control} can have many different values. The value of control signal S_{Control} is adjustable in response to adjusting the value of switch signal S_{Switch}.

It should be noted that, in some embodiments, dimmer switch 114a and controller chip 111 are integrated together, along with an AC-to-DC converter. Examples of such embodiments are discussed in more detail in the above-referenced U.S. patent application Ser. No. 12/553,893.

FIG. 1f is a block diagram of one embodiment of a light emitting apparatus, denoted as light emitting apparatus 100j. In this embodiment, light emitting apparatus 100j includes load circuit 130 operatively coupled to controller circuit 110 through drive circuit 120, as discussed in more detail above with FIGS. 1a and 1b.

In this embodiment, light emitting apparatus 100j includes an electrical device 157 operatively coupled to controller circuit 110 through drive circuit 120. Electrical device 157 can be operatively coupled to controller circuit 110 through drive circuit 120 in many different ways. In this embodiment, electrical device 157 is connected to conductive lines 125 and 126 so that electrical device 157 receives drive signal S_{Drive}. Electrical device 157 operates in response to receiving drive signal S_{Drive}.

Electrical device 157 can be of many different types of electrical devices, such as an appliance. Electrical device 157 can include many different components, such as an electrical circuit. In some embodiments, the electrical circuit includes a computer chip, such as a transceiver and microcontroller, which is capable of flowing a communication signal. Transceivers and microcontrollers are manufactured by many different companies, such as Analog Devices of Cambridge, Mass. and NXP Semiconductors of Eindhoven, The Netherlands. Some types of transceivers manufactured by NXP include the GreenChip series of transceivers, such as the SPR TEA1716, SPF TEA172x, SPF TES1731 and TEA 1792 products. Some types of microcontrollers manufactured by NXP include the LPC2361FBD100 and LPC1857FBD208 products.

In some embodiments, electrical device 157 is a power storage device 158, as indicated by an indication arrow 154 in FIG. 1f. Electrical device 157 can be many different types of power storage devices, such as a battery, capacitor and inductor. The battery can be of many different types, such as a rechargeable battery. Examples of rechargeable batteries include lithium-ion batteries and button cell batteries. A button cell battery 158a is indicated by an indication arrow 155 in FIG. 1f. It should be noted that power storage device 158 is charged in response to receiving drive signal S_{Drive} during normal operation. It should also be noted that power storage device 158 can provide signal S_{Drive} to load circuit 130, such as when the DC signal provided to drive circuit 120 is driven to zero volts. The DC signal provided to drive circuit 120 is driven to zero volts such as in a power outage. In this way, power storage device 158 can provide back-up power to load circuit 130.

As mentioned above, electrical device 157 can include an inductor. The inductor can be of many different types, such as a solenoid of a fan. In the inductor embodiments, the fan can be used to remove heat from load circuit 130. It should be noted that the fan operates in response to receiving drive signal S_{Drive}.

Drive circuit 120 provides drive signal S_{Drive} to load circuit 130 in response to a digital indication from controller circuit 110. The digital indication can be of many different types, such as a digital signal. In FIGS. 1a and 1b, the digital indication corresponds to a digital control signal, denoted as digital control signal S_{Control}.

In some embodiments, the digital indication is adjustable in response to a dimmer signal provided to controller circuit 110. The dimmer signal can be provided to controller circuit 110 in many different ways, such as by using a dimmer switch. A dimmer switch is used to dim a light. An example of a dimmer switch is disclosed in U.S. patent application Ser. No. 12/553,893, filed on Sep. 3, 2009, the contents of which are incorporated herein by reference as though fully set forth herein.

The digital indication can be provided to drive circuit 120 from controller circuit 110 in many different ways. In FIG. 1a, the digital indication is provided to drive circuit 120 from controller circuit 110 through a conductive line 115 so that digital control signal S_{Control} corresponds to a first current flow. Further, in FIG. 1a, the drive signal S_{Drive} is provided to load circuit 130 from drive circuit 120 through a conductive line 125 so that the drive signal S_{Drive} corresponds to a second current flow. It should be noted that a current flow has units of Amperes.

In FIG. 1b, the digital indication is provided to drive circuit 120 from controller circuit 110 through a pair of conductive lines 117, which includes conductive lines 115 and 116, so that the digital control signal S_{Control} corresponds to a potential difference between conductive lines 115 and 116. Further, in FIG. 1b, the drive signal S_{Drive} is provided to load circuit 130 from drive circuit 120 through a pair of conductive lines 127, which includes conductive lines 125 and 126, so that the drive signal S_{Drive} corresponds to a potential difference between conductive lines 125 and 126. It should be noted that the potential difference is sometimes referred to as a voltage and has units of volts.

In some embodiments, the digital indication is a bipolar digital control signal and, in some embodiments, the drive signal is a bipolar digital drive signal. The drive circuit provides the bipolar digital drive signal in response to receiving the bipolar digital control signal provided by the controller circuit. In some embodiments, the bipolar digital drive signal is adjustable in response to adjusting the bipolar digital control signal. For example, in some embodiments, the duty cycle of the bipolar digital drive signal is adjustable in response to adjusting the duty cycle of the bipolar digital control signal. Further, in some embodiments, the frequency of the bipolar digital drive signal is adjustable in response to adjusting the frequency of the bipolar digital control signal.

It should be noted that, in general, analog and digital signals are provided by analog and digital circuits, respectively. Information regarding analog signals is provided in more detail below with FIGS. 2a and 2b, and information regarding digital signals is provided in more detail below with FIGS. 2c, 2d, 2e, 2f, 2g and 2h. The digital signal can be of many different types, such as a unipolar digital signal and bipolar digital signal. Information regarding unipolar and bipolar digital signals is provided in more detail below with FIGS. 2c and 2d.

Load circuit 130 can be of many different types. In some embodiments, load circuit 130 includes a motor, such as an electrical motor. In some embodiments, load circuit 130 includes a linear variable differential transformer (LVDT). In some embodiments, load circuit 130 includes power storage device, such as a solenoid.

In the embodiments of FIGS. 1a and 1b, load circuit 130 includes a light emitting circuit, wherein the light emitting circuit includes a light emitting device, such as a light emitting diode (LED). A light emitting diode includes a pn junction formed by adjacent n-type and p-type semiconductor material layers, wherein the p-type semiconductor material layer corresponds to an anode and the n-type semiconductor material layer corresponds to a cathode. The LED flows light in response to driving a potential difference between the anode and cathode to a voltage value equal to or greater than a diode threshold voltage value. The LED is activated in response to driving the potential difference between the anode and cathode to the voltage value equal to or greater than the diode threshold voltage value. Hence, an activated LED flows light.

Further, the LED does not flow light in response to driving the potential difference between the anode and cathode to a voltage value less than the diode threshold voltage value. The LED is deactivated in response to driving the potential difference between the anode and cathode to the voltage value less than the diode threshold voltage value. Hence, a deactivated LED does not flow light. The diode threshold voltage value depends on many different properties of the LED, such as the material of the n-type and p-type semiconductor material layers. LEDs are provided by many different manufacturers, such as Cree, Inc. and Nichia Corporation. It should be noted that the diode threshold voltage value can be in many different voltage ranges. In some examples, the diode threshold voltage value is between two volts (2 V) and twenty-five volts (25 V). In one particular example, the diode threshold voltage value is twelve volts (12 V). In another example, the diode threshold voltage value is twenty-four volts (24 V).

In some embodiments, load circuit 130 provides first and second frequency spectrums of light in response to receiving a bipolar digital drive signal S_{Drive} from drive circuit 120. The first and second frequency spectrums of light can be adjusted in response to adjusting bipolar digital drive signal S_{Drive}. Bipolar digital drive signal S_{Drive} can be adjusted in many different ways, such as by adjusting digital control signal S_{Control}. In this way, light emitting apparatus 100 provides controllable lighting. It should be noted that the frequency spectrum of light corresponds to the color of the light. It should also be noted that, in some embodiments, load circuit 130 can provide two or more frequency spectrums of light in response to receiving a bipolar digital drive signal S_{Drive} from drive circuit 120.

In some embodiments, the amount of light provided by load circuit 130 is adjustable in response to adjusting a duty cycle of drive signal S_{Drive}. The amount of light provided by load circuit 130 increases and decreases in response to decreasing and increasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100 provides controllable lighting.

FIG. 1g is a block diagram of one embodiment of a light emitting apparatus, denoted as light emitting apparatus 100k. In this embodiment, light emitting apparatus 100k includes a load circuit 130a operatively coupled to controller circuit 110 through a drive circuit 120a. Drive circuit 120a provides a drive signal S_{Drive1} to load circuit 130a in response to a first digital indication from controller circuit 110. The first digital indication can be of many different types, such as a digital signal. In FIG. 1g, the first digital indication corresponds to a digital control signal, denoted as digital control signal S_{Control1}.

In FIG. 1g, the first digital indication is provided to drive circuit 120a from controller circuit 110 through a pair of conductive lines 117a, which includes conductive lines 115a and 116a, so that the digital control signal S_{Control1} corresponds to a potential difference between conductive lines 115a and 116a. Further, in FIG. 1g, the drive signal S_{Drive1} is provided to load circuit 130a from drive circuit 120a through a pair of conductive lines 127a, which includes conductive lines 125a and 126a, so that the drive signal S_{Drive1} corresponds to a potential difference between conductive lines 125a and 126a.

In FIG. 1g, the operation of drive circuit 120a is adjustable in response to receiving an indication from controller circuit 110. The indication can be of many different types. In this embodiment, the indication corresponds to a control signal S_{Control3}, which flows between controller circuit 110 and drive circuit 120a through a conductive line 128. In some embodiments, control signal S_{Control3} is a wireless signal. Drive circuit 120a is repeatably moveable between active and deactive conditions in response to adjusting control signal S_{Control3}. In the active condition, drive circuit 120a provides drive signal S_{Drive1} and, in the deactive condition, drive circuit 120a does not provide drive signal S_{Drive1}.

In this embodiment, light emitting apparatus 100k includes a load circuit 130b operatively coupled to controller circuit 110 through a drive circuit 120b. Drive circuit 120b provides a drive signal S_{Drive2} to load circuit 130b in response to a second digital indication from controller circuit 110. The second digital indication can be of many different types, such as a digital signal. In FIG. 1g, the second digital indication corresponds to a digital control signal, denoted as digital control signal S_{Control2}.

In FIG. 1g, the second digital indication is provided to drive circuit 120b from controller circuit 110 through a pair of conductive lines 117b, which includes conductive lines 115b and 116b, so that the digital control signal S_{Control2} corresponds to a potential difference between conductive lines 115b and 116b. Further, in FIG. 1g, the drive signal S_{Drive2} is provided to load circuit 130b from drive circuit 120b through a pair of conductive lines 127b, which includes conductive lines 125b and 126b, so that the drive signal S_{Drive2} corresponds to a potential difference between conductive lines 125b and 126b.

In FIG. 1g, the operation of drive circuit 120b is adjustable in response to receiving an indication from controller circuit 110. The indication can be of many different types. In this embodiment, the indication corresponds to a control signal S_{Control4}, which flows between controller circuit 110 and drive circuit 120b through a conductive line 129. In some embodiments, control signal S_{Control4} is a wireless signal. Drive circuit 120b is repeatably moveable between active and deactive conditions in response to adjusting control signal S_{Control4}. In the active condition, drive circuit 120b provides drive signal S_{Drive2} and, in the deactive condition, drive circuit 120b does not provide drive signal S_{Drive2}.

FIG. 1h is a block diagram of one embodiment of a light emitting apparatus, denoted as light emitting apparatus 100l. In this embodiment, light emitting apparatus 100l includes load circuit 130a operatively coupled to controller circuit 110 through drive circuit 120a. Drive circuit 120a provides drive signal S_{Drive1} to load circuit 130a in response to the first digital indication from controller circuit 110. The first digital indication can be of many different types, such as a digital signal. In FIG. 1g, the first digital indication corresponds to digital control signal S_{Control1}.

In FIG. 1g, the first digital indication is provided to drive circuit 120a from controller circuit 110 through the pair of conductive lines 117a, which includes conductive lines 115a and 116a, so that the digital control signal S_{Control1} corresponds to a potential difference between conductive lines 115a and 116a. Further, in FIG. 1g, the drive signal S_{Drive1} is provided to load circuit 130a from drive circuit 120a through the pair of conductive lines 127a, which includes conductive lines 125a and 126a, so that the drive signal S_{Drive1} corresponds to a potential difference between conductive lines 125a and 126a.

In this embodiment, light emitting apparatus 100l includes electrical device 157, which is operatively coupled to drive circuit 120a. Electrical device 157 can be operatively coupled to drive circuit 120a in many different ways. In this embodiment, electrical device 157 is connected to conductive lines 125a and 126a so that electrical device 157 receives drive signal S_{Drive1}. Electrical device 157 operates in response to receiving drive signal S_{Drive1}.

In this embodiment, light emitting apparatus 100l includes load circuit 130b operatively coupled to controller circuit 110 through drive circuit 120b. Drive circuit 120b provides drive signal S_{Drive2} to load circuit 130b in response to the second digital indication from controller circuit 110. The second digital indication can be of many different types, such as a digital signal. In FIG. 1g, the second digital indication corresponds to digital control signal S_{Control2}.

In FIG. 1g, the second digital indication is provided to drive circuit 120b from controller circuit 110 through the pair of conductive lines 117b, which includes conductive lines 115b and 116b, so that the digital control signal S_{Control2} corresponds to a potential difference between conductive lines 115b and 116b. Further, in FIG. 1g, the drive signal S_{Drive2} is provided to load circuit 130b from drive circuit 120b through the pair of conductive lines 127b, which includes conductive lines 125b and 126b, so that the drive signal S_{Drive2} corresponds to a potential difference between conductive lines 125b and 126b.

In this embodiment, light emitting apparatus 100l includes power storage device 158, which is operatively coupled to drive circuit 120b. Power storage device 158 can be operatively coupled to drive circuit 120b in many different ways. In this embodiment, power storage device 158 is connected to conductive lines 125b and 126b so that power storage device 158 receives drive signal S_{Drive2}. Power storage device 158 operates in response to receiving drive signal S_{Drive2}. As mentioned above, power storage device 158 can be of many different types, such as a rechargeable battery. Button cell battery 158a is indicated by indication arrow 155 in FIG. 1h. It should be noted that power storage device 158 can provide signal S_{Drive2} to load circuit 130a, such as when the DC signal provided to drive circuit 120b is driven to zero volts. The DC signal provided to drive circuit 120b is driven to zero volts such as in a power outage. In this way, power storage device 158 can provide back-up power to load circuit 130b.

FIG. 2a is a graph 140 which includes examples of a positive unipolar analog signal S_{AC1} and negative unipolar analog signal S_{AC2}, wherein graph 140 corresponds to voltage verses time. In this example, positive unipolar analog signal S_{AC1} is a periodic sinusoidal signal having a period T₁, wherein a periodic signal repeats itself after a time corresponding to the period. The period corresponds to a time value and is inversely related to the frequency f of the signal by the relation T=1/f, so that the period T increases and decreases as frequency f decreases and increases, respectively.

Positive unipolar analog signal S_{AC1} has magnitude V_{Mag} which varies about a reference voltage V_{REF}, wherein V_{REF} has a positive voltage value. Signal S_{AC1} is a positive unipolar signal because it has positive voltage values for period T₁. Signal S_{AC1} is a positive unipolar signal because it does not have negative voltage values for period T₁. Signal S_{AC1} is not a bipolar signal because signal S_{AC1} has positive voltage values for period T₁. Signal S_{AC1} is not a bipolar signal because signal S_{AC1} does not have positive and negative voltage values for period T₁.

In this example, negative unipolar analog signal S_{AC2} is a periodic sinusoidal signal having period T₁. Negative unipolar analog signal S_{AC2} has magnitude V_{Mag} which varies about a reference voltage −V_{REF}, wherein −V_{REF} has a negative voltage value. Signal S_{AC2} is a negative unipolar signal because it has negative voltage values for period T₁. Signal S_{AC2} is a negative unipolar signal because it does not have positive voltage values for period T₁. Signal S_{AC2} is not a bipolar signal because signal S_{AC2} has negative voltage values for period T₁. Signal S_{AC2} is not a bipolar signal because signal S_{AC2} does not have positive and negative voltage values for period T₁.

FIG. 2b is a graph 141 of an example of a bipolar analog signal S_{AC3}, wherein graph 141 corresponds to voltage verses time. In this example, bipolar analog signal S_{AC3} is a periodic sinusoidal signal having period T₁. Bipolar analog signal S_{AC3} has magnitude V_{Mag} which varies about a zero voltage value. Signal S_{AC3} is a bipolar signal because it has positive and negative voltage values for period T₁. Signal S_{AC3} is not a unipolar signal because signal S_{AC3} has positive and negative voltage values for period T₁.

FIG. 2c is a graph 142 which includes examples of a positive unipolar digital signal S_{DC1} and negative unipolar digital signal S_{DC2}, wherein graph 142 corresponds to voltage verses time. In this example, positive unipolar digital signal S_{DC1} is a periodic non-sinusoidal signal having period T₁. Positive unipolar digital signal S_{DC1} has magnitude V_{Mag} which varies about positive reference voltage V_{REF}, wherein V_{REF} has a positive voltage value. Signal S_{DC1} is a positive unipolar signal because it has positive voltage values for period T₁. Signal S_{DC1} is a positive unipolar signal because it does not have negative voltage values for period T₁. It should be noted that a voltage value of zero volts corresponds to a positive voltage value. Signal S_{DC1} is not a bipolar signal because signal S_{DC1} has positive voltage values for period T₁. Signal S_{DC1} is not a bipolar signal because signal S_{DC1} does not have negative voltage values for period T₁. Signal S_{DC1} is not a bipolar signal because signal S_{DC1} does not have positive and negative voltage values for period T₁.

For period T₁, digital signal S_{DC1} includes an active edge between rising and falling edges, as well as a deactive edge between rising and falling edges. The active and deactive edges have constant positive voltage values, wherein the voltage value of the active edge has a larger magnitude than the voltage value of the deactive edge. In a digital circuit, the active edge corresponds to a one (“1”) because it has a voltage value greater than positive reference voltage V_{REF} and the deactive edge corresponds to a zero (“0”) because it has a voltage value less than positive reference voltage V_{REF}.

In this example, negative unipolar digital signal S_{DC2} is a periodic non-sinusoidal signal having period T₁. Negative unipolar digital signal S_{DC2} has magnitude V_{Mag} which varies about negative reference voltage −V_{REF}, wherein −V_{REF} has a negative voltage value. Signal S_{DC2} is a negative unipolar signal because it has negative voltage values for period T₁. Signal S_{DC2} is a negative unipolar signal because it does not have positive voltage values for period T₁. It should be noted that a voltage value of zero volts does not correspond to a negative voltage value. Signal S_{DC2} is not a bipolar signal because signal S_{DC1} has negative voltage values for period T₁. Signal S_{DC2} is not a bipolar signal because signal S_{DC2} does not have positive voltage values for period T₁. Signal S_{DC2} is not a bipolar signal because signal S_{DC2} does not have positive and negative voltage values for period T₁.

For period T₁, digital signal S_{DC2} includes an active edge between rising and falling edges, as well as a deactive edge between rising and falling edges. The active and deactive edges have constant negative voltage values, wherein the voltage value of the active edge has a larger magnitude than the voltage value of the deactive edge. In a digital circuit, the active edge corresponds to a one (“1”) because it has a voltage value greater than negative reference voltage −V_{REF} and the deactive edge corresponds to a zero (“0”) because it has a voltage value less than negative reference voltage −V_{REF}.

FIG. 2d is a graph 143 of an example of a bipolar digital signal S_{DC3}, wherein graph 143 corresponds to voltage verses time. In this example, bipolar digital signal S_{DC3} is a periodic sinusoidal signal having period T₁. Bipolar digital signal S_{DC3} has magnitude V_{Mag} which varies about a zero voltage value. Signal S_{DC3} is a bipolar signal because it has positive and negative voltage values for period T₁. Signal S_{DC3} is not a unipolar signal because signal S_{DC3} has positive and negative voltage values for period T₁. The positive and negative voltage values of bipolar digital signal S_{DC3} have magnitudes of V_{Mag1} and V_{Mag2}, respectively, wherein the sum of magnitudes V_{Mag1} and V_{Mag2} is equal to magnitude V_{Mag}. In some embodiments, the values of magnitudes V_{Mag1} and V_{Mag2} are the same so that the value of magnitude V_{Mag1} is equal to the value of magnitude V_{Mag2}. In other embodiments, the values of magnitudes V_{Mag1} and V_{Mag2} are not the same. For example, in some embodiments, the value of magnitude V_{Mag1} is greater than the value of magnitude V_{Mag2} so that the value of magnitude V_{Mag2} is less than the value of magnitude V_{Mag1}. In other embodiments, the value of magnitude V_{Mag2} is greater than the value of magnitude V_{Mag1} so that the value of magnitude V_{Mag1} is less than the value of magnitude V_{Mag2}.

It should be noted that bipolar digital signal S_{DC3} includes active, deactive, rising and falling edges, which are discussed in more detail above. The active edges of bipolar digital signal S_{DC3} have values greater than the zero voltage value, and the deactive edges of the bipolar digital signal S_{DC3} have values less than the zero voltage value.

FIG. 2e is a graph 144 of an example of a positive unipolar digital signal S_{DC4} having a fifty percent (50%) duty cycle, wherein graph 144 corresponds to voltage verses time. More information regarding duty cycles can be found in U.S. Pat. Nos. 7,042,379 and 7,773,016. In this example, positive unipolar digital signal S_{DC4} is a periodic non-sinusoidal signal having period T₂. Signal S_{DC4} is a positive unipolar signal because it has positive voltage values for period T₂. It should be noted that the deactive edge of signal S_{DC4} has a zero voltage value, which is a positive voltage value, as mentioned above. Signal S_{DC4} is not a bipolar signal because signal S_{DC4} has positive voltage values for period T₂.

Positive unipolar digital signal S_{DC4} has a fifty percent (50%) duty cycle because the length of time of its active edge is the same as the length of time of its deactive edge. In this particular example, the active edge of signal S_{DC4} extends between times t₁ and t₂, wherein time t₂ is greater than time t₁. Further, the deactive edge of signal S_{DC4} extends between times t₂ and t₃, wherein time t₃ is greater than time t₂. Positive unipolar digital signal S_{DC4} has a fifty percent (50%) duty cycle because the time difference between times t₂ and t₁ is the same as the time difference between times t₃ and t₂. In this way, positive unipolar digital signal S_{DC4} has a fifty percent (50%) duty cycle because the length of time of its active edge is the same as the length of time of its deactive edge. It should be noted that, in this example, time t₁ corresponds to the time of the rising edge of signal S_{DC4}, time t₂ corresponds to the time of the falling edge of signal S_{DC4} and the difference between times t₁ and t₃ corresponds to period T₂.

FIG. 2f is a graph 145 of an example of a positive unipolar digital signal S_{DC5} having a duty cycle that is less than fifty percent (50%), wherein graph 145 corresponds to voltage verses time. In this example, positive unipolar digital signal S_{DC5} is a periodic non-sinusoidal signal having period T₂. Signal S_{DC5} is a positive unipolar signal because it has positive voltage values for period T₂. It should be noted that the deactive edge of signal S_{DC5} has a zero voltage value, which is a positive voltage value, as mentioned above. Signal S_{DC5} is not a bipolar signal because signal S_{DC5} has positive voltage values for period T₂.

Positive unipolar digital signal S_{DC5} has a duty cycle that is less than fifty percent (50%) because the length of time of its active edge is less than the length of time of its deactive edge. In this particular example, the active edge of signal S_{DC5} extends between times t₁ and t₂, wherein time t₂ is greater than time t₁. Further, the deactive edge of signal S_{DC5} extends between times t₂ and t₃, wherein time t₃ is greater than time t₂. Positive unipolar digital signal S_{DC5} has a duty cycle that is less than fifty percent (50%) because the time difference between times t₂ and t₁ is less than the time difference between times t₃ and t₂. In this way, positive unipolar digital signal S_{DC5} has a duty cycle that is less than fifty percent (50%) because the length of time of its active edge is less than the length of time of its deactive edge. It should be noted that, in this example, time t₁ corresponds to the time of the rising edge of signal S_{DC5}, time t₂ corresponds to the time of the falling edge of signal S_{DC5} and the difference between times t₁ and t₃ corresponds to period T₂.

FIG. 2g is a graph 146 of an example of a positive unipolar digital signal S_{DC6} having a duty cycle that is greater than fifty percent (50%), wherein graph 146 corresponds to voltage verses time. In this example, positive unipolar digital signal S_{DC6} is a periodic non-sinusoidal signal having period T₂. Signal S_{DC6} is a positive unipolar signal because it has positive voltage values for period T₂. It should be noted that the deactive edge of signal S_{DC6} has a zero voltage value, which is a positive voltage value, as mentioned above. Signal S_{DC6} is not a bipolar signal because signal S_{DC6} has positive voltage values for period T₂.

Positive unipolar digital signal S_{DC6} has a duty cycle that is greater than fifty percent (50%) because the length of time of its active edge is greater than the length of time of its deactive edge. In this particular example, the active edge of signal S_{DC6} extends between times t₁ and t₂, wherein time t₂ is greater than time t₁. Further, the deactive edge of signal S_{DC6} extends between times t₂ and t₃, wherein time t₃ is greater than time t₂. Positive unipolar digital signal S_{DC6} has a duty cycle that is greater than fifty percent (50%) because the time difference between times t₂ and t₁ is greater than the time difference between times t₃ and t₂. In this way, positive unipolar digital signal S_{DC6} has a duty cycle that is greater than fifty percent (50%) because the length of time of its active edge is greater than the length of time of its deactive edge. It should be noted that, in this example, time t₁ corresponds to the time of the rising edge of signal S_{DC6}, time t₂ corresponds to the time of the falling edge of signal S_{DC6} and the difference between times t₁ and t₃ corresponds to period T₂.

FIG. 2h is a graph 146a of an example of positive unipolar digital signal S_{DC6} having a duty cycle that is equal to fifty percent (=50%), wherein graph 146a corresponds to voltage verses time. In this example, positive unipolar digital signal S_{DC6} is a periodic non-sinusoidal signal having period T₂. Signal S_{DC6} is a positive unipolar signal because it has positive voltage values for period T₂. It should be noted that the deactive edge of signal S_{DC6} has a zero voltage value, which is a positive voltage value, as mentioned above. Signal S_{DC6} is not a bipolar signal because signal S_{DC6} has positive voltage values for period T₂.

Positive unipolar digital signal S_{DC6} has a duty cycle that is equal to fifty percent (=50%) because the length of time of its active edge is the same as the length of time of its deactive edge. In this particular example, the active edge of signal S_{DC6} extends between times t₁ and t₂, wherein time t₂ is greater than time t₁. Further, the deactive edge of signal S_{DC6} extends between times t₂ and t₃, wherein time t₃ is greater than time t₂. Positive unipolar digital signal S_{DC6} has a duty cycle that is equal to fifty percent (=50%) because the time difference between times t₂ and t₁ is the same as the time difference between times t₃ and t₂. In this way, positive unipolar digital signal S_{DC6} has a duty cycle that is equal to fifty percent (=50%) because the length of time of its active edge is equal to the length of time of its deactive edge. It should be noted that, in this example, time t₁ corresponds to the time of the rising edge of signal S_{DC6}, time t₂ corresponds to the time of the falling edge of signal S_{DC6} and the difference between times t₁ and t₃ corresponds to period T₂.

FIG. 2i is a graph 146b of an example of positive unipolar digital signal S_{DC7} having a duty cycle that is equal to fifty percent (=50%), wherein graph 146b corresponds to voltage verses time. In this example, the pulse between times t₁ and t₃ corresponds to a number of pulses within period T₂, wherein the number of pulses correspond to a number of bits of information. In this particular example, the number of bits between times t₁ and t₅ is four and the number of bits between times t₅ and t₉ is three. The number of bits is adjustable in response to adjusting the control signal provided by a controller circuit, such as controller circuit 110, which is discussed above. Signal S_{DC7} can be used to drive the LED's of a light emitting sub-circuit so that information can be flowed in the form of light pulses.

FIG. 2j is a graph 146c of an example of positive bipolar digital signal S_{DC9} having a duty cycle that is equal to fifty percent (=50%), wherein graph 146b corresponds to voltage verses time. In this example, the pulse between times t₁ and t₇ corresponds to a number of pulses within period T₂, wherein the number of pulses correspond to a number of bits of information. It should be noted that some of the pulses correspond to positive pulses and other pulses correspond to negative pulses. Hence, in a circuit in which LED's are connected together in reverse parallel, the positive pulse can be used to drive one LED and the negative pulse can be used to drive the other LED. In this particular example, the number of positive pulses is equal to six (6) and the number of negative pulses is equal to five (5). The number of positive and negative pulses is adjustable in response to adjusting the control signal provided by a controller circuit, such as controller circuit 110, which is discussed above. Signal S_{DC9} can be used to drive the LED's of first and second light emitting sub-circuits, which are connected in reverse parallel, so that information can be flowed in the form of light pulses.

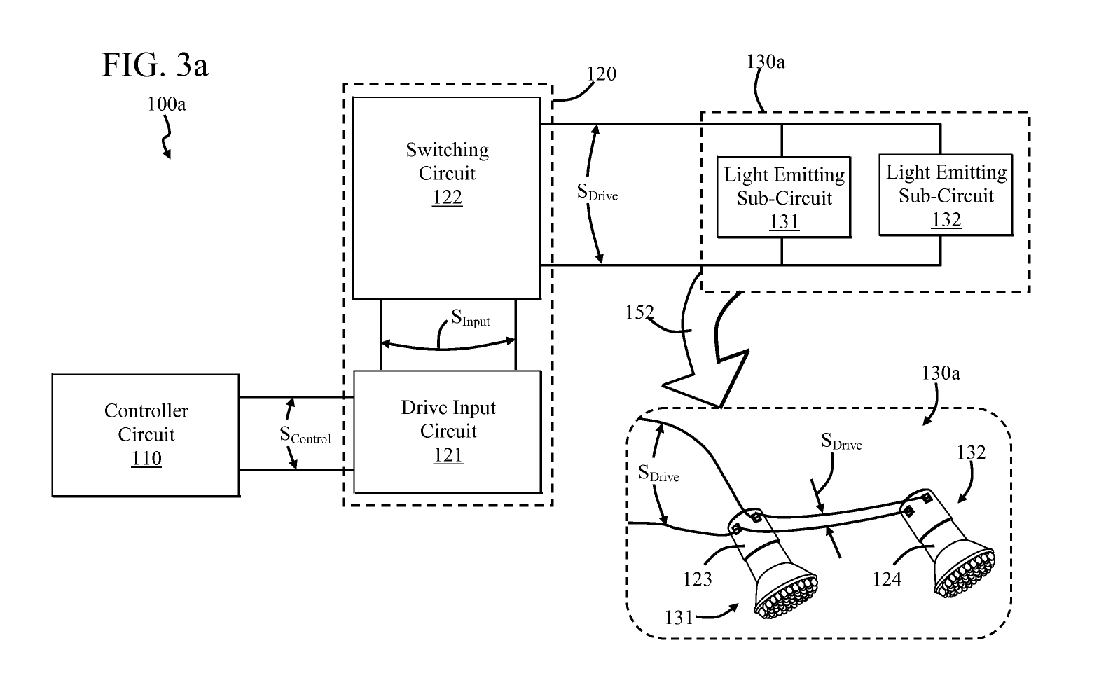

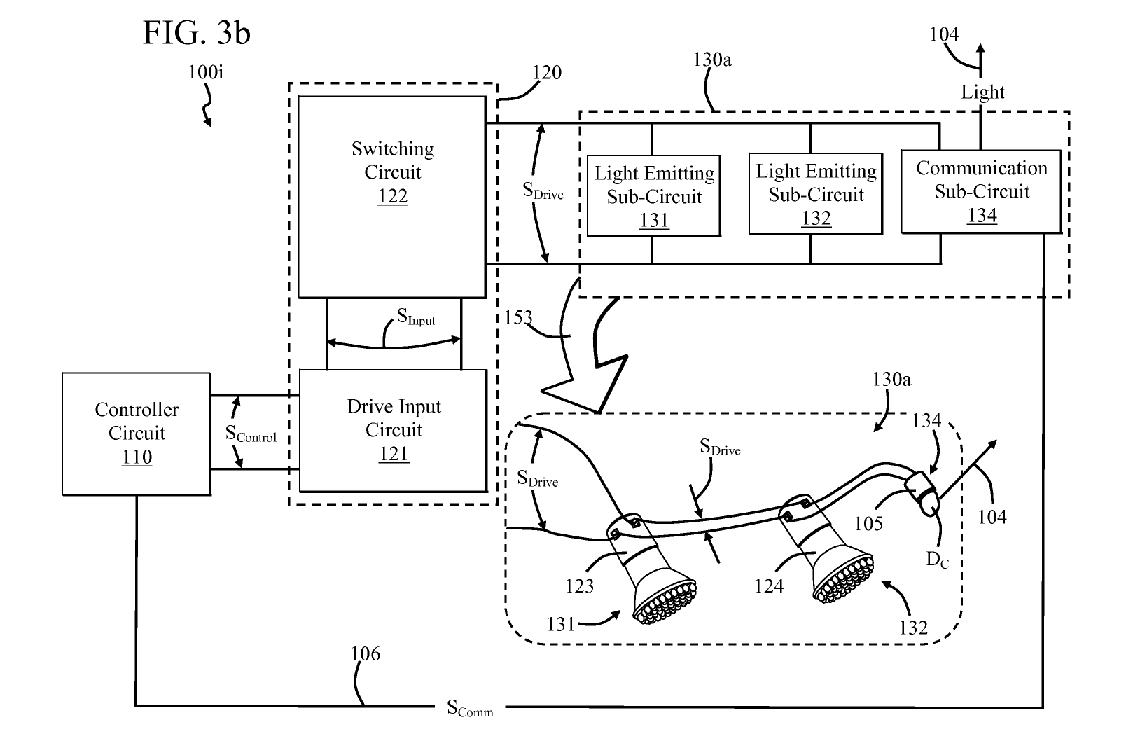

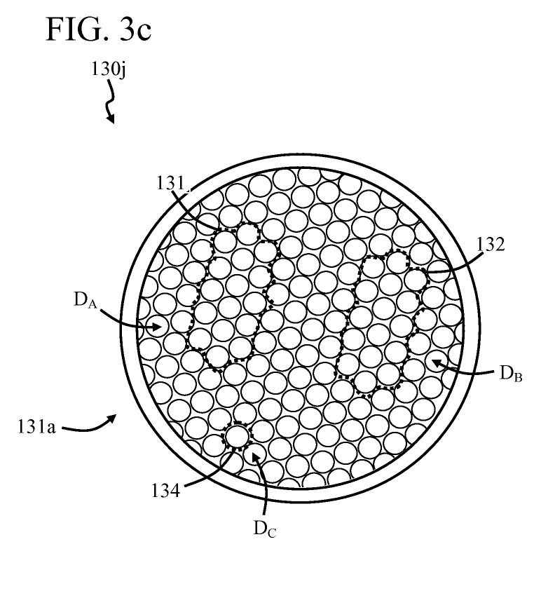

FIG. 3a is a more detailed block diagram of an embodiment of light emitting apparatus 100 of FIG. 1b, denoted as light emitting apparatus 100a. In this embodiment, light emitting apparatus 100a includes a load circuit 130a operatively coupled to controller circuit 110 through drive circuit 120. In this embodiment, drive circuit 120 includes a drive input circuit 121 operatively coupled to controller circuit 110 and a switching circuit 122 operatively coupled to drive input circuit 121 and load circuit 130a.

In operation, drive circuit 120 provides drive signal S_{Drive} to load circuit 130a in response to a digital indication from controller circuit 110, wherein the digital indication corresponds to a digital control signal S_{Control}. Drive circuit 120 can provide drive signal S_{Drive} to load circuit 130a in many different ways. In this embodiment, drive input circuit 121 provides a drive input signal S_{Input} to switching circuit 122 in response to receiving digital control signal S_{Control}, and switching circuit 122 provides drive signal S_{Drive} to load circuit 130a in response to receiving drive input signal S_{Input} from drive input circuit 121.

In this embodiment, load circuit 130a includes light emitting sub-circuits 131 and 132 connected in parallel so they have opposite polarities. Light emitting sub-circuits 131 and 132 are connected in parallel so they have opposite polarities because an anode of light emitting sub-circuit 131 is connected to a cathode of light emitting sub-circuit 132. Further, light emitting sub-circuits 131 and 132 are connected in parallel so they have opposite polarities because a cathode of light emitting sub-circuit 131 is connected to an anode of light emitting sub-circuit 132. In this embodiment, light emitting sub-circuits 131 and 132 have opposite polarities so that, during a first operating condition, light emitting sub-circuit 131 emits light and light emitting sub-circuit 132 does not emit light and, during a second operating condition, light emitting sub-circuit 131 does not emit light and light emitting sub-circuit 132 does emit light. Light emitting sub-circuits 131 and 132 are repeatably moveable between the first and second conditions in response to load circuit 130a receiving drive signal S_{Drive}. Light emitting sub-circuits 131 and 132 can include many different types of light emitting devices, such as those discussed in more detail above.

It should be noted that, in this embodiment, signals S_{Control}, S_{Input} and S_{Drive} are digital signals. In some embodiments, signals S_{Control}, S_{Input} and S_{Drive} are bipolar digital signals and, in other embodiments, signals S_{Control}, S_{Input} and S_{Drive} are unipolar digital signals. In some embodiments, signals S_{Control}, S_{Input} and S_{Drive} are positive unipolar digital signals and, in other embodiments, signals S_{Control}, S_{Input} and S_{Drive} are negative unipolar digital signals.

In this embodiment, light emitting sub-circuits 131 and 132 provide first and second frequency spectrums of light in response to receiving a bipolar digital drive signal S_{Drive} from switching circuit 122. The first and second frequency spectrums of light can be adjusted in response to adjusting bipolar digital drive signal S_{Drive}. Bipolar digital drive signal S_{Drive} can be adjusted in many different ways, such as by adjusting digital control signal S_{Control}. In this way, light emitting apparatus 100a provides controllable lighting.

In some embodiments, the amount of light provided by light emitting sub-circuit 131 is adjustable in response to adjusting a duty cycle of drive signal S_{Drive}. The amount of light provided by light emitting sub-circuit 131 increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting sub-circuit 131 provides controllable lighting.

In some embodiments, the amount of light provided by light emitting sub-circuit 132 is adjustable in response to adjusting a duty cycle of drive signal S_{Drive}. The amount of light provided by light emitting sub-circuit 132 increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100a provides controllable lighting.

Light emitting sub-circuits 131 and 132 can be of many different types. In the embodiments indicated by indication arrow 152 of FIG. 3a, light emitting sub-circuits 131 and 132 are lamps 123 and 124, respectively. In this embodiment, lamps 123 and 124 each include a light emitting diode. More information regarding light emitting diodes is provided in the Background, as well as with some of the other drawings included herein.

Light emitting sub-circuits 131 and 132 can provide many different frequency spectrums of light. The frequency spectrum of light can be in the visible spectrum and the non-visible spectrum. The visible spectrum includes frequency spectrums detectable by the normal human eye and the non-visible spectrum includes frequency spectrums that are not detectable by the normal human eye. In general, the visible frequency spectrum includes light having a color of between red and violet, such as red, orange, green, blue, indigo and violet. The non-visible frequency spectrum includes light having a color of infrared and ultraviolet.

FIG. 3b is a more detailed block diagram of an embodiment of light emitting apparatus 100 of FIG. 1b, denoted as light emitting apparatus 100i. In this embodiment, light emitting apparatus 100i includes load circuit 130a operatively coupled to controller circuit 110 through drive circuit 120. In this embodiment, drive circuit 120 includes drive input circuit 121 operatively coupled to controller circuit 110 and switching circuit 122 operatively coupled to drive input circuit 121 and load circuit 130a.

In operation, drive circuit 120 provides drive signal S_{Drive} to load circuit 130a in response to a digital indication from controller circuit 110, wherein the digital indication corresponds to a digital control signal S_{Control}. Drive circuit 120 can provide drive signal S_{Drive} to load circuit 130a in many different ways. In this embodiment, drive input circuit 121 provides drive input signal S_{Input} to switching circuit 122 in response to receiving digital control signal S_{Control}, and switching circuit 122 provides drive signal S_{Drive} to load circuit 130a in response to receiving drive input signal S_{Input} from drive input circuit 121.

In this embodiment, load circuit 130a includes light emitting sub-circuits 131 and 132 connected in parallel so they have opposite polarities, as well as a communication sub-circuit 134.

In this embodiment, communication sub-circuit 134 is in communication with controller circuit 110 through a conductive line 106 so that a communication signal S_{Comm} can flow therebetween. In this way, communication signal S_{Comm} is a wired signal. In some embodiments, controller circuit 110 and communication sub-circuit 134 each include a transceiver (not shown) so that communication signal S_{Comm} is a wireless signal.

Light emitting sub-circuits 131 and 132 are connected in parallel so they have opposite polarities because an anode of light emitting sub-circuit 131 is connected to a cathode of light emitting sub-circuit 132. Further, light emitting sub-circuits 131 and 132 are connected in parallel so they have opposite polarities because a cathode of light emitting sub-circuit 131 is connected to an anode of light emitting sub-circuit 132. In this embodiment, light emitting sub-circuits 131 and 132 have opposite polarities so that, during a first operating condition, light emitting sub-circuit 131 emits light and light emitting sub-circuit 132 does not emit light and, during a second operating condition, light emitting sub-circuit 131 does not emit light and light emitting sub-circuit 132 does emit light. Light emitting sub-circuits 131 and 132 are repeatably moveable between the first and second conditions in response to load circuit 130a receiving drive signal S_{Drive}. Light emitting sub-circuits 131 and 132 can include many different types of light emitting devices, such as those discussed in more detail above.

It should be noted that, in this embodiment, signals S_{Control}, S_{Input} and S_{Drive} are digital signals. In some embodiments, signals S_{Control}, S_{Input} and S_{Drive} are bipolar digital signals and, in other embodiments, signals S_{Control}, S_{Input} and S_{Drive} are unipolar digital signals. In some embodiments, signals S_{Control}, S_{Input} and S_{Drive} are positive unipolar digital signals and, in other embodiments, signals S_{Control}, S_{Input} and S_{Drive} are negative unipolar digital signals.

In this embodiment, light emitting sub-circuits 131 and 132 provide first and second frequency spectrums of light in response to receiving a bipolar digital drive signal S_{Drive} from switching circuit 122. The first and second frequency spectrums of light can be adjusted in response to adjusting bipolar digital drive signal S_{Drive}. Bipolar digital drive signal S_{Drive} can be adjusted in many different ways, such as by adjusting digital control signal S_{Control}. In this way, light emitting apparatus 100i provides controllable lighting.

In some embodiments, the amount of light provided by light emitting sub-circuit 131 is adjustable in response to adjusting a duty cycle of drive signal S_{Drive}. The amount of light provided by light emitting sub-circuit 131 increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting sub-circuit 131 provides controllable lighting.

In some embodiments, the amount of light provided by light emitting sub-circuit 132 is adjustable in response to adjusting a duty cycle of drive signal S_{Drive}. The amount of light provided by light emitting sub-circuit 132 increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100i provides controllable lighting.

Light emitting sub-circuits 131 and 132 can be of many different types. In the embodiment indicated by indication arrow 152 of FIG. 3b, light emitting sub-circuits 13a and 132 are lamps 123 and 124, respectively. In this embodiment, lamps 123 and 124 each include a light emitting diode. More information regarding light emitting diodes is provided in the Background, as well as with some of the other drawings included herein.

Communication sub-circuit 134 can be of many different types. In the embodiment indicated by indication arrow 153 of FIG. 3b, communication sub-circuit 134 is a communication diode 105. Communication diode 105 can be of many different types, such as those included in remote controls, such as for a television. In the embodiment of indication arrow 153, communication diode 105 is in communication with controller circuit 110 through drive circuit 120. In this way, communication sub-circuit 134 is in communication with controller circuit 110 through drive circuit 120.

Communication diode 105 can provide many different frequency spectrums of light. As mentioned above, the frequency spectrum of light can be in the visible spectrum and the non-visible spectrum. The visible spectrum includes frequency spectrums detectable by the normal human eye and the non-visible spectrum includes frequency spectrums that are not detectable by the normal human eye. In general, the visible frequency spectrum includes light having a color of between red and violet, such as red, orange, green, blue, indigo and violet. The non-visible frequency spectrum includes light having a color of infrared and ultraviolet. In this embodiment, light emitting sub-circuits 131 and 132 provide light having a visible frequency spectrum, and communication diode 105 provides light having a non-visible frequency spectrum.

FIG. 3c is another embodiment of a load circuit, which is denoted as load circuit 130j. In this embodiment, load circuit 130j includes a lamp, denoted as lamp 131a, wherein lamp 131a carries light emitting sub-circuits 131 and 132, as well as communication sub-circuit 134. For illustrative purposes, light emitting sub-circuits 131 and 132 and communication sub-circuit 134 are indicated by corresponding broken lines in FIG. 3c. In this embodiment, light emitting sub-circuits 131 and 132 include diode strings D_{A} and D_{B}, respectively, and communication sub-circuit 134 includes a diode string D_{C}. In general, diode strings D_{A}, D_{B} and D_{C} each include one or more light emitting diode. Diode string D_{C} is shown as including one light emitting diode in FIG. 3c for simplicity, but it can include more than one light emitting diode, if desired.

FIG. 4a is a circuit diagram 101a of one embodiment of light emitting apparatus 100a of FIG. 3a, which is denoted as light emitting apparatus 100b. In this embodiment, light emitting apparatus 100b includes load circuit 130, denoted as load circuit 130b, operatively coupled to controller circuit 110 through drive circuit 120. In this embodiment, drive circuit 120 includes drive input circuit 121 operatively coupled to controller circuit 110 and switching circuit 122 operatively coupled to drive input circuit 121 and load circuit 130b.

In this embodiment, controller circuit 110 includes a controller chip, which can be of many different types. One type of controller chip is a programmable logic unit. Controller chips are manufactured by many different companies, such as Microchip, Inc., Intel, Atmel and Freescale Semiconductor. Some names of these controller chips are the PIC microcontroller from Microchip, the 8051 microcontrollers from Intel, the AVR microcontrollers from Atmel and the 68C11 microcontrollers from Freescale Semiconductor. There is also the ARM microcontroller, which is provided by many different suppliers.

In this embodiment, drive input circuit 121 includes transistors Q₁ and Q₂, which operate as switches, as will be discussed in more detail below. Transistors Q₁ and Q₂ can be of many different types. In this embodiment, transistors Q₁ and Q₂ are embodied as metal oxide field effect transistors (MOSFETs). A MOSFET includes a control terminal which controls the flow of a current between source and drain terminals.

In an n-type MOSFET (NMOS), the current flows between the source and drain terminals in response to driving a signal applied to the control terminal to a voltage level above a threshold voltage level, wherein the threshold voltage level has a positive voltage value. In the n-type MOSFET, the current does not flow between the source and drain terminals in response to driving the signal applied to the control terminal to a voltage level below the threshold voltage level. In this way, the n-type MOSFET operates as a switch.

In a p-type MOSFET (PMOS), the current flows between the source and drain terminals in response to driving a signal applied to the control terminal to a voltage level below a threshold voltage level, wherein the threshold voltage level has a negative voltage value. In the p-type MOSFET, the current does not flow between the source and drain terminals in response to driving the signal applied to the control terminal to a voltage level above the threshold voltage level. In this way, the p-type MOSFET operates as a switch. Examples of the circuit symbols typically used for NMOS and PMOS transistors are labeled and shown in FIG. 4a.

In this embodiment, the control terminal of transistor Q₁ is connected to a first output of controller circuit 110 so it receives a digital control signal S_{Control1}, and the control terminal of transistor Q₂ is connected to a second output of controller circuit 110 so it receives a digital control signal S_{Control2}. In this embodiment, the source terminals of transistors Q₁ and Q₂ are connected to a reference terminal which applies a reference voltage V_{Ref2}, and the drain terminals of transistors Q₁ and Q₂ are connected to switching circuit 122 and provide drive input signals S_{Input1} and S_{Input2}, respectively.

In this embodiment, switching circuit 122 includes transistors Q₅ and Q₆, which operate as switches, as will be discussed in more detail below. Transistors Q₅ and Q₆ can be of many different types. In this embodiment, transistors Q₅ and Q₆ are embodied as MOSFETs.

In this embodiment, the control terminal of transistor Q₅ is connected to the drain of transistor Q₂ through a resistor R₂, and the control terminal of transistor Q₆ is connected to the drain of transistor Q₁ through a resistor R₄. Further, the source of transistor Q₅ is connected to the drain of transistor Q₁, and the source of transistor Q₆ is connected to the drain of transistor Q₂. In this embodiment, the drains of transistors Q₅ and Q₆ are connected to a reference terminal which applies a reference voltage V_{Ref1}. It should be noted that, in this embodiment, reference voltage V_{Ref1} is greater than reference voltage V_{Ref2}. However, reference voltage V_{Ref1} is less than reference voltage V_{Ref2} in other embodiments.

It should be noted that, in general, transistors Q₁ and Q₂ are the same type of MOSFETS and transistors Q₅ and Q₆ are the same type of MOSFETS. For example, in one embodiment, transistors Q₁ and Q₂ are NMOS transistors and transistors Q₅ and Q₆ are PMOS transistors. In another embodiment, transistors Q₁ and Q₂ are PMOS transistors and transistors Q₅ and Q₆ are NMOS transistors. The type of transistors chosen depends on the relative voltage values between reference voltages V_{Ref1} and V_{Ref2}.

The control terminal of transistor Q₅ is connected, through a resistor R₁, to the terminal that applies reference voltage V_{Ref1}, and the control terminal of transistor Q₆ is connected, through a resistor R₃, to the terminal that applies reference voltage V_{Ref1}. As will be discussed in more detail below, drive signal S_{Drive} is provided to load circuit 130b between the sources of transistors Q₅ and Q₆.

The ratios of the resistance values of resistors R₁ and R₂ determine the voltage value of signal S_{Input2} when transistor Q₂ is active. Further, the ratios of the resistance values of resistors R₃ and R₄ determine the voltage value of signal S_{Input1} when transistor Q₂ is active.

Resistors R₁, R₂, R₃ and R₄ can be of many different types. In some embodiments, resistors R₁, R₂, R₃ and R₄ are resistors having predetermined resistance values and, in other embodiments, resistors R₁, R₂, R₃ and R₄ are resistors having adjustable resistance values. An example of a resistor having an adjustable resistance value is a potentiometer.

In this embodiment, light emitting apparatus 100b includes an Diode string D_{A} which includes one or more LEDs connected in series. In this embodiment, the LEDs of string D_{A} are denoted as diodes D_{A1}, D_{A2}, D_{A3} . . . D_{AN}, wherein N is a whole number greater than or equal to one. In this embodiment, light emitting apparatus 100b includes an Diode string D_{B} which includes one or more LEDs connected in series. In this embodiment, the LEDs of string D_{B} are denoted as diodes D_{B1}, D_{B2}, D_{B3} . . . D_{BM}, wherein M is a whole number greater than or equal to one. It should be noted that, in some embodiments, N and M are equal and, in other embodiments, N and M are not equal. For example, in some embodiments, N is greater than M, in other embodiments, M is greater than N. It should be noted that a diode of diode string D_{A} can be a silicon diode to reduce the likelihood of diode string D_{A} experiencing a reverse jump current.

In this embodiment, the LEDs of Diode string D_{A} are connected in series and each have the same polarity. The LEDs of Diode string D_{A} are connected in series and each have the same polarity because the terminal of one diode is connected to the opposed terminal of an adjacent diode. For example, the anode of diode D_{A2} is connected to the cathode of diode D_{A1}. Further, the cathode of diode D_{A2} is connected to the anode of diode D_{A3}. It should be noted that the LEDs of Diode string D_{A} are connected in series and each have the same polarity so that they move between the active and deactive conditions together.

Further, in this embodiment, the LEDs of Diode string D_{B} are connected in series and each have the same polarity. The LEDs of Diode string D_{B} are connected in series and each have the same polarity because the terminal of one diode is connected to the opposed terminal of an adjacent diode. For example, the anode of diode D_{B2} is connected to the cathode of diode D_{B1}. Further, the cathode of diode D_{B2} is connected to the anode of diode D_{B3}. It should be noted that the light emitting diodes of Diode string D_{B} are connected in series and each have the same polarity so that they move between the active and deactive conditions together.

In this embodiment, light emitting sub-circuits 131 and 132 are connected in parallel so they have opposite polarities, as discussed in more detail above. Light emitting sub-circuits 131 and 132 are connected in parallel so they have opposite polarities because an anode of light emitting sub-circuit 131 is connected to a cathode of light emitting sub-circuit 132. The anode of light emitting sub-circuit 131 is connected to the cathode of light emitting sub-circuit 132 because the anode of Diode string D_{A} is connected to the cathode of diode string D_{B}. It should be noted that the anode of Diode string D_{A} corresponds to the anode of LED D_{A1}, and the cathode of Diode string D_{B} corresponds to the cathode of LED D_{BM}.

Light emitting sub-circuits 131 and 132 are connected in parallel so they have opposite polarities because a cathode of light emitting sub-circuit 131 is connected to an anode of light emitting sub-circuit 132. The cathode of light emitting sub-circuit 131 is connected to the anode of light emitting sub-circuit 132 because the cathode of Diode string D_{A} is connected to the anode of diode string D_{B}. It should be noted that the cathode of Diode string D_{A} corresponds to the cathode of LED DAN, and the anode of Diode string D_{B} corresponds to the anode of LED D_{B1}.

In this embodiment, Diode strings D_{A} and D_{B} provide first and second frequency spectrums of light in response to receiving a bipolar digital drive signal S_{Drive} from switching circuit 122. The first and second frequency spectrums of light can be adjusted in response to adjusting bipolar digital drive signal S_{Drive}. Bipolar digital drive signal S_{Drive} can be adjusted in many different ways, such as by adjusting digital control signal S_{Control}. In this way, light emitting apparatus 100b provides controllable lighting.

In some embodiments, the amount of light provided by Diode string D_{A} is adjustable in response to adjusting a duty cycle of drive signal S_{Drive}. The amount of light provided by Diode string D_{A} increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100b provides controllable lighting.

In some embodiments, the amount of light provided by Diode strings D_{B} is adjustable in response to adjusting a duty cycle of drive signal S_{Drive}. The amount of light provided by Diode strings D_{B} increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100b provides controllable lighting.

It should be noted that an Diode string can include LEDs of the same type and different type. For example, in one embodiment, the Diode string includes diodes having the same diode threshold voltage values, such as twelve volts (12 V). In this way, the Diode string includes LEDs of same types.

In another embodiment, the Diode string includes diodes having different diode threshold voltage values, such as twelve volts (12 V) and twenty-four volts (24 V). In this way, the Diode string includes LEDs of different types.

FIG. 4b is a circuit diagram 101b of one embodiment of load circuit 130b of FIG. 4a, wherein N=5 and M=1 so that diode string D_{A} includes five diodes D_{A1}, D_{A2}, D_{A3}, D_{A4} and D_{A5} connected in series and diode string D_{B} includes one diode D_{B1}. In this embodiment, diodes D_{A1}, D_{A2}, D_{A3}, D_{A4} and D_{A5} are each the same types of diodes, although one or more of them can be different in other embodiments. In this embodiment, diodes D_{A1}, D_{A2}, D_{A3}, D_{A4} and D_{A5} are each the same types of diodes because they emit the same spectrum of light.

In some embodiments, diodes D_{A1}, D_{A2}, D_{A3}, D_{A4} and D_{A5} have the same diode threshold voltage value. For example, in some embodiments, diodes D_{A1}, D_{A2}, D_{A3}, D_{A4} and D_{A5} each have a diode threshold voltage value of 4.8 volts. In this way, diodes D_{A1}, D_{A2}, D_{A3}, D_{A4} and D_{A5} are each activated in response to driving the value of drive signal S_{Drive} to be greater than or equal to 24 volts (i.e. more positive than or equal to 24 volts, such as 25 volts). Further, diodes D_{A1}, D_{A2}, D_{A3}, D_{A4} and D_{A5} are each deactivated in response to driving the value of drive signal S_{Drive} to be less than 24 volts (i.e. less positive than 24 volts, such as 23 volts).

In one embodiment, diodes D_{A1}, D_{A2}, D_{A3}, D_{A4} and D_{A5} each have a diode threshold voltage value of 2.4 volts and diode D_{B1} has a diode threshold voltage value of 12 volts. In this way, diodes D_{A1}, D_{A2}, D_{A3}, D_{A4} and D_{A5} are each activated in response to driving the value of drive signal S_{Drive} to be greater than or equal to 12 volts (i.e. more positive than or equal to 12 volts, such as 13 volts), and diode D_{B1} is activated in response to driving the value of drive signal S_{Drive} to be less than or equal to −12 volts (i.e. more negative than or equal to −12 volts, such as −13 volts). Further, diodes D_{A1}, D_{A2}, D_{A3}, D_{A4} and D_{A5} are each deactivated in response to driving the value of drive signal S_{Drive} to be less than 12 volts (i.e. less positive than 12 volts, such as 11 volts), and diode D_{B1} is deactivated in response to driving the value of drive signal S_{Drive} to be greater than −12 volts (i.e. more positive than −12 volts, such as −11 volts). In this embodiment, drive signal S_{Drive} can correspond to a bipolar digital signal. One example of a bipolar digital signal that can correspond to drive signal S_{Drive} is shown in FIG. 2d, wherein V_{MAG1} corresponds to 12 volts and V_{MAG2} corresponds to −12 volts.

In another embodiment, diodes D_{A1}, D_{A2}, D_{A3}, D_{A4} and D_{A5} each have a diode threshold voltage value of 4.8 volts and diode D_{B1} has a diode threshold voltage value of 8 volts. In this way, diodes D_{A1}, D_{A2}, D_{A3}, D_{A4} and D_{A5} are each activated in response to driving the value of drive signal S_{Drive} to be greater than or equal to 24 volts (i.e. more positive than or equal to 24 volts, such as 25 volts), and diode D_{B1} is activated in response to driving the value of drive signal S_{Drive} to be less than or equal to −8 volts (i.e. more negative than or equal to −8 volts, such as −9 volts). Further, diodes D_{A1}, D_{A2}, D_{A3}, D_{A4} and D_{A5} are each deactivated in response to driving the value of drive signal S_{Drive} to be less than 24 volts (i.e. less positive than 24 volts, such as 23 volts), and diode D_{B1} is deactivated in response to driving the value of drive signal S_{Drive} to be greater than −8 volts (i.e. more positive than −8 volts, such as −7 volts). In this embodiment, drive signal S_{Drive} can correspond to a bipolar digital signal. One example of a bipolar digital signal that corresponds to drive signal S_{Drive} is shown in FIG. 2d, wherein V_{MAG1} corresponds to 24 volts and V_{MAG2} corresponds to −8 volts.

FIG. 4c is a circuit diagram 101d of another embodiment of load circuit 130b of FIG. 4a, wherein N=5 and M=1 so that diode string D_{A} includes five diodes D_{A1}, D_{A2}, D_{A3}, D_{A4} and D_{A5} connected in series and diode string D_{B} includes one diode D_{B1}. In this embodiment, load circuit 130b includes a diode string D_{C}, which includes a diode D_{C1} so that L=1.

In this embodiment, diodes D_{A1}, D_{A2}, D_{A3}, D_{A4} and D_{A5} are each the same types of diodes, although one or more of them can be different in other embodiments. In this embodiment, diodes D_{A1}, D_{A2}, D_{A3}, D_{A4} and D_{A5} are each the same types of diodes because they emit the same spectrum of light.

In some embodiments, diodes D_{A1}, D_{A2}, D_{A3}, D_{A4} and D_{A5} have the same diode threshold voltage value. For example, in some embodiments, diodes D_{A1}, D_{A2}, D_{A3}, D_{A4} and D_{A5} each have a diode threshold voltage value of 4.8 volts. In this way, diodes D_{A1}, D_{A2}, D_{A3}, D_{A4} and D_{A5} are each activated in response to driving the value of drive signal S_{Drive} to be greater than or equal to 24 volts (i.e. more positive than or equal to 24 volts, such as 25 volts). Further, diodes D_{A1}, D_{A2}, D_{A3}, D_{A4} and D_{A5} are each deactivated in response to driving the value of drive signal S_{Drive} to be less than 24 volts (i.e. less positive than 24 volts, such as 23 volts).

In one embodiment, diodes D_{A1}, D_{A2}, D_{A3}, D_{A4} and D_{A5} each have a diode threshold voltage value of 2.4 volts and diode D_{B1} has a diode threshold voltage value of 12 volts. In this way, diodes D_{A1}, D_{A2}, D_{A3}, D_{A4} and D_{A5} are each activated in response to driving the value of drive signal S_{Drive} to be greater than or equal to 12 volts (i.e. more positive than or equal to 12 volts, such as 13 volts), and diode D_{B1} is activated in response to driving the value of drive signal S_{Drive} to be less than or equal to −12 volts (i.e. more negative than or equal to −12 volts, such as −13 volts). Further, diodes D_{A1}, D_{A2}, D_{A3}, D_{A4} and D_{A5} are each deactivated in response to driving the value of drive signal S_{Drive} to be less than 12 volts (i.e. less positive than 12 volts, such as 11 volts), and diode D_{B1} is deactivated in response to driving the value of drive signal S_{Drive} to be greater than −12 volts (i.e. more positive than −12 volts, such as −11 volts). In this embodiment, drive signal S_{Drive} can correspond to a bipolar digital signal. One example of a bipolar digital signal that can correspond to drive signal S_{Drive} is shown in FIG. 2d, wherein V_{MAG1} corresponds to 12 volts and V_{MAG2} corresponds to −12 volts.

In another embodiment, diodes D_{A1}, D_{A2}, D_{A3}, D_{A4} and D_{A5} each have a diode threshold voltage value of 4.8 volts and diode D_{B1} has a diode threshold voltage value of 8 volts. In this way, diodes D_{A1}, D_{A2}, D_{A3}, D_{A4} and D_{A5} are each activated in response to driving the value of drive signal S_{Drive} to be greater than or equal to 24 volts (i.e. more positive than or equal to 24 volts, such as 25 volts), and diode D_{B1} is activated in response to driving the value of drive signal S_{Drive} to be less than or equal to −8 volts (i.e. more negative than or equal to −8 volts, such as −9 volts). Further, diodes D_{A1}, D_{A2}, D_{A3}, D_{A4} and D_{A5} are each deactivated in response to driving the value of drive signal S_{Drive} to be less than 24 volts (i.e. less positive than 24 volts, such as 23 volts), and diode D_{B1} is deactivated in response to driving the value of drive signal S_{Drive} to be greater than −8 volts (i.e. more positive than −8 volts, such as −7 volts). In this embodiment, drive signal S_{Drive} can correspond to a bipolar digital signal. One example of a bipolar digital signal that corresponds to drive signal S_{Drive} is shown in FIG. 2d, wherein V_{MAG1} corresponds to 24 volts and V_{MAG2} corresponds to −8 volts.

In this embodiment, diode string D_{C} is connected in parallel with diode strings D_{A} and D_{B}. The cathode of diode D_{C1} is connected to the anode of diode D_{B1} and the anode of diode D_{C1} is connected to the cathode of diode D_{B1}. In operation, diode D_{C1} emits light when diode string D_{A} emits light, and diode D_{C1} does not emit light when diode string D_{A} does not emit light. Further, diode D_{C1} emits light when diode string D_{A} does not emit light, and diode D_{C1} does not emit light when diode string D_{A} does emit light.

In some embodiments, diode string D_{C} emits the same frequency spectrum of light as diode string D_{A}, and, in other embodiments, diode string D_{C} emits a different frequency spectrum of light from diode string D_{A}. In some embodiments, the frequency spectrum of light emitted by diode string D_{C} corresponds to visible light. In other embodiments, the frequency spectrum of light emitted by diode string D_{C} corresponds to non-visible light. For example, in some embodiments, the frequency spectrum of light emitted by diode string D_{C} corresponds to infrared light. In other embodiments, the frequency spectrum of light emitted by diode string D_{C} corresponds to ultraviolet light.

FIG. 4d is a circuit diagram of another embodiment of light emitting apparatus 100a of FIG. 4a. In this embodiment, a diode string D_{C} is connected in parallel with diode strings D_{A} and D_{B}, wherein diode string D_{C} provides light 104. Light 104 can be of many different types, such as visible light and non-visible light. More information regarding visible light and non-visible light is provided in more detail above. In one particular embodiment, diode string D_{C} includes a LED which provides infrared light. Diode string D_{C} can be used to proved optical pulses for optical communication with a remote device, wherein the remote device is not shown.

FIG. 4e is a circuit diagram 101f of another embodiment of a load circuit 130b of FIG. 4a, which is denoted as load circuit 130i, wherein N=5 and M=1 so that diode string D_{A} includes five diodes D_{A1}, D_{A2}, D_{A3}, D_{A4} and D_{A5} connected in series and diode string D_{B} includes one diode D_{B1}. In this embodiment, load circuit 130b includes a diode string D_{C}, which includes a diode D_{C1} so that L=1. This embodiment of circuit diagram 101f is similar to circuit diagram 101d of FIG. 4c. In this embodiment, however, load circuit 130i includes a switch 113a connected in series with diode string D_{A}, a switch 113b connected in series with diode string D_{B} and a switch 113c connected in series with diode string D_{C}. Switches 113a, 113b and 113 are operatively coupled to a controller circuit 110a, which can be the same or similar to controller circuit 110. In some embodiments, controller circuit 110a is a portion of controller circuit 110, so that controller circuit 110a is included with controller circuit 110.

In this embodiment, the operation of diode string D_{A} is adjustable in response to receiving an indication from controller circuit 110a. The indication can be of many different types. In this embodiment, the indication corresponds to control signal S_{Control3}, which flows between controller circuit 110a and switch 113a through conductive line 128. In some embodiments, control signal S_{Control} B is a wireless signal. Diode string D_{A} is repeatably moveable between active and deactive conditions in response to adjusting control signal S_{Control3}. In the active condition, current flows though diode string D_{A} in response to establishing drive signal S_{Drive} and, in the deactive condition, current does not flow though diode string D_{A} in response to establishing drive signal S_{Drive}.

In this embodiment, the operation of diode string D_{B} is adjustable in response to receiving an indication from controller circuit 110a. The indication can be of many different types. In this embodiment, the indication corresponds to control signal S_{Control4}, which flows between controller circuit 110a and switch 113b through conductive line 129. In some embodiments, control signal S_{Control4} is a wireless signal. Diode string D_{B} is repeatably moveable between active and deactive conditions in response to adjusting control signal S_{Control4}. In the active condition, current flows though diode string D_{B} in response to establishing drive signal S_{Drive} and, in the deactive condition, current does not flow though diode string D_{B} in response to establishing drive signal S_{Drive}.

In this embodiment, the operation of diode string D_{C} is adjustable in response to receiving an indication from controller circuit 110a. The indication can be of many different types. In this embodiment, the indication corresponds to control signal S_{Control3}, which flows between controller circuit 110a and switch 113c through a conductive line 129a. In some embodiments, control signal S_{Control9} is a wireless signal. Diode string D_{C} is repeatably moveable between active and deactive conditions in response to adjusting control signal S_{Control9}. In the active condition, current flows though diode string D_{C} in response to establishing drive signal S_{Drive} and, in the deactive condition, current does not flow though diode string D_{C} in response to establishing drive signal S_{Drive}.

It should be noted that, in general, one or more of switches 113a, 113b and 113c can be in the active condition. For example, in one situation switches 113a and 113b are in the active condition and switch 113c is in the deactive condition. In another situation, switches 113a and 113b are in the deactive condition and switch 113c is in the active condition. In this way, the frequency spectrum of light provided by load circuit 130i is adjustable in response to adjusting a control signal.

FIG. 5a is a circuit diagram 101c of another embodiment of light emitting apparatus 100a of FIG. 3, which is denoted as light emitting apparatus 100c. In this embodiment, light emitting apparatus 100c includes load circuit 130, denoted as a load circuit 130c, operatively coupled to controller circuit 110 through drive circuit 120. In this embodiment, drive circuit 120 includes drive input circuit 121 operatively coupled to controller circuit 110 and switching circuit 122 operatively coupled to drive input circuit 121 and load circuit 130c.

In this embodiment, drive input circuit 121 includes transistors Q₁ and Q₂, which operate as switches, as will be discussed in more detail below. Transistors Q₁ and Q₂ can be of many different types. In this embodiment, transistors Q₁ and Q₂ are embodied as MOSFETs.

In this embodiment, the control terminal of transistor Q₁ is connected to a first output of controller circuit 110 so it receives a digital control signal S_{Control1}, and the control terminal of transistor Q₂ is connected to a second output of controller circuit 110 so it receives a digital control signal S_{Control3}. In this embodiment, the source terminals of transistors Q₁ and Q₂ are connected to a reference terminal which applies reference voltage V_{Ref2}, and the drain terminals of transistors Q₁ and Q₂ are connected to switching circuit 122 and provide drive input signals S_{Input1} and S_{Input3}, respectively.

In this embodiment, switching circuit 122 includes transistors Q₅ and Q₆, which operate as switches, as will be discussed in more detail below. Transistors Q₅ and Q₆ can be of many different types. In this embodiment, transistors Q₅ and Q₆ are embodied as MOSFETs.

In this embodiment, the control terminal of transistor Q₅ is connected to an output of controller circuit 110 so it receives a digital control signal S_{Control2} and the control terminal of transistor Q₆ is connected to an output of controller circuit 110 so it receives a digital control signal S_{Control4}. Further, the source of transistor Q₅ is connected to the drain of transistor Q₁. In this embodiment, the sources of transistors Q₂, Q₅ and Q₆ are connected to load circuit 130c, as will be discussed in more detail below. In this embodiment, the drains of transistors Q₅ and Q₆ are connected to a reference terminal which applies a reference voltage V_{Ref1}. It should be noted that, in this embodiment, reference voltage V_{Ref1} is greater than reference voltage V_{Ref2}. However, reference voltage V_{Ref1} is less than reference voltage V_{Ref2} in other embodiments. As will be discussed in more detail below, more than one drive signal is provided by switching circuit 122 to load circuit 130c.

In this embodiment, load circuit 130c includes light emitting sub-circuits 131, 132 and 133. In this embodiment, light emitting sub-circuit 131 includes Diode string D_{A} which includes one or more LEDs connected in series. In this embodiment, the LEDs of string D_{A} are denoted as diodes D_{A1}, D_{A2}, D_{A3} . . . D_{AN}, wherein N is a whole number greater than or equal to one.

In this embodiment, light emitting sub-circuit 132 includes an Diode string D_{B} which includes one or more LEDs connected in series. In this embodiment, the LEDs of string D_{B} are denoted as diodes D_{B1}, D_{B2}, D_{B3} . . . D_{BM}, wherein M is a whole number greater than or equal to one. In this embodiment, light emitting sub-circuit 133 includes an Diode string D_{C} which includes one or more LEDs connected in series.

In this embodiment, the LEDs of string D_{C} are denoted as diodes D_{C1}, D_{C2}, D_{C3} . . . D_{BL}, wherein L is a whole number greater than or equal to one. It should be noted that, in some embodiments, N and M are equal and, in other embodiments, N and M are not equal. In some embodiments, N and L are equal and, in other embodiments, N and L are not equal. Further, in some embodiments, M and L are equal and, in other embodiments, M and L are not equal.

In this embodiment, the LEDs of Diode string D_{A} are connected in series and each have the same polarity. The LEDs of Diode string D_{A} are connected in series and each have the same polarity because the terminal of one diode is connected to the opposed terminal of an adjacent diode. For example, the anode of diode D_{A2} is connected to the cathode of diode D_{A1}. Further, the cathode of diode D_{A2} is connected to the anode of diode D_{A3}. It should be noted that the LEDs of Diode string D_{A} are connected in series and each have the same polarity so that they move between the active and deactive conditions together.

Further, in this embodiment, the LEDs of Diode string D_{B} are connected in series and each have the same polarity. The LEDs of Diode string D_{B} are connected in series and each have the same polarity because the terminal of one diode is connected to the opposed terminal of an adjacent diode. For example, the anode of diode D_{B2} is connected to the cathode of diode D_{B1}. Further, the cathode of diode D_{B2} is connected to the anode of diode D_{B3}. It should be noted that the light emitting diodes of Diode string D_{B} are connected in series and each have the same polarity so that they move between the active and deactive conditions together.

In this embodiment, the LEDs of Diode string D_{C} are connected in series and each have the same polarity. The LEDs of Diode string D_{C} are connected in series and each have the same polarity because the terminal of one diode is connected to the opposed terminal of an adjacent diode. For example, the anode of diode D_{C2} is connected to the cathode of diode D_{C1}. Further, the cathode of diode D_{C2} is connected to the anode of diode D_{C3}. It should be noted that the LEDs of Diode string D_{C} are connected in series and each have the same polarity so that they move between the active and deactive conditions together.

In this embodiment, the anode of Diode string D_{A} is connected to an anode of Diode string D_{C}, and the anodes of Diode strings D_{A} and D_{C} are connected to the drain of transistor Q₁ and the source of transistor Q₆. In this embodiment, the cathode of Diode string D_{B} is connected to the cathode of Diode string D_{C} and the drain of transistor Q₁ and the source of transistor Q₅, and the anode of diode string DB is connected to the cathode of diode string D_{A} and the drain of transistor Q₂. In this embodiment, the cathode of Diode string D_{B} is connected to the cathode of Diode string D_{C} and the drain of transistor Q₁ and the source of transistor Q₅.

In this embodiment, Diode strings D_{A}, D_{B} and D_{C} provide first, second and third frequency spectrums of light, respectively, in response to receiving a bipolar digital drive signal S_{Drive} from switching circuit 122. The first, second and third frequency spectrums of light can be adjusted in response to adjusting bipolar digital drive signal S_{Drive}. Bipolar digital drive signal S_{Drive} can be adjusted in many different ways, such as by adjusting digital control signal S_{Control}. In this way, light emitting apparatus 100c provides controllable lighting.

In some embodiments, the amount of light provided by Diode string D_{A} is adjustable in response to adjusting a duty cycle of drive signal S_{Drive}. The amount of light provided by Diode string D_{A} increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100c provides controllable lighting.

In some embodiments, the amount of light provided by Diode strings D_{B} is adjustable in response to adjusting a duty cycle of drive signal S_{Drive}. The amount of light provided by Diode strings D_{B} increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100c provides controllable lighting.

In some embodiments, the amount of light provided by Diode strings D_{C} is adjustable in response to adjusting a duty cycle of drive signal S_{Drive}. The amount of light provided by Diode strings D_{C} increases and decreases in response to increasing and decreasing, respectively, the duty cycle of drive signal S_{Drive}. The duty cycle of drive signal S_{Drive} can be adjusted in many different ways, such as by adjusting the duty cycle of digital control signal S_{Control}. In this way, light emitting apparatus 100c provides controllable lighting.

FIG. 5b is a circuit diagram of one embodiment of load circuit 130c of FIG. 5a, wherein N=3 and M=2 and L=1 so that diode string D_{A} includes three diodes D_{A1}, D_{A2} and D_{A3} connected in series and diode string D_{B} includes two diodes D_{b1} and D_{B2} connected in series and diode string D_{C} includes one diode D_{C1}. In this embodiment, diodes D_{A1}, D_{A2} and D_{A3} are each the same types of diodes, although one or more of them can be different in other embodiments. In this embodiment, diodes D_{A1}, D_{A2} and D_{A3} are each the same types of diodes because they emit the same spectrum of light. In this embodiment, diodes D_{B1} and D_{B2} are each the same types of diodes, although one or more of them can be different in other embodiments. In this embodiment, diodes D_{B1} and D_{B2} are each the same types of diodes because they emit the same spectrum of light. In this embodiment, diodes D_{B1} and D_{B2} are each the same types of diodes, although one or more of them can be different in other embodiments.

In some embodiments, diodes D_{A1}, D_{A2} and D_{A3} are the same types of diodes as diodes D_{B1} and D_{B2}, although they can be different types in other embodiments. In some embodiments, diodes D_{A1}, D_{A2} and D_{A3} are the same types of diodes as diode D_{C1}, although they can be different types in other embodiments. In some embodiments, diodes D_{B1} and D_{B2} are the same types of diodes as diode D_{C1}, although they can be different types in other embodiments.

In some embodiments, diodes D_{A1}, D_{A2} and D_{A3} have the same diode threshold voltage value. For example, in some embodiments, diodes D_{A1}, D_{A2} and D_{A3} each have a diode threshold voltage value of 8 volts. In this way, diodes D_{A1}, D_{A2} and D_{A3} are each activated in response to driving the value of drive signal S_{Drive2} to be greater than or equal to 24 volts (i.e. more positive than or equal to 24 volts, such as 25 volts). Further, diodes D_{A1}, D_{A2} and D_{A3} are each deactivated in response to driving the value of drive signal S_{Drive2} to be less than 24 volts (i.e. less positive than 24 volts, such as 23 volts).

In one embodiment, diodes D_{A1}, D_{A2} and D_{A3} each have a diode threshold voltage value of 4 volts and diodes D_{B1} and D_{B2} each have a diode threshold voltage value of 6 volts and diode D_{C1} has a diode threshold voltage value of 12 volts. In this way, diodes D_{A1}, D_{A2} and D_{A3} are each activated in response to driving the value of drive signal S_{Drive2} to be greater than or equal to 12 volts (i.e. more positive than pr equal to 12 volts, such as 13 volts), and diodes D_{B1} and D_{B2} are activated in response to driving the value of drive signal S_{Drive3} to be less than or equal to −12 volts (i.e. more negative than or equal to −12 volts, such as −13 volts) and diode D_{C1} is activated in response to driving the value of drive signal S_{Drive1} to be less than or equal to −12 volts (i.e. more negative than or equal to −12 volts, such as −13 volts). Further, diodes D_{A1}, D_{A2} and are each deactivated in response to driving the value of drive signal S_{Drive2} to be less than 12 volts (i.e. less positive than 12 volts, such as 11 volts), and diodes D_{B1} and D_{B2} are deactivated in response to driving the value of drive signal S_{Drive3} to be greater than −12 volts (i.e. more positive than −12 volts, such as −11 volts) and diode D_{C1} is deactivated in response to driving the value of drive signal S_{Drive1} to be greater than −12 volts (i.e. more positive than −12 volts, such as −11 volts). In this embodiment, drive signals S_{Drive1}, S_{Drive2} and S_{Drive3} can each correspond to a bipolar digital signal.

One example of a bipolar digital signal that can correspond to drive signals S_{Drive1}, S_{Drive2} and S_{Drive3} is shown in FIG. 2d. Drive signals S_{Drive1} can correspond to a first version of bipolar digital signal S_{DC3} wherein V_{MAG1} corresponds to 12 volts and V_{MAG2} corresponds to −12 volts. Drive signals S_{Drive2} can correspond to a second version of bipolar digital signal S_{DC3} wherein V_{MAG1} corresponds to 12 volts and V_{MAG2} corresponds to −12 volts. Drive signals S_{Drive3} can correspond to a third version of bipolar digital signal S_{DC3} wherein V_{MAG1} corresponds to 12 volts and V_{MAG2} corresponds to −12 volts.

In another embodiment, diodes D_{A1}, D_{A2} and D_{A3} each have a diode threshold voltage value of 5 volts and diodes D_{B1} and D_{B2} each have a diode threshold voltage value of 4 volts and diode D_{C1} has a diode threshold voltage value of 6 volts. In this way, diodes D_{A1}, D_{A2} and D_{A3} are each activated in response to driving the value of drive signal S_{Drive2} to be greater than or equal to 15 volts (i.e. more positive than or equal to 15 volts, such as 16 volts), and diodes D_{B1} and D_{B2} are activated in response to driving the value of drive signal S_{Drive3} to be less than or equal to −8 volts (i.e. more negative than or equal to −8 volts, such as −9 volts) and diode D_{C1} is activated in response to driving the value of drive signal S_{Drive1} to be less than or equal to −6 volts (i.e. more negative than or equal to −6 volts, such as −7 volts).

Further, diodes D_{A1}, D_{A2} and D_{A3} are each deactivated in response to driving the value of drive signal S_{Drive2} to be less than 24 volts (i.e. less positive than 24 volts, such as 23 volts), and diode D_{B1} is deactivated in response to driving the value of drive signal S_{Drive3} to be greater than −8 volts (i.e. more positive than −8 volts, such as −7 volts) and diode D_{C1} is deactivated in response to driving the value of drive signal S_{Drive1} to be greater than −6 volts (i.e. more positive than −6 volts, such as −5 volts).

One example of a bipolar digital signal that can correspond to drive signals S_{Drive1}, S_{Drive2} and S_{Drive3} is shown in FIG. 2d. Drive signals can correspond to a first version of bipolar digital signal S_{DC3} wherein V_{MAG1} corresponds to 15 volts and V_{MAG2} corresponds to −15 volts. Drive signals S_{Drive3} can correspond to a second version of bipolar digital signal S_{DC3} wherein V_{MAG1} corresponds to 8 volts and V_{MAG2} corresponds to −8 volts. Drive signals S_{Drive3} can correspond to a third version of bipolar digital signal S_{DC3} wherein V_{MAG1} corresponds to 6 volts and V_{MAG2} corresponds to −6 volts.

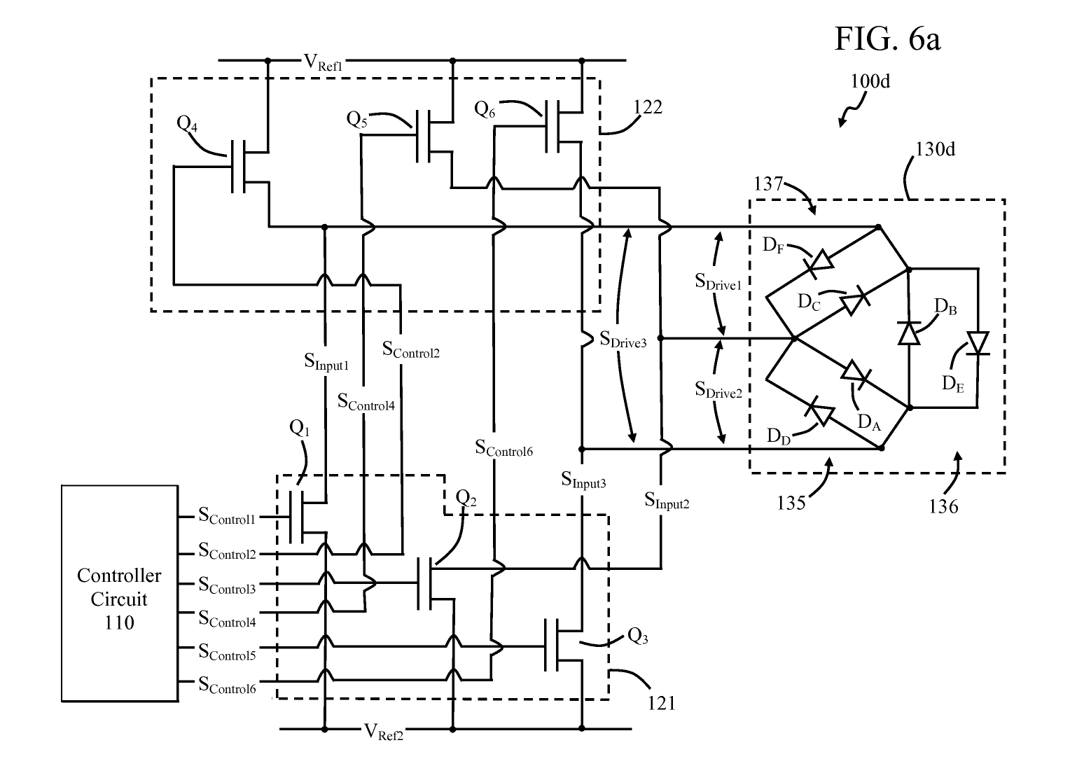

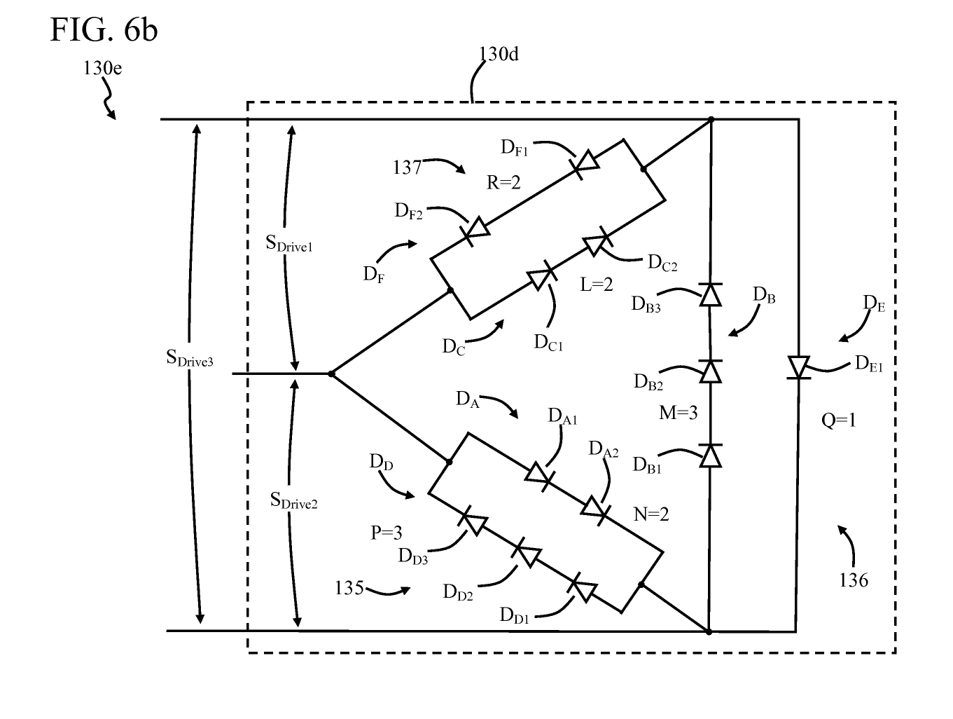

FIG. 6A is a circuit diagram of another embodiment of light emitting apparatus 100a of FIG. 3, which is denoted as circuit diagram 100d. In this embodiment, light emitting apparatus 100d includes load circuit 130, denoted as a load circuit 130d, operatively coupled to controller circuit 110 through drive circuit 120. In this embodiment, drive circuit 120 includes drive input circuit 121 operatively coupled to controller circuit 110 and switching circuit 122 operatively coupled to drive input circuit 121 and load circuit 130d.

In this embodiment, drive input circuit 121 includes transistors Q1, Q2 and Q3, which operate as switches, as will be discussed in more detail below. Transistors Q1, Q2 and Q3 can be of many different types. In this embodiment, transistors Q1, Q2 and Q3 are embodied as MOSFETs.

In this embodiment, the control terminal of transistor Q1 is connected to the first output of controller circuit 110 so it receives a digital control signal SControl1, and the control terminal of transistor Q2 is connected to the third output of controller circuit 110 so it receives a digital control signal SControl3 and the control terminal of transistor Q3 is connected to a fifth output of controller circuit 110 so it receives a digital control signal SControl5. In this embodiment, the source terminals of transistors Q1, Q2 and Q3 are connected to the reference terminal which applies reference voltage VRef2, and the drain terminals of transistors Q1, Q2 and Q3 are connected to switching circuit 122 and provide drive input signals SInput1, SInput2 and SInput3, respectively.

In this embodiment, switching circuit 122 includes transistors Q₄, Q₅ and Q₆, which operate as switches, as will be discussed in more detail below. Transistors Q₄, Q₅ and Q₆ can be of many different types. In this embodiment, transistors Q₄, Q₅ and Q₆ are embodied as MOSFETs.

In this embodiment, the control terminal of transistor Q₄ is connected to an output of controller circuit 110 so it receives the digital control signal S_{Control2}, the control terminal of transistor Q₅ is connected to an output of controller circuit 110 so it receives a digital control signal S_{Control4} and the control terminal of transistor Q₆ is connected to an output of controller circuit 110 so it receives a digital control signal S_{Control6}.

Further, the source of transistor Q₄ is connected to the drain of transistor Q₁, the source of transistor Q₅ is connected to the drain of transistor Q₂ and the source of transistor Q₆ is connected to the drain of transistor Q₃. In this embodiment, the sources of transistors Q₄, Q₅ and Q₆ are connected to load circuit 130d, as will be discussed in more detail below.

It should be noted that drive input circuit 121 provides drive input signals S_{Input1}, S_{Input2} and S_{Input3} to switching circuit 122, wherein drive input signals S_{Input1} flows between the drain of transistor Q₁ and the source of transistor Q₄, drive input signals S_{Input2} flows between the drain of transistor Q₂ and the source of transistor Q₅ and drive input signals S_{Input3} flows between the drain of transistor Q₃ and the source of transistor Q₆.

In this embodiment, the drains of transistors Q₄, Q₅ and Q₆ are connected to the reference terminal which applies the reference voltage V_{Ref1}. It should be noted that, in this embodiment, reference voltage V_{Ref1} is greater than reference voltage V_{Ref2}. However, reference voltage V_{Ref1} is less than reference voltage V_{Ref2} in other embodiments. As will be discussed in more detail below, more than one drive signal is provided by switching circuit 122 to load circuit 130d.

In this embodiment, load circuit 130d includes light emitting sub-circuits 135, 136 and 137. It should be noted that light emitting sub-circuits 135, 136 and 137 can each include an Diode string, as described in more detail above with FIG. 4a. For example, in this embodiment, light emitting sub-circuit 135 includes Diode strings D_{A} and D_{D} connected in parallel. Further, light emitting sub-circuit 136 includes Diode strings D_{B} and D_{E} connected in parallel and light emitting sub-circuit 137 includes Diode strings D_{C} and D_{F} connected in parallel. It should be noted that Diode strings D_{A} and D_{D} are connected in parallel in the same manner as described above in FIG. 4a, Diode strings D_{B} and D_{E} are connected in parallel in the same manner as described above in FIG. 4a and Diode strings D_{C} and D_{F} are connected in parallel in the same manner as described above in FIG. 4a.

In this embodiment, light emitting sub-circuit 135 is connected to the source of transistor Q₅ so that the anode of Diode string D_{A} is connected to the source of transistor Q₅ and the cathode of Diode string D_{D} is connected to the source of transistor Q₅. As mentioned above, the source of transistor Q₅ is connected to the drain of transistor Q₂. Hence, the anode of Diode string D_{A} is connected to the drain of transistor Q₂ and the cathode of Diode string D_{D} is connected to the drain of transistor Q₂.

In this embodiment, light emitting sub-circuit 135 is connected to the drain of transistor Q₃ so that the cathode of Diode string D_{A} is connected to the drain of transistor Q₃ and the anode of Diode string D_{D} is connected to the drain of transistor Q₃. As mentioned above, the drain of transistor Q₃ is connected to the source of transistor Q₆. Hence, the cathode of Diode string D_{A} is connected to the source of transistor Q₆ and the anode of Diode string D_{D} is connected to the source of transistor Q₆.

In this embodiment, light emitting sub-circuit 136 is connected to the source of transistor Q₄ so that the anode of Diode string D_{E} is connected to the source of transistor Q₄ and the cathode of Diode string D_{B} is connected to the source of transistor Q₄. As mentioned above, the drain of transistor Q₁ is connected to the source of transistor Q₄. Hence, the anode of Diode string D_{E} is connected to the drain of transistor Q₁ and the cathode of Diode string D_{B} is connected to the drain of transistor Q₁.

In this embodiment, light emitting sub-circuit 136 is connected to the drain of transistor Q₃ so that the anode of Diode string D_{B} is connected to the drain of transistor Q₃ and the cathode of Diode string D_{E} is connected to the drain of transistor Q₄. As mentioned above, the drain of transistor Q₃ is connected to the source of transistor Q₆. Hence, the anode of Diode string D_{B} is connected to the drain of transistor Q₃ and the cathode of Diode string D_{E} is connected to the drain of transistor Q₄.

In this embodiment, light emitting sub-circuit 137 is connected to the source of transistor Q₄ so that the anode of Diode string D_{F} is connected to the source of transistor Q₄ and the cathode of Diode string D_{C} is connected to the source of transistor Q₄. As mentioned above, the drain of transistor Q₁ is connected to the source of transistor Q₄. Hence, the anode of Diode string D_{F} is connected to the drain of transistor Q₁ and the cathode of Diode string D_{C} is connected to the drain of transistor Q₁.

In this embodiment, light emitting sub-circuit 137 is connected to the source of transistor Q₅ so that the cathode of Diode string D_{F} is connected to the source of transistor Q₅ and the anode of Diode string D_{C} is connected to the source of transistor Q₅. As mentioned above, the drain of transistor Q₂ is connected to the source of transistor Q₅. Hence, the cathode of Diode string D_{F} is connected to the drain of transistor Q₂ and the anode of Diode string D_{C} is connected to the drain of transistor Q₂.

FIG. 6b is a circuit diagram of one embodiment of load circuit 130c of FIG. 6a, wherein N=2 and M=3 and L=2 so that diode string D_{A} includes two diodes D_{A1} and D_{A2} connected in series and diode string D_{B} includes three diodes D_{B1}, D_{B2} and D_{B3} connected in series and diode string D_{C} includes two diodes D_{C1} and D_{C2}. Further, in this embodiment of load circuit 130c, P=3 and Q=1 and R=2 so that diode string D_{D} includes three diodes D_{D1}, D_{D2} and D_{D3} connected in series and diode string D_{E} includes one diode D_{E1} and diode string D_{F} includes two diodes D_{F1} and D_{F2} connected in series.

In this embodiment, diodes D_{A1} and D_{A2} are each the same types of diodes, although one or more of them can be different in other embodiments. In some embodiments, diodes D_{A1} and D_{A2} have the same diode threshold voltage value. For example, in some embodiments, diodes D_{A1} and D_{A2} each have a diode threshold voltage value of 8 volts. In one embodiment, diodes D_{A1} and D_{A2} each have a diode threshold voltage value of 4 volts and diodes D_{B1} and D_{B2} each have diode threshold voltage values of 6 volts and diodes D_{C1} and D_{C2} each have a diode threshold voltage value of 12 volts. In other embodiments, diodes D_{A1} and D_{A2} have different diode threshold voltage values.

In this embodiment, diodes D_{B1}, D_{B2} and D_{B3} are each the same types of diodes, although one or more of them can be different in other embodiments. In some embodiments, diodes D_{B1}, D_{B2} and D_{B3} have the same diode threshold voltage value. For example, in some embodiments, diodes D_{B1}, D_{B2} and D_{B3} each have a diode threshold voltage value of 12 volts. In one embodiment, diodes D_{B1}, D_{B2} and D_{B3} each have a diode threshold voltage value of 6 volts and diodes D_{A1} and D_{A2} each have diode threshold voltage values of 4 volts and diodes D_{C1} and D_{C2} each have a diode threshold voltage value of 12 volts. In other embodiments, diodes D_{B1} and D_{B2} have different diode threshold voltage values.

In this embodiment, diodes D_{C1} and D_{C2} are each the same types of diodes, although one or more of them can be different in other embodiments. In some embodiments, diodes D_{C1} and D_{C2} have the same diode threshold voltage value. For example, in some embodiments, diodes D_{C1} and D_{C2} each have a diode threshold voltage value of 12 volts. In one embodiment, diodes D_{C1} and D_{C2} each have a diode threshold voltage value of 6 volts and diodes D_{A1} and D_{A2} each have diode threshold voltage values of 4 volts and diodes D_{B1}, D_{B2} and D_{B3} each have a diode threshold voltage value of 12 volts.

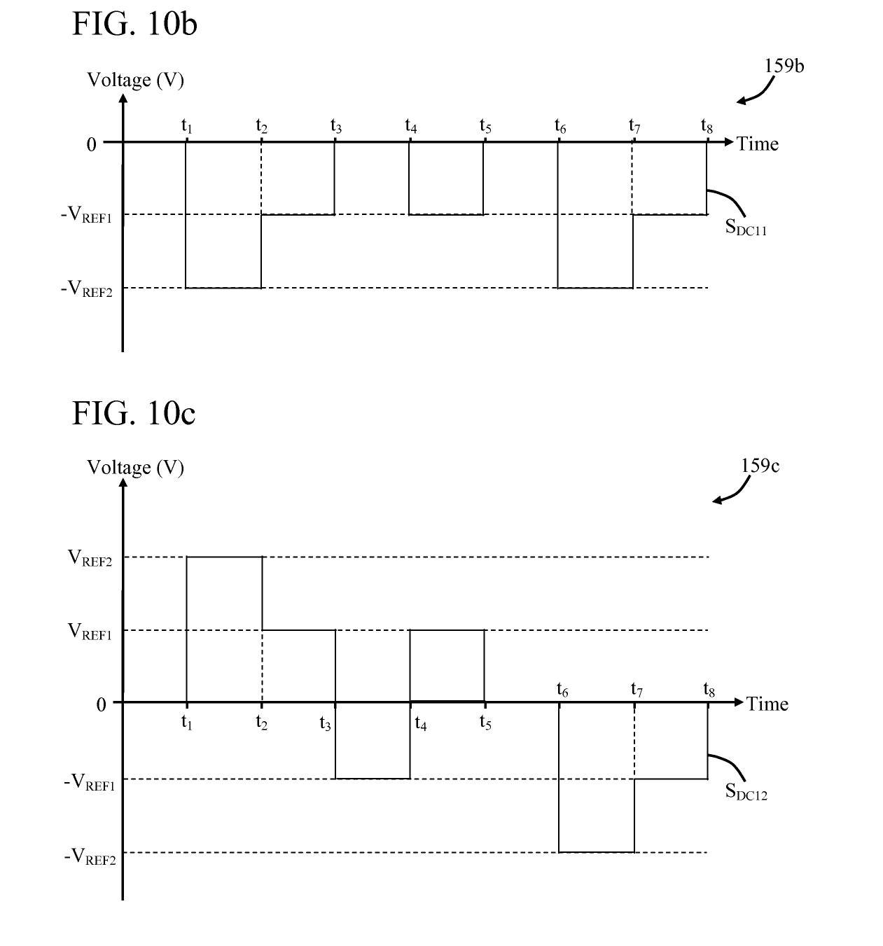

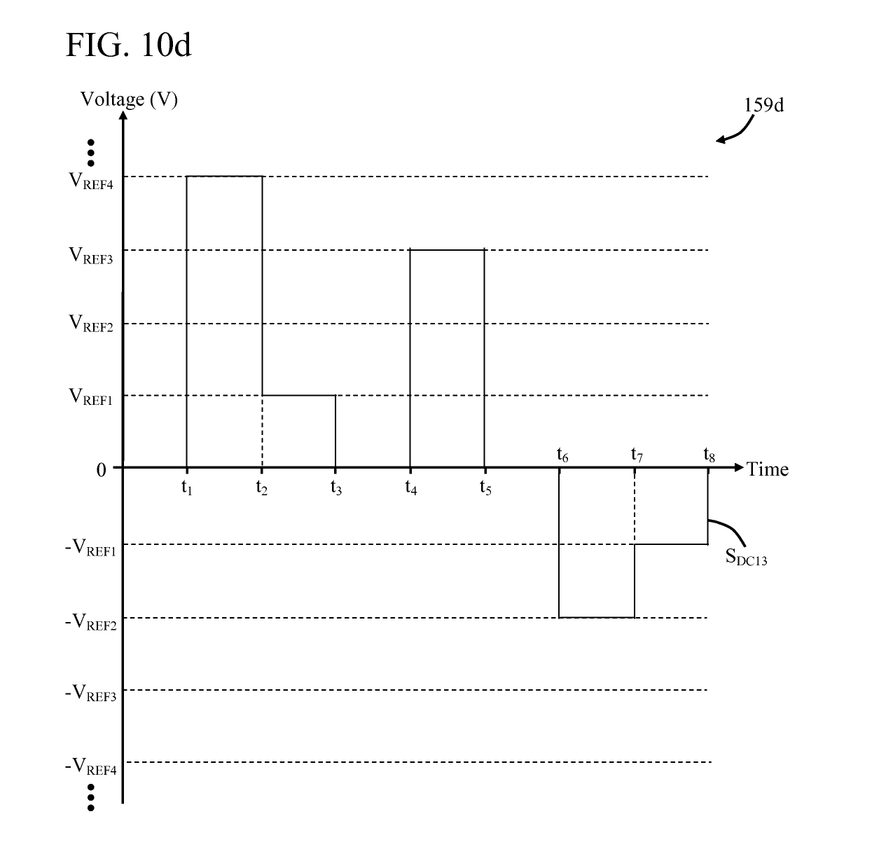

In other embodiments, diodes D_{C1} and D_{C2} have different diode threshold voltage values, so that diodes D_{C1} and D_{C2} are activated in response to different amplitude signals. Signals having different amplitudes are discussed in more detail above, as well as below with FIGS. 10a, 10b, 10c and 10d.

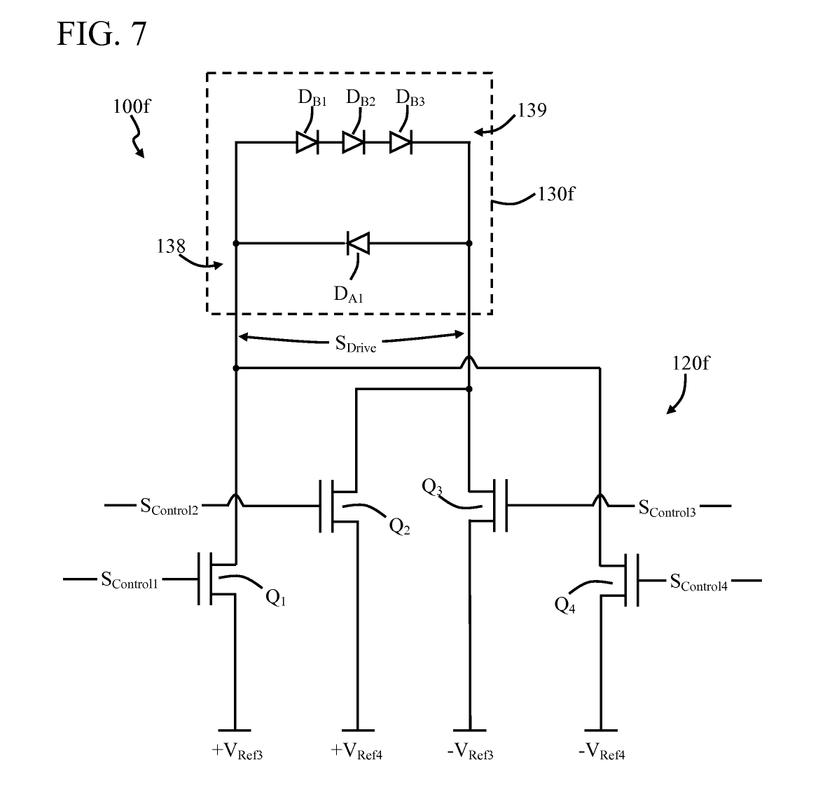

FIG. 7 is a circuit diagram of one embodiment of a light emitting apparatus 100f. In this embodiment, light emitting apparatus 100f includes a load circuit 130f operatively coupled to controller circuit 110 (not shown) through a drive circuit 120f. Drive circuit 120f provides drive signal S_{Drive} to load circuit 130f in response to receiving control signals S_{Control1}, S_{Control2}, S_{Control3} and S_{Control4} from controller circuit 110.

In this embodiment, drive circuit 120f includes transistors Q₁, Q₂, Q₃ and Q₄, which operate as switches, as will be discussed in more detail below. Transistors Q₁, Q₂, Q₃ and Q₄ are operatively coupled to load circuit 130d. Transistors Q₁, Q₂, Q₃ and Q₄ can be of many different types. In this embodiment, transistors Q₁, Q₂, Q₃ and Q₄ are embodied as MOSFETs.

In this embodiment, the control terminal of transistor Q₁ is connected to the first output of controller circuit 110 so it receives digital control signal S_{Control1}, the control terminal of transistor Q₂ is connected to the second output of controller circuit 110 so it receives digital control signal S_{Control2}, the control terminal of transistor Q₃ is connected to a third output of controller circuit 110 so it receives a digital control signal S_{Control3} and the control terminal of transistor Q₃ is connected to a fourth output of controller circuit 110 so it receives digital control signal S_{Control4}.

In this embodiment, the source terminals of transistors Q₁, Q₂, Q₃ and Q₄ are connected to separate reference terminals which apply reference voltages V_{Ref3}, V_{Ref4}, −V_{Ref3} and −V_{Ref4}, respectively. Further, the drain terminals of transistors Q₁ and Q₄ are connected together and to load circuit 130f, and the drain terminals of transistors Q₂ and Q₃ are connected together and to load circuit 130f.

In this embodiment, load circuit 130f includes a light emitting sub-circuit 138, which includes diode D_{A1}. It should be noted that, in general, light emitting sub-circuit 138 can include one or more diodes. However, light emitting sub-circuit 138 includes one diode in this embodiment for illustrative purposes. Diode D_{A1} includes an anode connected to the drains of transistors Q₂ and Q₃ and a cathode connected to the drains of transistors Q₁ and Q₄.

In this embodiment, load circuit 130f includes a light emitting sub-circuit 139, which includes diodes D_{B1}, D_{B2} and D_{B3}. It should be noted that, in general, light emitting sub-circuit 138 can include one or more diodes. However, light emitting sub-circuit 138 includes three diodes in this embodiment for illustrative purposes. Diodes D_{B1}, D_{B2} and D_{B3} are connected in series so that the cathode of diode D_{B1} is connected to the anode of diode D_{B2}, and the cathode of diode D_{B2} is connected to the anode of diode D_{B3}. Further, the cathode of diode D_{B3} is connected to the drains of transistors Q₂ and Q₃. In this way, diodes D_{B1}, D_{B2} and D_{B3} are connected in series.

In this embodiment, light emitting sub-circuits 138 and 139 are connected in reverse parallel. Light emitting sub-circuits 138 and 139 are connected in reverse parallel so that the anode of diode D_{B1} is connected to the cathode of transistor D_{A1} and the cathode of transistor D_{B3} is connected to the anode of transistor D_{A1}. In this way, light emitting sub-circuits 138 and 139 are connected in reverse parallel.

In this embodiment, the anode of diode D_{B1} and the cathode of transistor D_{A1} are connected to the drains of Q₁ and Q₄ and the cathode of transistor D_{B3} and the anode of transistor D_{A1} are connected to the drains of transistors Q₂ and Q₃. In this way, load circuit 130f is connected to drive circuit 120f.

In this embodiment, the diodes of light emitting sub-circuit 139 are the same types of diodes because diodes D_{B1}, D_{B2}, and D_{B3} are the same types of diodes. However, in other embodiments, one or more of diodes D_{B1}, D_{B2}, and D_{B3} are different. For example, in one embodiment, diode D_{B1} and D_{B2} are the same types of diodes and diode D_{B3} is a different type of diode from diodes D_{B1} and D_{B2}. In some embodiments, diode D_{A1} is the same type of diode as diodes D_{B1}, D_{B2}, and D_{B3}. However, in other embodiments, diode D_{A1} is a different type of diode from diodes D_{B1}, D_{B2}, and D_{B3}.

In some embodiments, diodes D_{B1}, D_{B2} and D_{B3} have the same diode threshold voltage value. For example, in some embodiments, diodes D_{B1}, D_{B2} and D_{B3} each have a diode threshold voltage value of 8 volts. In this way, diodes D_{B1}, D_{B2} and D_{B3} are each activated in response to driving the value of drive signal S_{Drive} to be greater than or equal to 24 volts (i.e. more positive than or equal to 24 volts, such as 25 volts). Further, diodes D_{B1}, D_{B2} and D_{B3} are each deactivated in response to driving the value of drive signal S_{Drive} to be less than 24 volts (i.e. less positive than 24 volts, such as 23 volts).

In one embodiment, diodes D_{B1}, D_{B2} and D_{B3} each have a diode threshold voltage value of 4 volts and diode D_{A1} has a diode threshold voltage value of 6 volts. In this way, diodes D_{B1}, D_{B2} and D_{B3} are each activated in response to driving the value of drive signal S_{Drive} to be greater than or equal to 12 volts (i.e. more positive than pr equal to 12 volts, such as 13 volts), and diode D_{A1} is activated in response to driving the value of drive signal S_{Drive} to be less than or equal to −6 volts (i.e. more negative than or equal to −6 volts, such as −7 volts). Further, diodes D_{B1}, D_{B2} and D_{B3} are each deactivated in response to driving the value of drive signal S_{Drive} to be less than 12 volts (i.e. less positive than 12 volts, such as 11 volts), and diode D_{A1} is deactivated in response to driving the value of drive signal S_{Drive} to be greater than −6 volts (i.e. more positive than −6 volts, such as −5 volts). In this embodiment, drive signal S_{Drive} can correspond to a bipolar digital signal, as will be discussed in more detail presently.

One example of a bipolar digital signal that can correspond to drive signal S_{Drive} is shown in FIG. 2d. Drive signal S_{Drive} can correspond to a version of bipolar digital signal S_{DC3} wherein V_{MAG1} corresponds to 12 volts and V_{MAG2} corresponds to −12 volts.

In another embodiment, diodes D_{B1}, D_{B2} and D_{B3} each have a diode threshold voltage value of 5 volts and diode D_{A1} has a diode threshold voltage value of 4 volts. In this way, diodes D_{A1}, D_{A2} and D_{A3} are each activated in response to driving the value of drive signal S_{Drive2} to be greater than or equal to 15 volts (i.e. more positive than or equal to 15 volts, such as 16 volts), and diode D_{A1} is activated in response to driving the value of drive signal S_{Drive3} to be less than or equal to −5 volts (i.e. more negative than or equal to −5 volts, such as −6 volts).

Further, diodes D_{B1}, D_{B2} and D_{B3} are each deactivated in response to driving the value of drive signal S_{Drive3} to be less than 15 volts (i.e. less positive than 15 volts, such as 14 volts), and diode D_{A1} is deactivated in response to driving the value of drive signal S_{Drive3} to be greater than −5 volts (i.e. more positive than −5 volts, such as −4 volts).

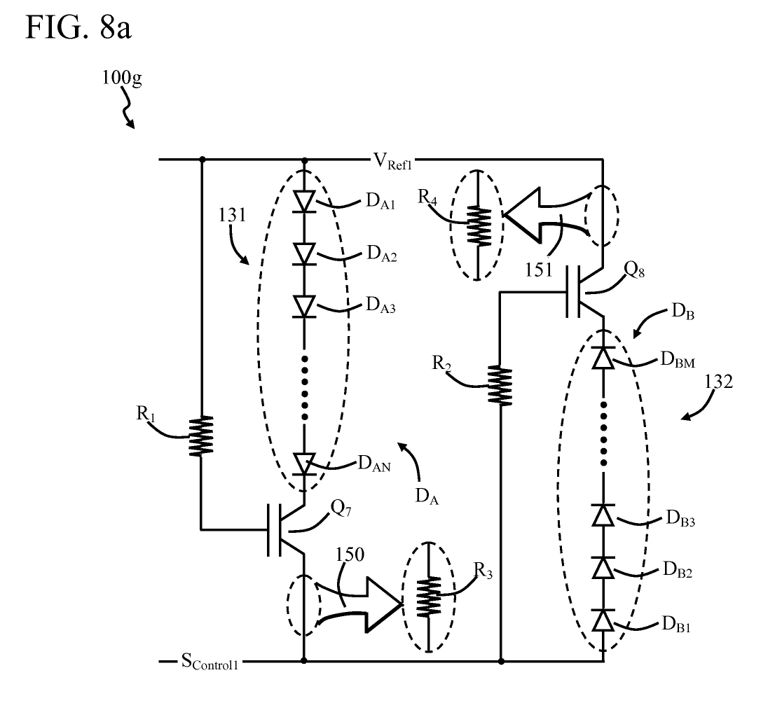

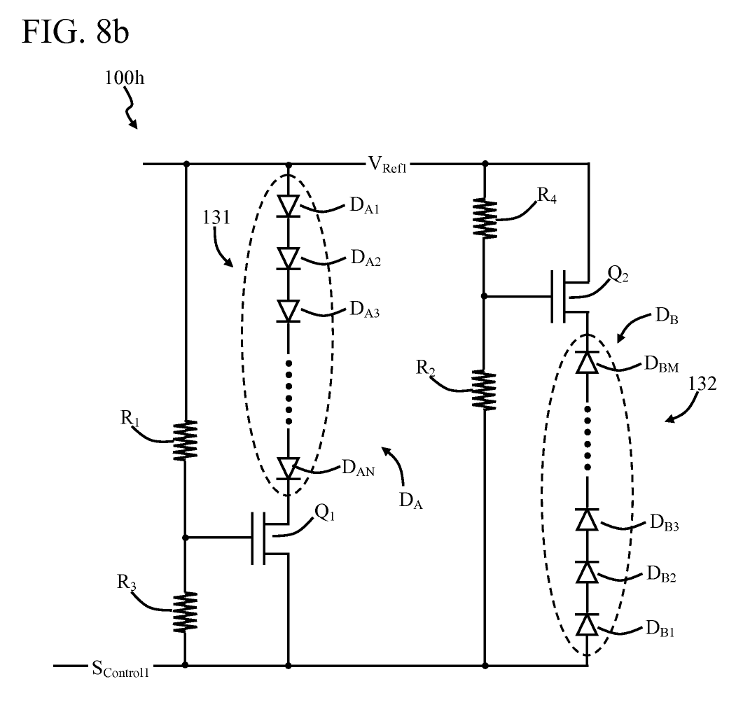

FIG. 8a is a circuit diagram of one embodiment of a light emitting apparatus 100g. In this embodiment, light emitting apparatus 100g includes transistors Q₇ and Q₈, which operate as switches, as will be discussed in more detail below. Transistors Q₇ and Q₈ can be of many different types. In this embodiment, transistors Q₇ and Q₈ are embodied as MOSFETs.

In this embodiment, the source of transistor Q₇ is connected to the first output of controller circuit 110 (not shown) so it receives digital control signal S_{Control1}, and the control terminal of transistor Q₈ is connected to the first output of controller circuit 110 (not shown) through resistor R₂ so it receives digital control signal S_{Control1}. In some embodiments, resistor R₃ is connected between the source of transistor Q₇ and the first output of controller circuit 110 that provides digital control signal S_{Control1}, as indicated by an indication arrow 150.

In this embodiment, the control terminal of transistor Q₈ is connected to a reference terminal which applies reference voltage V_{Ref1} through transistor R₁, and the drain terminal of transistor Q₈ is connected to the reference terminal which applies reference voltage V_{Ref1}. In this way, the control terminal of transistor Q₇ is connected to the drain terminal of transistor Q₈ through resistor R₁ and the reference terminal which applies reference voltage V_{Ref1}. In some embodiments, resistor R₄ is connected between the drain of transistor Q₈ and reference terminal which applies reference voltage V_{Ref1}, as indicated by an indication arrow 151. In this way, the control terminal of transistor Q₇ is connected to the drain terminal of transistor Q₈ through resistors R₁ and R₄ and the reference terminal which applies reference voltage V_{Ref1}.

In this embodiment, light emitting apparatus 100g includes light emitting sub-circuit 131 connected to the drain of transistor Q₇ and the reference terminal which applies reference voltage V_{Ref1}. In this embodiment, light emitting apparatus 100g includes diode string D_{A}, wherein diode string D_{A} includes diodes D_{A1}, D_{A2}, D_{A3}, . . . D_{AN}. Diode string D_{A} is discussed in more detail above.

In this embodiment, light emitting apparatus 100g includes light emitting sub-circuit 132 connected to the source of transistor Q₈ and the first output of controller circuit 110 (not shown) that provides digital control signal S_{Control1}. In this embodiment, light emitting apparatus 100g includes diode string D_{B}, wherein diode string D_{B} includes diodes D_{B1}, D_{B2}, D_{B3}, . . . D_{BN}. Diode string D_{B} is discussed in more detail above.

FIG. 8b is a circuit diagram of one embodiment of a light emitting apparatus 100h. In this embodiment, light emitting apparatus 100h includes transistors Q₇ and Q₈, which operate as switches, as will be discussed in more detail below. Transistors Q₇ and Q₈ can be of many different types. In this embodiment, transistors Q₇ and Q₈ are embodied as MOSFETs.

In this embodiment, the source of transistor Q₇ is connected to the first output of controller circuit 110 (not shown) so it receives digital control signal S_{Control1}, and the control terminal of transistor Q₈ is connected to the first output of controller circuit 110 (not shown) through resistor R₂ so it receives digital control signal S_{Control1}. In some embodiments, resistor R₃ is connected between the source of transistor Q₇ and the first output of controller circuit 110 that provides digital control signal S_{Control1}, as indicated by an indication arrow 150.

In this embodiment, the control terminal of transistor Q₈ is connected to a reference terminal which applies reference voltage V_{Ref1} through transistor R₁, and the drain terminal of transistor Q₈ is connected to the reference terminal which applies reference voltage V_{Ref1}. In this way, the control terminal of transistor Q₇ is connected to the drain terminal of transistor Q₈ through resistor R₁ and the reference terminal which applies reference voltage V_{Ref1}. In some embodiments, resistor R₄ is connected between the drain of transistor Q₈ and reference terminal which applies reference voltage V_{Ref1}, as indicated by an indication arrow 151. In this way, the control terminal of transistor Q₇ is connected to the drain terminal of transistor Q₈ through resistors R₁ and R₄ and the reference terminal which applies reference voltage V_{Ref1}.

In this embodiment, light emitting apparatus 100h includes light emitting sub-circuit 131 connected to the drain of transistor Q₇ and the reference terminal which applies reference voltage V_{Ref1}. In this embodiment, light emitting apparatus 100h includes diode string D_{A}, wherein diode string D_{A} includes diodes D_{A1}, D_{A2}, D_{A3}, . . . D_{AN}. Diode string D_{A} is discussed in more detail above.

In this embodiment, light emitting apparatus 100h includes light emitting sub-circuit 132 connected to the source of transistor Q₈ and the first output of controller circuit 110 (not shown) that provides digital control signal S_{Control1}. In this embodiment, light emitting apparatus 100h includes diode string D_{B}, wherein diode string D_{B} includes diodes D_{B1}, D_{B2}, D_{B3}, . . . D_{BN}. Diode string D_{B} is discussed in more detail above.

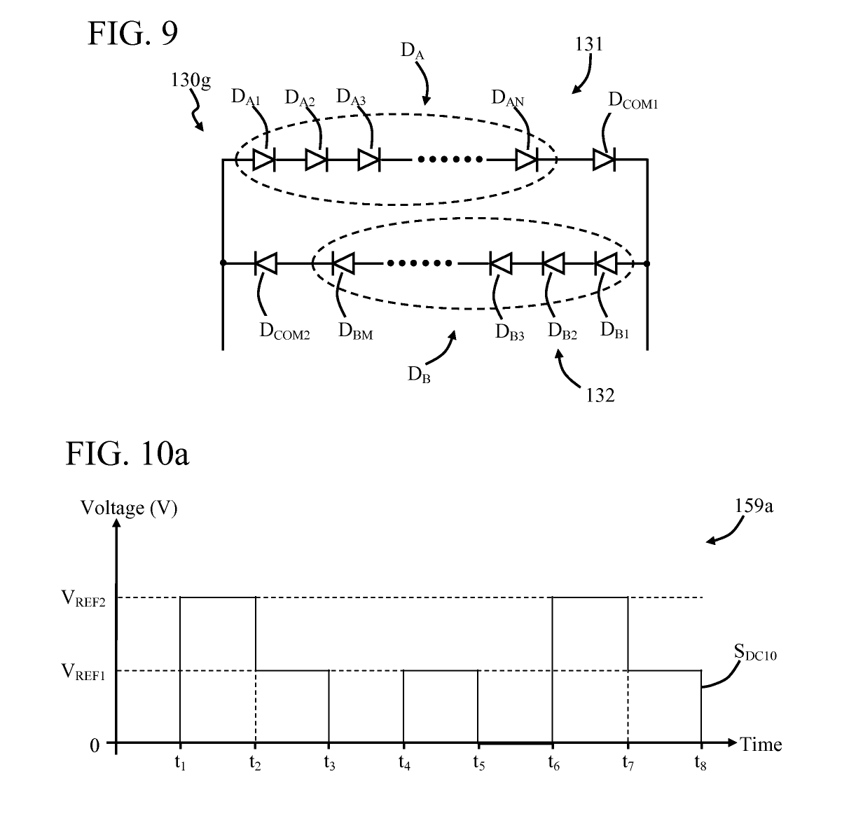

FIG. 9 is a circuit diagram of one embodiment of a load circuit 130g. In this embodiment, load circuit 130g includes light emitting sub-circuits 131 and 132 connected in reverse parallel, as discussed in more detail above with FIG. 4b. Load circuit 130g is driven by drive signal S_{Drive}, which is discussed in more detail above.

In this embodiment, diode string D_{A} includes diodes D_{A1}, D_{A2}, D_{A3}, . . . D_{AN} connected in series with a diode D_{COM1}, wherein D_{COM1} is a different type of diode than the diodes of diode string D_{A}. In this embodiment, diode D_{COM1} provides a different spectrum of light than the diodes of diode string D_{A}.

In one embodiment, diode D_{COM1} provides a spectrum of light at a higher frequency than the diodes of diode string D_{A}. For example, in one embodiment, diode string provides a visible spectrum of light and diode D_{COM1} provides an ultraviolet spectrum of light. In another embodiment, diode D_{COM1} provides a spectrum of light at a lower frequency than the diodes of diode string D_{A}. For example, in one embodiment, diode string provides a visible spectrum of light and diode D_{COM1} provides an infrared spectrum of light. In general, diode strings D_{A} and D_{B} provide visible light for illumination and diodes D_{COM1} and D_{COM2} provide light for communication. For example, diodes D_{COM1} and D_{COM2} can provide light pulses for communicating with an electronic device, such as a television. It should be noted that the visible light provided by diode strings D_{A} and D_{B} can illuminate the electronic device. Examples of drive signal S_{Drive} will be discussed in more detail presently. Light pulses are discussed in more detail above, such as with FIGS. 2h, 2i and 2j.

FIG. 10a is a graph 159a of an example of a multi-level DC signal S_{DC10}, wherein graph 159a corresponds to voltage verses time. In this example, multi-level DC signal S_{DC10} is a positive unipolar digital signal and can be periodic and non-periodic. DC signal S_{DC10} is a multi-level signal because it can have more than one non-zero voltage value. For example, in this embodiment, multi-level DC signal S_{DC10} has a value of V_{REF2} between times t₁ and t₂ and multi-level DC signal S_{DC10} has a value of V_{REF1} between times t₂ and t₃. Hence, multi-level DC signal S_{DC10} has magnitudes V_{Mag} which varies about positive reference voltages V_{REF1} and V_{REF2}, wherein V_{REF1} and V_{REF2} have positive voltage values. Reference voltages −V_{REF1} and V_{REF2} can have many different voltage values. In one embodiment, V_{REF1} and V_{REF2} are 12 volts and 24 volts, respectively. In another embodiment, V_{REF1} and V_{REF2} are 3 volts and 24 volts, respectively. Multi-level DC signal S_{DC12} has a value of zero volts between times t₃ and t₄, and Multi-level DC signal S_{DC12} has a value of zero volts between times t₅ and t₆.

In some embodiments, the value of V_{REF1} and V_{REF2} depends on the number of diodes included in a diode string that is driven by multi-level DC signal S_{DC10}. As the number of diodes increases and decreases, the positive value of V_{REF1} and V_{REF2} increase and decreases, respectively.

FIG. 10b is a graph 159b of an example of a multi-level DC signal S_{DC11}, wherein graph 159b corresponds to voltage verses time. In this example, multi-level DC signal S_{DC11} is a negative unipolar digital signal and can be periodic and non-periodic. DC signal S_{DC11} is a multi-level signal because it can have more than one non-zero voltage value. For example, in this embodiment, multi-level DC signal S_{DC11} has a value of −V_{REF2} between times t₁ and t₂ and multi-level DC signal S_{DC11} has a value of −V_{REF1} between times t₂ and t₃. Hence, multi-level DC signal S_{DC11} has magnitudes V_{Mag} which varies about negative reference voltages −V_{REF1} and −V_{REF2}, wherein −V_{REF1} and −V_{REF2} have negative voltage values. Reference voltages −V_{REF1} and −V_{REF2} can have many different voltage values. In one embodiment, −V_{REF1} and −V_{REF2} are −12 volts and −24 volts, respectively. In another embodiment, −V_{REF1} and −V_{REF2} are −3 volts and −24 volts, respectively. Multi-level DC signal S_{DC12} has a value of zero volts between times t₃ and t₄, and Multi-level DC signal S_{DC12} has a value of zero volts between times t₅ and t₆.

In some embodiments, the value of −V_{REF1} and −V_{REF2} depends on the number of diodes included in a diode string that is driven by multi-level DC signal S_{DC11}. As the number of diodes increases and decreases, the negative value of −V_{REF1} and −V_{REF2} increase and decreases, respectively.

FIG. 10c is a graph 159c of an example of a multi-level DC signal S_{DC12}, wherein graph 159c corresponds to voltage verses time. In this example, multi-level DC signal S_{DC12} is a bipolar digital signal and can be periodic and non-periodic. DC signal S_{DC12} is a multi-level signal because it can have more than one non-zero voltage value. For example, in this embodiment, multi-level DC signal S_{DC12} has a value of V_{REF2} between times t₁ and t₂ and multi-level DC signal S_{DC12} has a value of V_{REF1} between times t₂ and t₃. Multi-level DC signal S_{DC12} has a value of −V_{REF1} between times t₃ and t₄ and multi-level DC signal S_{DC12} has a value of V_{REF1} between times t₄ and t₅. Multi-level DC signal S_{DC12} has a value of −V_{REF2} between times t₆ and t₇ and multi-level DC signal S_{DC12} has a value of −V_{REF1} between times t₇ and t₈. Multi-level DC signal S_{DC12} has a value of zero volts between times t₅ and t₆.

Hence, multi-level DC signal S_{DC12} has magnitudes V_{Mag} which varies about positive reference voltages V_{REF1} and V_{REF2}, wherein V_{REF1} and V_{REF2} have positive voltage values. Further, multi-level DC signal S_{DC12} has magnitudes V_{Mag} which varies about negative reference voltages −V_{REF1} and −V_{REF2}, wherein −V_{REF1} and −V_{REF2} have negative voltage values.

Reference voltages V_{REF1} and V_{REF2} can have many different voltage values. In one embodiment, V_{REF1} and V_{REF2} are 12 volts and 24 volts, respectively. In another embodiment, V_{REF1} and V_{REF2} are 3 volts and 12 volts, respectively.

Reference voltages −V_{REF1} and −V_{REF2} can have many different voltage values. In one embodiment, −V_{REF1} and −V_{REF2} are −12 volts and −24 volts, respectively. In another embodiment, −V_{REF1} and −V_{REF2} are −3 volts and −24 volts, respectively. In another embodiment, −V_{REF1} and −V_{REF2} are −3 volts and −12 volts, respectively.

FIG. 10d is a graph 159d of an example of a multi-level DC signal S_{DC13}, wherein graph 159d corresponds to voltage verses time. In this example, multi-level DC signal S_{DC13} is a bipolar digital signal and can be periodic and non-periodic. DC signal S_{DC13} is a multi-level signal because it can have more than one non-zero voltage value. For example, in this embodiment, multi-level DC signal S_{DC13} has a value of V_{REF4} between times t₁ and t₂ and multi-level DC signal S_{DC13} has a value of V_{REF1} between times t₂ and t₃. Multi-level DC signal S_{DC13} has a value of V_{REF3} between times t₄ and t₅. Multi-level DC signal S_{DC13} has a value of −V_{REF2} between times t₆ and t₇ and multi-level DC signal S_{DC13} has a value of −V_{REF1} between times t₇ and t₈. Multi-level DC signal S_{DC13} has a value of zero volts between times t₃ and t₄, and Multi-level DC signal S_{DC13} has a value of zero volts between times t₅ and t₆.

Hence, multi-level DC signal S_{DC13} has magnitudes V_{Mag} which varies about positive reference voltages V_{REF1}, V_{REF2}, V_{REF3} and V_{REF4}, wherein V_{REF1}, V_{REF2}, V_{REF3} and V_{REF4} have positive voltage values and V_{REF4} is more positive than V_{REF3}, V_{REF3} is more positive than V_{REF2} and V_{REF2} is more positive than V_{REF1}.

Further, multi-level DC signal S_{DC13} has magnitudes V_{Mag} which varies about negative reference voltages −V_{REF1}, −V_{REF2}, −V_{REF3} and −V_{REF4}, wherein −V_{REF1}, −V_{REF2}, −V_{REF3} and −V_{REF4} have negative voltage values and −V_{REF4} is more negative than V_{REF3}, V_{REF3} is more negative than V_{REF2} and V_{REF2} is more negative than V_{REF1}.

Reference voltages V_{REF1}, V_{REF2}, V_{REF3} and V_{REF4} can have many different voltage values. In one embodiment, V_{REF1}, V_{REF2}, V_{REF3} and V_{REF4} are 3 volts, 6 volts, 12 volts and 24 volts, respectively.

Reference voltages −V_{REF1}, −V_{REF2}, −V_{REF3} and −V_{REF4} can have many different voltage values. In one embodiment, −V_{REF1}, −V_{REF2}, −V_{REF3} and −V_{REF4} are −3 volts, −6 volts, −12 volts and −24 volts, respectively.

In some embodiments, the number of reference voltage values depends on the number of light emitting sub-circuits. Further, as the number of light emitting sub-circuits increases and decreases, the number of reference voltage values increase and decreases, respectively. As the number of positive polarity light emitting sub-circuits increases and decreases, the number of positive reference voltage values increase and decreases, respectively. Further, as the number of negative polarity light emitting sub-circuits increases and decreases, the number of negative reference voltage values increase and decreases, respectively.

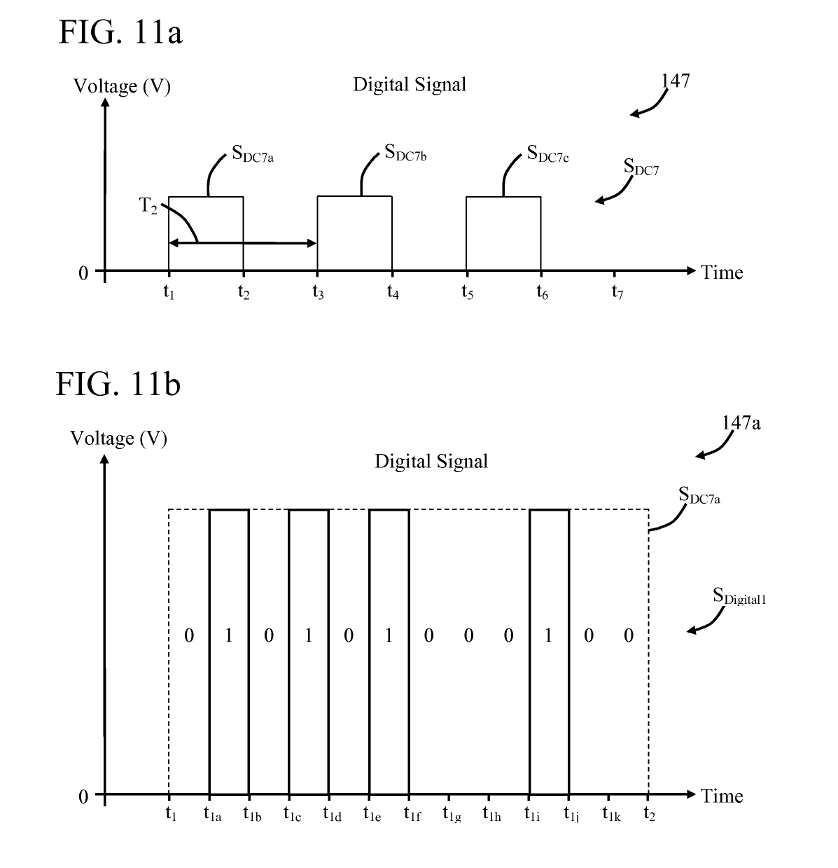

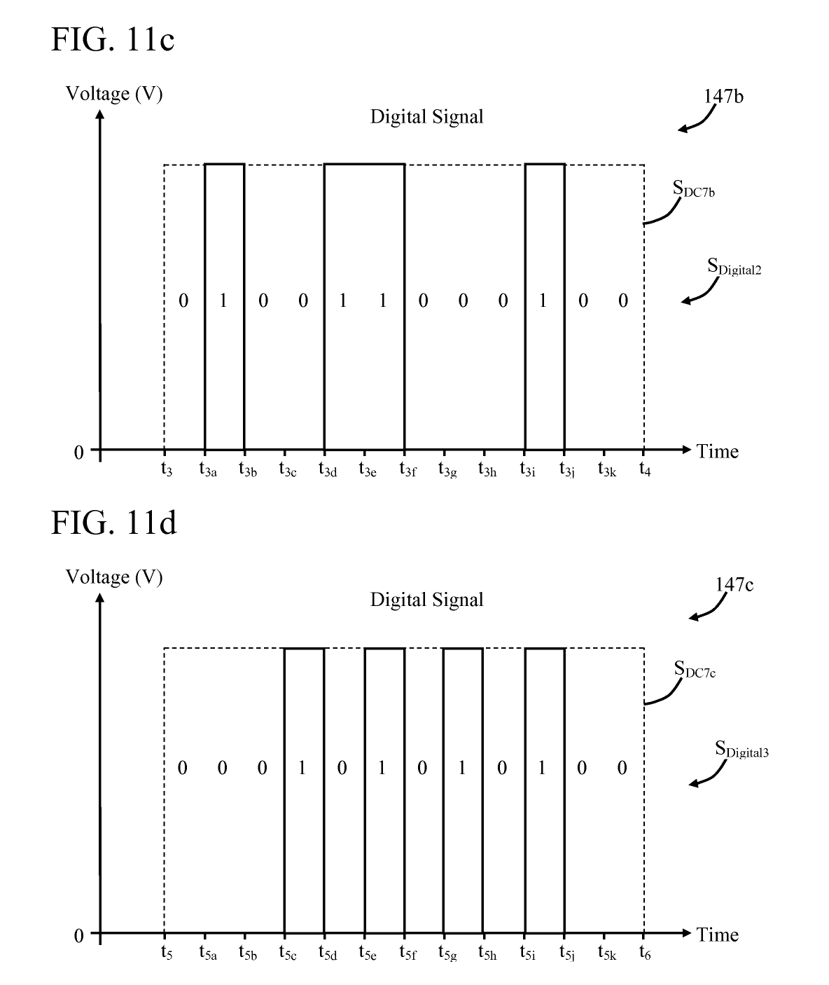

FIG. 11a is a graph 147 of an example of a positive unipolar digital signal S_{DC7} having a fifty percent (50%) duty cycle, wherein graph 147 corresponds to voltage verses time. More information regarding positive unipolar digital signal S_{DC7} is provided above with FIG. 2e. In this example, positive unipolar digital signal S_{DC7} is a periodic non-sinusoidal signal having period T₂. Signal S_{DC7} is a positive unipolar signal because it has positive voltage values for period T₂. It should be noted that the deactive edge of signal S_{DC7} has a zero voltage value, which is a positive voltage value, as mentioned above. Signal S_{DC7} is not a bipolar signal because signal S_{DC7} has positive voltage values for period T₂.

Positive unipolar digital signal S_{DC7} has a fifty percent (50%) duty cycle because the length of time of its active edge is the same as the length of time of its deactive edge. In this particular example, the active edge of signal S_{DC7} extends between times t₁ and t₂, wherein time t₂ is greater than time t₁. The portion of signal S_{DC7} with the active edge between times t₁ and t₂ is denoted as signal S_{DC7a}. Further, the deactive edge of signal S_{DC7} extends between times t₂ and t₃, wherein time t₃ is greater than time t₂. The active edge of signal S_{DC7} extends between times t₃ and t₄, wherein time t₄ is greater than time t₃. The portion of signal S_{DC7} with the active edge between times t₃ and t₄ is denoted as signal S_{DC7b}. Further, the deactive edge of signal S_{DC7} extends between times t₄ and t₅, wherein time t₅ is greater than time t₄. The active edge of signal S_{DC7} extends between times t₅ and t₆, wherein time t₆ is greater than time t₅. The portion of signal S_{DC7} with the active edge between times t₅ and t₆ is denoted as signal S_{DC7c}. Further, the deactive edge of signal S_{DC7} extends between times t₆ and t₇, wherein time t₇ is greater than time t₆.

Positive unipolar digital signal S_{DC7} has a fifty percent (50%) duty cycle because the time difference between times t₂ and t₁ is the same as the time difference between times t₃ and t₂. In this way, positive unipolar digital signal S_{DC7} has a fifty percent (50%) duty cycle because the length of time of its active edge is the same as the length of time of its deactive edge. It should be noted that, in this example, time t₁ corresponds to the time of the rising edge of signal S_{DC7}, time t₂ corresponds to the time of the falling edge of signal S_{DC7} and the difference between times t₁ and t₃ corresponds to period T₂. It should be noted that, in this example, Positive unipolar digital signal S_{DC7} has a fifty percent (50%) duty cycle between times t₃ and t₅ and between times t₅ and t₇.

FIG. 11b is a graph 147a of an example of a digital signal S_{Digital1} shown with positive unipolar digital signal S_{DC7a} (in phantom) of FIG. 11a, wherein graph 147a corresponds to voltage verses time.

It should be noted that digital signal S_{Digital1} can correspond to drive signal S_{Drive} of FIG. 10. In this example, the digital signal S_{Digital1} has

a zero value (“0”) between times t₁ and t₁ₐ,

a one value (“1”) between times t₁ₐ and t_{1b},

a zero value (“0”) between times t_{1b} and t_{1c},

a one value (“1”) between times t_{1c} and t_{1d},

a zero value (“0”) between times t_{1d} and t₁ₑ,

a one value (“1”) between times t₁ₑ and t_{1f},

a zero value (“0”) between times t_{1f} and t_{1g},

a zero value (“0”) between times t_{1g} and t₁ₕ,

a zero value (“0”) between times t₁ₕ and t₁ᵢ,

a one value (“1”) between times t₁ᵢ and t₁ⱼ,

a zero value (“0”) between times t₁ⱼ and t₁ₖ, and

a zero value (“0”) between times t₁ₖ and t₂.

It should be noted that (FIG. 11b)

time t₁ₐ is greater than time t₁,

time t_{1b} is greater than time t₁ₐ,

time t_{1c} is greater than time t_{1b},

time t_{1d} is greater than time t_{1c},

time t₁ₑ is greater than time t_{1d},

time t_{1f} is greater than time t₁ₑ,

time t_{1g} is greater than time t_{1f},

time t₁ₕ is greater than time t_{1g},

time t₁ᵢ is greater than time t₁ₕ,

time t₁ⱼ is greater than time t₁ᵢ,

time t₁ₖ is greater than time t₁ₕ and

time t₂ is greater than time t₁ₖ.

Digital signal S_{Digital1} has a duty cycle less than fifty percent (50%) because the length of time of its active edge is the less than the length of time of its deactive edge. In this particular example, the active edge of digital signal S_{Digital1} extends between times t₁ₐ and t_{1b}, times t_{1c} and t_{1d}, times t₁ₑ and t_{1f} and times t₁ᵢ and t₁ⱼ.

FIG. 11c is a graph 147b of an example of a digital signal S_{Digital2} shown with positive unipolar digital signal S_{DC7b} (in phantom) of FIG. 11a, wherein graph 147c corresponds to voltage verses time.

It should be noted that digital signal S_{Digital2} can correspond to drive signal S_{Drive} of FIG. 10. In this example, the digital signal S_{Digital2} has

a zero value (“0”) between times t₃ and t₃ₐ,

a one value (“1”) between times t₃ₐ and t_{3b},

a zero value (“0”) between times t_{3b} and t_{3c},

a zero value (“0”) between times t_{3c} and t_{3d},

a one value (“1”) between times t_{3d} and t₃ₑ,

a one value (“1”) between times t₃ₑ and t_{3f},

a zero value (“0”) between times t_{3f} and t_{3g},

a zero value (“0”) between times t_{3g} and t₃ₕ,

a zero value (“0”) between times t₃ₙ and t₃ᵢ,

a one value (“1”) between times t3i and t3j,

a value (“0”) between times t3j and t3k, and

a zero value (“0”) between times t3k and t4.

It should be noted that

time t₃ₐ is greater than time t₃,

time t_{3b} is greater than time t₃ₐ,

time t_{3c} is greater than time t_{3b},

time t_{3d} is greater than time t_{3c},

time t₃ₑ is greater than time t_{3d},

time t_{3f} is greater than time t₃ₑ,

time t_{3g} is greater than time t_{3f},

time t₃ₕ is greater than time t_{3g},

time t₃ᵢ is greater than time t₃ₕ,

time t₃ⱼ is greater than time t₃ᵢ,

time t₃ₖ is greater than time t₃ⱼ and

time t₄ is greater than time t₃ₖ.

Digital signal S_{Digital2} has a duty cycle less than fifty percent (50%) because the length of time of its active edge is the less than the length of time of its deactive edge. In this particular example, the active edge of digital signal S_{Digital1} extends between times t₃ₐ and t_{3b}, times t_{3d} and t₃ₑ, times t₃ₑ and t_{3f} and times t₃ᵢ and t₃ⱼ. It should be noted that the duty cycles of digital signal S_{Digital1} and S_{Digital2} are the same.

FIG. 11d is a graph 147c of an example of a digital signal S_{Digital3} shown with positive unipolar digital signal S_{DC7c} (in phantom) of FIG. 11a, wherein graph 147c corresponds to voltage verses time. It should be noted that digital signal S_{Digital3} can correspond to drive signal S_{Drive} of FIG. 10. In this example, the digital signal S_{Digital3} has

a zero value (“0”) between times t₅ and t₅ₐ,

a zero value (“0”) between times t₅ₐ and t_{5b},

a zero value (“0”) between times t_{5b} and t_{5c},

a one value (“1”) between times t_{5c} and t_{5d},

a zero value (“0”) between times t_{5d} and t₅ₑ,

a one value (“1”) between times t₅ₑ and t_{5f},

a zero value (“0”) between times t_{5f} and t_{5g},

a one value (“1”) between times t_{5g} and t₅ₕ,

a zero value (“0”) between times t₅ₕ and t₅ᵢ,

a one value (“1”) between times t₅ᵢ and t₅ⱼ,

a zero value (“0”) between times t₅ⱼ and t₅ₖ, and

a zero value (“0”) between times t₅ₖ and t₆.

It should be noted that

time t₅ₐ is greater than time t₅,

time t_{5b} is greater than time t₅ₐ,

time t_{5c} is greater than time t_{5b},

time t_{5d} is greater than time t_{5c},

time t₅ₑ is greater than time t_{5d},

time t_{5f} is greater than time t₅ₑ,

time t_{5g} is greater than time t_{5f},

time t₅ₕ is greater than time t_{5g},

time t₅ᵢ is greater than time t₅ₕ,

time t₅ⱼ is greater than time t₅ᵢ,

time t₅ₖ is greater than time t₅ⱼ and

time t₆ is greater than time t₅ₖ.

Digital signal S_{Digital3} has a duty cycle less than fifty percent (50%) because the length of time of its active edge is the less than the length of time of its deactive edge. In this particular example, the active edge of digital signal S_{Digital3} extends between times t_{5c} and t_{5d}, times t₅ₑ and t_{5f}, times t_{5g} and t₅ₕ and times t₅ᵢ and t₅ⱼ. Digital signal S_{Digital3} has a duty cycle less than fifty percent (50%) because the length of time of its active edge is the less than the length of time of its deactive edge. It should be noted that the duty cycles of digital signal S_{Digital1}, S_{Digital2} and S_{Digital3} are the same.

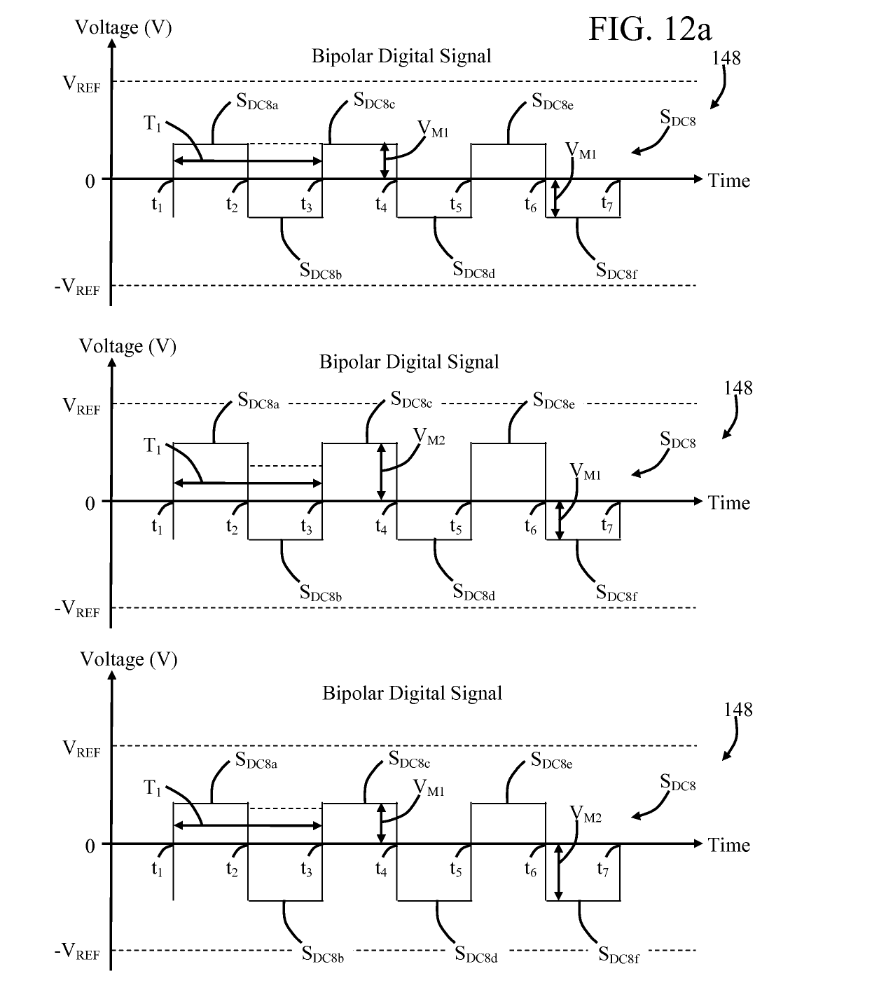

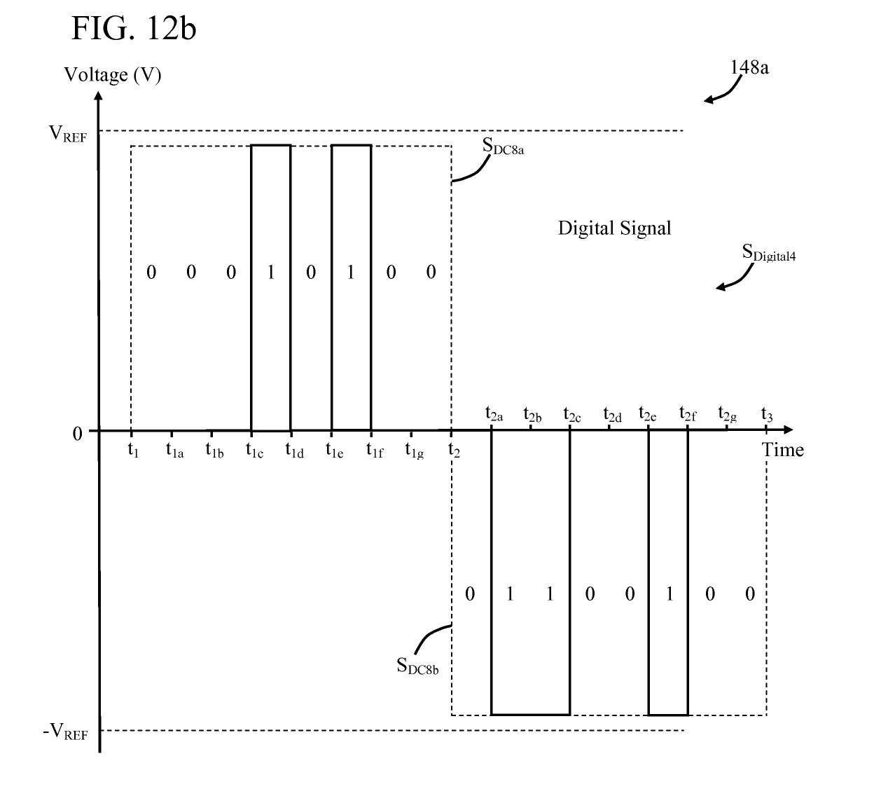

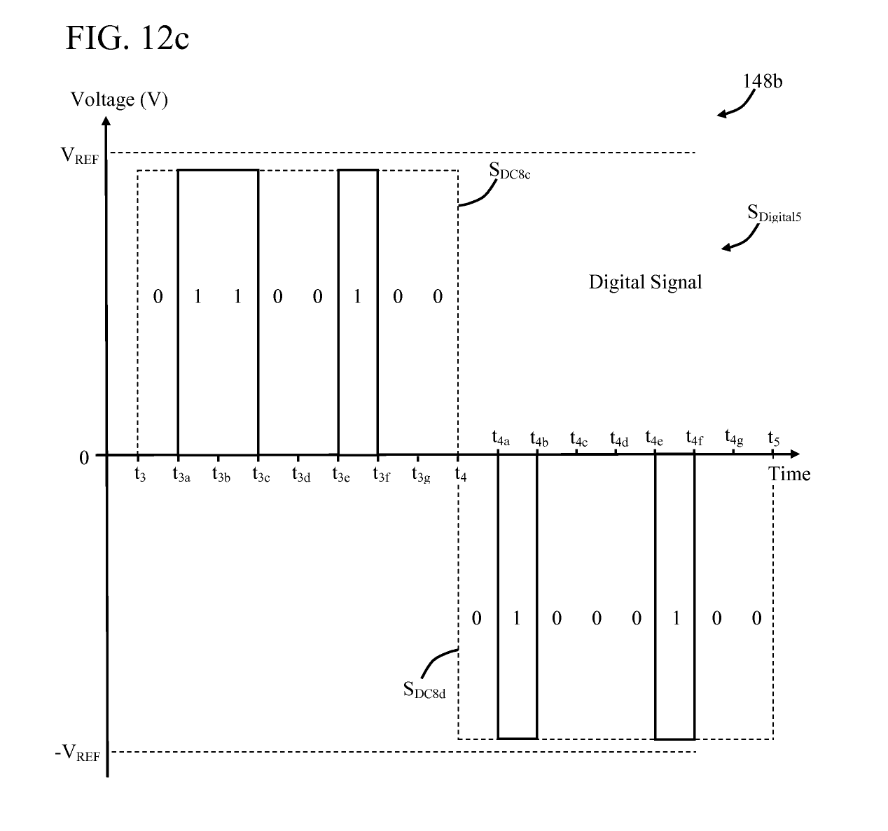

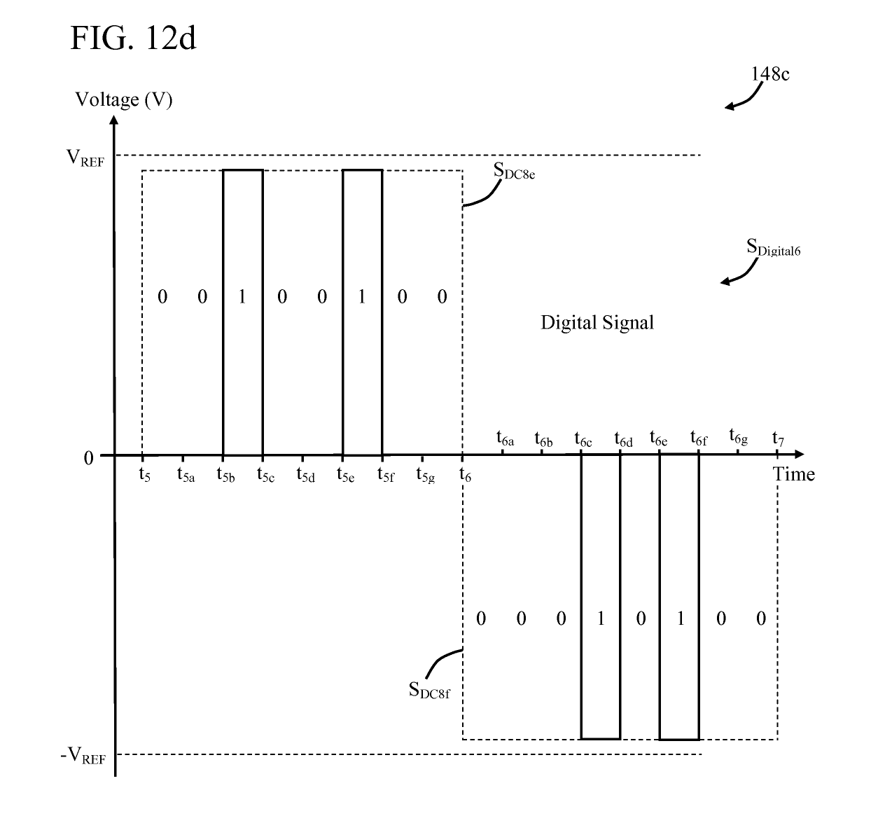

FIG. 12a is a graph 148 of an example of a bipolar digital signal S_{DC8}, wherein graph 148 corresponds to voltage verses time. More information regarding bipolar digital signals is provided above, such as with FIG. 2d. It should be noted that bipolar digital signal S_{DC8} can correspond to drive signal S_{Drive} of FIG. 10. In this example, bipolar digital signal S_{DC8} is a periodic non-sinusoidal signal having period T₁, and has a magnitude which varies about a zero voltage value. Bipolar digital signal S_{DC8} has positive and negative active edges, wherein the positive and negative active edges correspond to positive and negative voltage values, respectively, as will be discussed in more detail presently.

In this particular example, a first positive active edge of signal S_{DC8} extends between times t₁ and t₂, wherein time t₂ is greater than time t₁. The portion of signal S_{DC8} with the first positive active edge between times t₁ and t₂ is denoted as signal S_{DC8a}. Further, a first negative active edge of signal S_{DC8} extends between times t₂ and t₃, wherein time t₃ is greater than time t₂. The portion of signal S_{DC8} with the first negative active edge between times t₂ and t₃ is denoted as signal S_{DC8b}.

In this particular example, the difference between times t₁ and t₂ is the same as the difference between times t₂ and t₃. In this way, the length of time of the first positive active edge of signal S_{DC8} is the same as the length of time of the first negative active edge of signal S_{DC8}.

A second positive active edge of signal S_{DC8} extends between times t₃ and t₄, wherein time t₄ is greater than time t₃. The portion of signal S_{DC8} with the second positive active edge between times t₃ and t₄ is denoted as signal S_{DC8c}. Further, a second negative active edge of signal S_{DC8} extends between times t₄ and t₅, wherein time t₅ is greater than time t₄. The portion of signal S_{DC8} with the second negative active edge between times t₄ and t₅ is denoted as signal S_{DC8d}.

In this particular example, the difference between times t₃ and t₄ is the same as the difference between times t₄ and t₅. In this way, the length of time of the second positive active edge of signal S_{DC8} is the same as the length of time of the second negative active edge of signal S_{DC8}.

A third positive active edge of signal S_{DC8} extends between times t₅ and t₆, wherein time t₆ is greater than time t₅. The portion of signal S_{DC8} with the third positive active edge between times t₅ and t₆ is denoted as signal S_{DC8e}. Further, a third negative active edge of signal S_{DC8} extends between times t₆ and t₇, wherein time t₇ is greater than time t₆. The portion of signal S_{DC8} with the third negative active edge between times t₆ and t₇ is denoted as signal S_{DC8f}.

In this particular example, the difference between times t₅ and t₆ is the same as the difference between times t₆ and t₇. In this way, the length of time of the third positive active edge of signal S_{DC8} is the same as the length of time of the third negative active edge of signal S_{DC8}.

FIG. 12b is a graph 148a of an example of a digital signal S_{Digital4} shown with signal S_{DC8a} (in phantom) and S_{DC8b} (in phantom) of FIG. 12a, wherein graph 148a corresponds to voltage verses time. It should be noted that digital signal S_{Digital4} can correspond to drive signal S_{Drive} of FIG. 10. Digital signal S_{Digital4} can include a positive one value a negative one value and/or a zero value (“0”). A positive one value corresponds to a voltage value that is greater than zero volts and a negative one value corresponds to a voltage value that is less than zero volts.

In this example, signal S_{Digital4} has

a zero value (“0”) between times t₁ and t₁ₐ,

a zero value (“0”) between times t₁ₐ and t_{1b},

a zero value (“0”) between times t_{1b} and t_{1c},

a positive one value (“+1”) between times t_{1c} and t_{1d},

a zero value (“0”) between times t_{1d} and t₁ₑ,

a positive one value (“+1”) between times t₁ₑ and t_{1f},

a zero value (“0”) between times t_{1f} and t_{1g}, and

a zero value (“0”) between times t_{1g} and t₂.

As mentioned above,

time t₁ₐ is greater than time t₁,

time t_{1b} is greater than time t₁ₐ,

time t_{1c} is greater than time t_{1b},

time t_{1d} is greater than time t_{1c},

time t₁ₑ is greater than time t_{1d},

time t_{1f} is greater than time t₁ₑ,

time t_{1g} is greater than time t_{1f} and

time t₂ is greater than time t_{1g}.

Between times t₁ and t₂, signal S_{Digital4} has a duty cycle less than fifty percent (50%) because the length of time of its active edge is the less than the length of time of its deactive edge. In this particular example, the active edge of signal S_{Digital4} between times t₁ and t₂ extends between times t_{1c} and t_{1d} and times t₁ₑ and t_{1f}, wherein the active edges correspond to a positive one value (“+1”).

In this example, signal S_{Digital4} has

a zero value (“0”) between times t₂ and t₂ₐ,

a negative one value (“−1”) between times t₂ₐ and t_{2b},

a negative one value (“−1”) between times t_{2b} and t_{2c},

a zero value (“0”) between times t_{2c} and t_{2d},

a zero value (“0”) between times t_{2d} and t₂ₑ,

a negative one value (“−1”) between times t₂ₑ and t_{2f},

a zero value (“0”) between times t_{2f} and t_{2g}, and

a zero value (“0”) between times t_{2g} and t₃.

As mentioned above,

time t₂ₐ is greater than time t₂,

time t_{2b} is greater than time t₂ₐ,

time t_{2c} is greater than time t_{2b},

time t_{2d} is greater than time t_{2c},

time t₂ₑ is greater than time t_{2d},

time t_{2f} is greater than time t₂ₑ,

time t_{2g} is greater than time t_{2f} and

time t₃ is greater than time t_{2g}.

Between times t₂ and t₃, signal S_{Digital4} has a duty cycle less than fifty percent (50%) because the length of time of its negative active edge is the less than the length of time of its deactive edge. In this particular example, the negative active edge of signal S_{Digital4} between times t₂ and t₃ extends between times t₂ₐ and t_{2b}, times t_{2b} and t_{2c} and times t₂ₑ and t_{2f}, wherein the negative active edges correspond to a negative one value

FIG. 12c is a graph 148b of an example of a digital signal S_{Digital5} shown with signal S_{DC8c} (in phantom) and S_{DC8d} (in phantom) of FIG. 12a, wherein graph 148b corresponds to voltage verses time.

It should be noted that digital signal S_{Digital5} can correspond to drive signal S_{Drive} of FIG. 10. Digital signal S_{Digital5} can include a positive one value (“+1”), a negative one value (“−1”) and/or a zero value (“0”). A positive one value corresponds to a voltage value that is greater than zero volts and a negative one value corresponds to a voltage value that is less than zero volts.

In this example, signal S_{Digital5} has

a zero value (“0”) between times t₃ and t₃ₐ,

a positive one value (“+1”) between times t₃ₐ and t_{3b},

a positive one value (“+1”) between times t_{3b} and t_{3c},

a zero value (“0”) between times t_{3c} and t_{3d},

a zero value (“0”) between times t_{3d} and t₃ₑ,

a positive one value (“+1”) between times t₃ₑ and t_{3f},

a zero value (“0”) between times t_{3f} and t_{3g}, and

a zero value (“0”) between times t_{3g} and t₄.

As mentioned above,

time t₃ₐ is greater than time t₃,

time t_{3b} is greater than time t₃ₐ,

time t_{3c} is greater than time t_{3b},

time t_{3d} is greater than time t_{3c},

time t₃ₑ is greater than time t_{3d},

time t_{3f} is greater than time t₃ₑ,

time t_{3g} is greater than time t_{3f} and

time t₄ is greater than time t_{3g}.

Between times t₃ and t₄, signal S_{Digital5} has a duty cycle less than fifty percent (50%) because the length of time of its active edge is the less than the length of time of its deactive edge. In this particular example, the active edge of signal S_{Digital5} between times t₃ and t₄ extends between times t₃ₐ and t_{3b}, times

t_{3b} and t_{3c} and times t₃ₑ and t_{3f}.

In this example, signal S_{Digital5} has

a zero value (“0”) between times t₄ and t₄ₐ,

a negative one value (“−1”) between times t₄ₐ and t_{4b},

a zero value (“0”) between times t_{4b} and t_{4c},

a zero value (“0”) between times t_{4c} and t_{4d},

a zero value (“0”) between times t_{4d} and t₄ₑ,

a negative one value (“−1”) between times t₄ₑ and t_{4f},

a zero value (“0”) between times t_{4f} and t_{4g}, and

a zero value (“0”) between times t_{4g} and t₅.

As mentioned above,

time t₄ₐ is greater than time t₄,

time t_{4b} is greater than time t₄ₐ,

time t_{4c} is greater than time t_{4b},

time t_{4d} is greater than time t_{4c},

time t₄ₑ is greater than time t_{4d},

time t_{4f} is greater than time t₄ₑ,

time t_{4g} is greater than time t_{4f} and

time t₅ is greater than time t_{4g}.

Between times t₄ and t₅, signal S_{Digital5} has a duty cycle less than fifty percent (50%) because the length of time of its negative active edge is the less than the length of time of its deactive edge. In this particular example, the negative active edge of signal S_{Digital5} between times t₄ and t₅ extends between times t₄ₐ and t_{4b} and times t₄ₑ and t_{4f}, wherein the negative active edges correspond to a negative one value (“−1”).

It should be noted that the duty cycle of signal S_{Digital5} between times t₃ and t₄ is different than the duty cycle of signal S_{Digital5} between times t₄ and t₅. In this example, the duty cycle of signal S_{Digital5} between times t₃ and t₄ is greater than the duty cycle of signal S_{Digital5} between times t₄ and t₅. In other examples, the duty cycle of signal S_{Digital5} between times t₃ and t₄ is less than or equal to the duty cycle of signal S_{Digital5} between times t₄ and t₅. In this way, the duty cycle of signal S_{Digital5} between times t₃ and t₄ and the duty cycle of signal S_{Digital5} between times t₄ and t₅ are adjustable.

FIG. 12d is a graph 148c of an example of a digital signal S_{Digital6} shown with signal S_{DC8e} (in phantom) and S_{DC8f} (in phantom) of FIG. 12a, wherein graph 148c corresponds to voltage verses time. It should be noted that digital signal S_{Digital6} can correspond to drive signal S_{Drive} of FIG. 10. Digital signal S_{Digital6} can include a positive one value (“+1”), a negative one value (“−1”) and/or a zero value (“0”). A positive one value corresponds to a voltage value that is greater than zero volts and a negative one value corresponds to a voltage value that is less than zero volts.

In this example, signal S_{Digital6} has

a zero value (“0”) between times t₅ and t₅ₐ,

a zero value (“0”) between times t₅ₐ and t_{5b},

a positive one value (“+1”) between times t_{5b} and t_{5c},

a zero value (“0”) between times t_{5c} and t_{5d},

a zero value (“0”) between times t_{5d} and t₅ₑ,

a positive one value (“+1”) between times t₅ₑ and t_{5f},

a zero value (“0”) between times t_{5f} and t_{5g}, and

a zero value (“0”) between times t_{5g} and t₆.

As mentioned above,

time t₅ₐ is greater than time t₅,

time t_{5b} is greater than time t₅ₐ,

time t_{5c} is greater than time t_{5b},

time t_{5d} is greater than time t_{5c},

time t₅ₑ is greater than time t_{5d},

time t_{5f} is greater than time t₅ₑ,

time t_{5g} is greater than time t_{5f} and

time t₆ is greater than time t_{5g}.

Between times t₅ and t₆, signal S_{Digital6} has a duty cycle less than fifty percent (50%) because the length of time of its active edge is the less than the length of time of its deactive edge. In this particular example, the active edge of signal S_{Digital6} between times t₅ and t₆ extends between times t_{5b} and t_{5c} and times t₅ₑ and t_{5f}.

In this example, signal S_{Digital6} has

a zero value (“0”) between times t₆ and t₆ₐ,

a zero value (“0”) between times t₆ₐ and t_{6b},

a zero value (“0”) between times t_{6b} and t_{6c},

a negative one value (“−1”) between times t_{6c} and t_{6d},

a zero value (“0”) between times t_{6d} and t₆ₑ,

a negative one value (“−1”) between times t₆ₑ and t_{6f},

a zero value (“0”) between times t_{6f} and t_{6g}, and

a zero value (“0”) between times t_{6g} and t₇.

As mentioned above,

time t₆ₐ is greater than time t₆,

time t_{6b} is greater than time t₆ₐ,

time t_{6c} is greater than time t_{6b},

time t_{6d} is greater than time t_{6c},

time t₆ₑ is greater than time t_{6d},

time t_{6f} is greater than time t₆ₑ,

time t_{6g} is greater than time t_{6f} and

time t₇ is greater than time t_{6g}.

Between times t₆ and t₇, signal S_{Digital6} has a duty cycle less than fifty percent (50%) because the length of time of its negative active edge is the less than the length of time of its deactive edge. In this particular example, the negative active edge of signal S_{Digital6} between times t₆ and t₇ extends between times t_{6c} and t_{6d} and times t₆ₑ and t_{6f}, wherein the negative active edges correspond to a negative one value (“−1”).

It should be noted that the duty cycle of signal S_{Digital6} between times t₅ and t₆ is the same as the duty cycle of signal S_{Digital6} between times t₆ and t₇. In other examples, the duty cycle of signal S_{Digital6} between times t₅ and t₆ is different from the duty cycle of signal S_{Digital6} between times t₆ and t₇. In other examples, the duty cycle of signal S_{Digital6} between times t₅ and t₆ is greater than or less than the duty cycle of signal S_{Digital6} between times t₆ and t₇. In this way, the duty cycle of signal S_{Digital6} between times t₅ and t₆ and the duty cycle of signal S_{Digital6} between times t₆ and t₇ are adjustable.

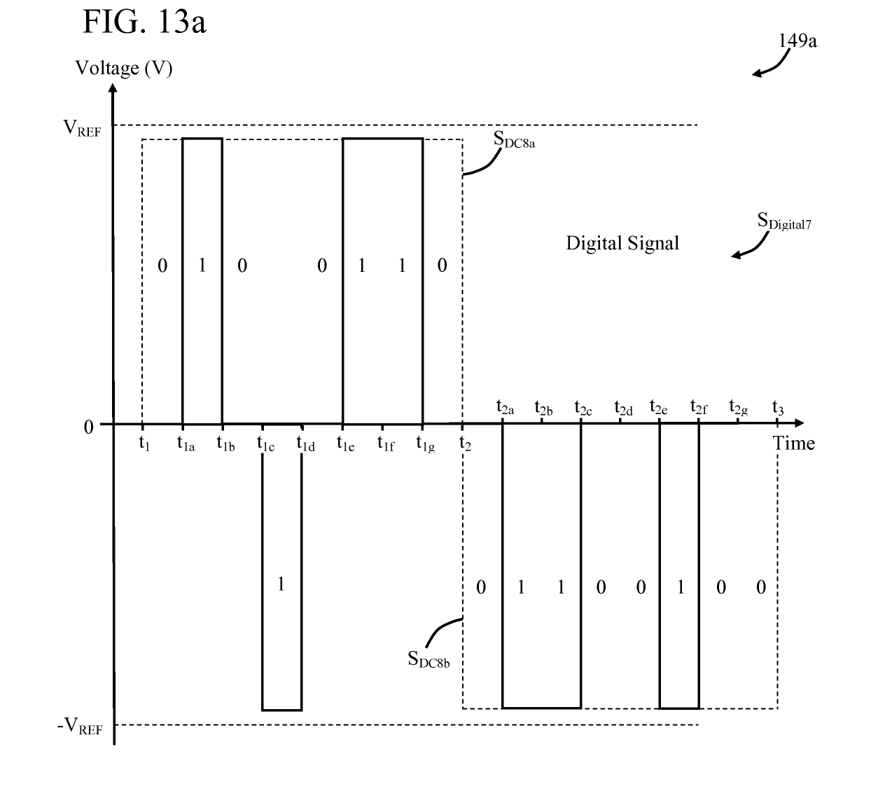

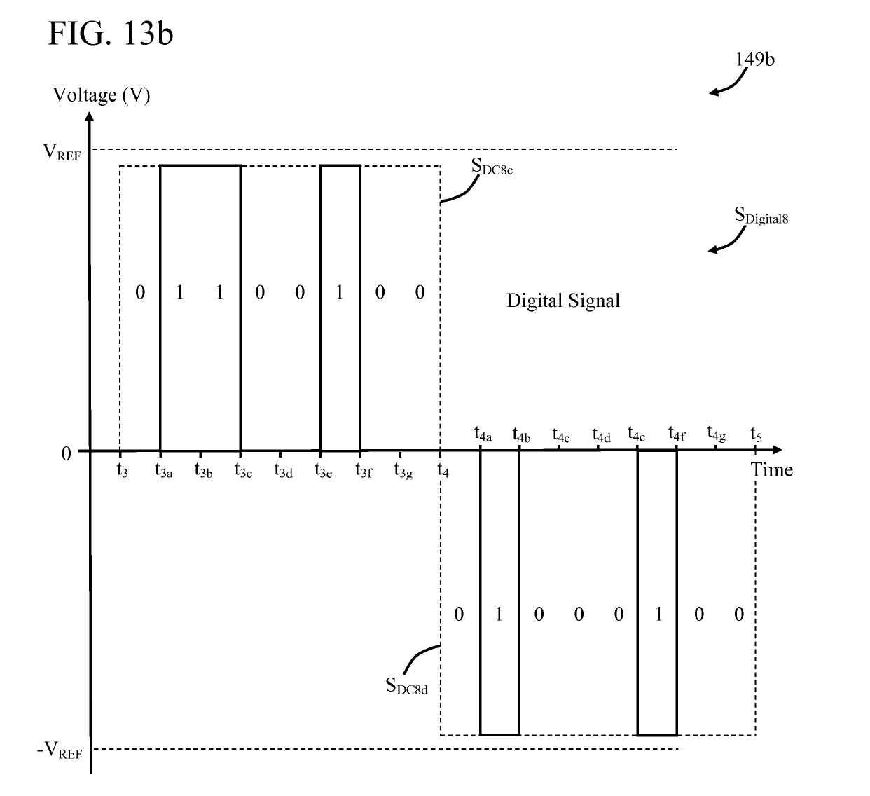

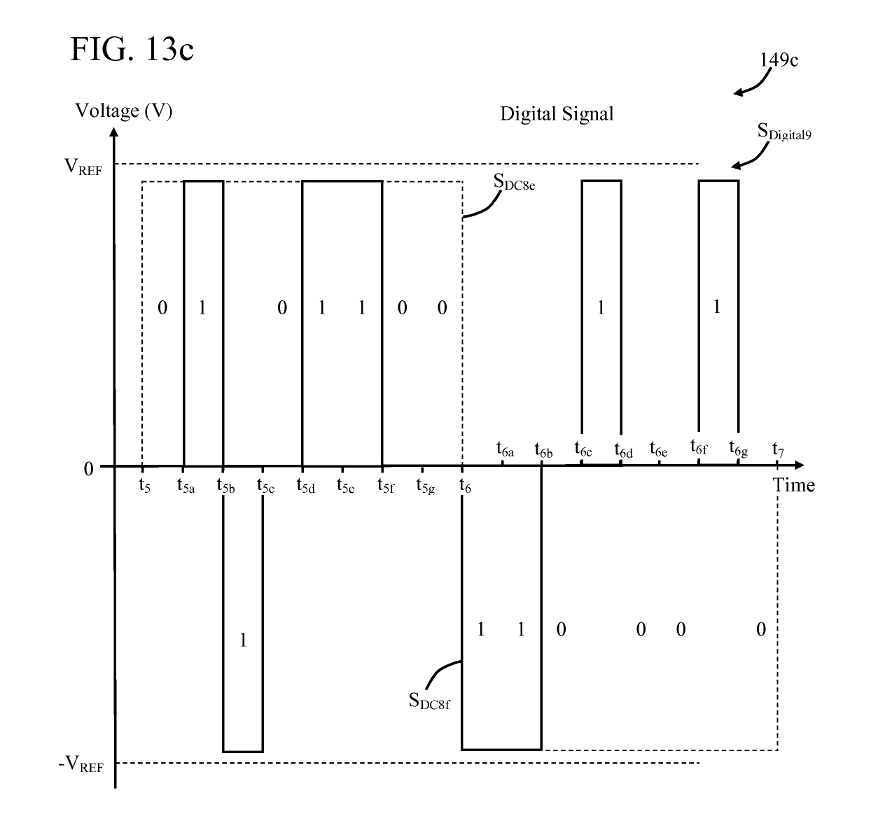

FIG. 13a is a graph 149a of an example of a digital signal S_{Digital7} shown with signal S_{DC8a} (in phantom) and S_{DC8b} (in phantom) of FIG. 12a, wherein graph 149a corresponds to voltage verses time. It should be noted that digital signal S_{Digital7} can correspond to drive signal S_{Drive} of FIG. 10. Digital signal S_{Digital7} can include a positive one value (“+1”), a negative one value (“−1”) and/or a zero value (“0”). A positive one value corresponds to a voltage value that is greater than zero volts and a negative one value corresponds to a voltage value that is less than zero volts.

In this example, signal S_{Digital7} has

a zero value (“0”) between times t₁ and t₁ₐ,

a positive one value (“+1”) between times t₁ₐ and t_{1b},

a zero value (“0”) between times t_{1b} and t_{1c},

a negative one value (“−1”) between times t_{1c} and t_{1d},

a zero value (“0”) between times t_{1d} and t₁ₑ,

a positive one value (“+1”) between times t₁ₑ and t_{1f},

a positive one value (“+1”) between times t_{1f} and t_{1g}, and

a zero value (“0”) between times t_{1g} and t₂.

As mentioned above,

time t₂ₐ is greater than time t₂,

time t_{2b} is greater than time t₂ₐ,

time t_{2c} is greater than time t_{2b},

time t_{2d} is greater than time t_{2c},

time t₂ₑ is greater than time t_{2d},

time t_{2f} is greater than time t₂ₑ,

time t_{2g} is greater than time t_{2f} and

time t₃ is greater than time t_{2g}.

Between times t₁ and t₂, signal S_{Digital7} has a duty cycle equal to fifty percent (50%) because the length of time of its positive and negative active edges is the same as the length of time of its deactive edge. In this particular example, the positive active edge of signal S_{Digital7} between times t₁ and t₂ extends between times t₁ₐ and t_{1b}, times t₁ₑ and t_{1f} and times t_{1f} and t_{1g}. Further, the negative active edge of signal S_{Digital7} between times t₁ and t₂ extends between times t_{5c} and t_{5d}.

In this example, signal S_{Digital7} has

a zero value (“0”) between times t₂ and t₂ₐ,

a negative one value (“−1”) between times t₂ₐ and t_{2b},

a negative one value (“−1”) between times t_{2b} and t_{2c},

a zero value (“0”) between times t_{2c} and t_{2d},

a zero value (“0”) between times t_{2d} and t₂ₑ,

a negative one value (“−1”) between times t₂ₑ and t_{2f},

a zero value (“0”) between times t_{2f} and t_{2g}, and

a zero value (“0”) between times t_{2g} and t₃.

As mentioned above,

time t₂ₐ is greater than time t₂,

time t_{2b} is greater than time t₂ₐ,

time t_{2c} is greater than time t_{2b},

time t_{2d} is greater than time t_{2c},

time t₂ₑ is greater than time t_{2d},

time t_{2f} is greater than time t₂ₑ,

time t_{2g} is greater than time t_{2f} and

time t₃ is greater than time t_{2g}.

Between times t₂ and t₃, signal S_{Digital7} has a duty cycle less than fifty percent (50%) because the length of time of its negative active edge is the less than the length of time of its deactive edge. In this particular example, the negative active edge of signal S_{Digital7} between times t₂ and t₃ extends between times t₂ₐ and t_{2b}, times t_{2b} and t_{2c} and times t₂ₑ and t_{2f}, wherein the negative active edges correspond to a negative one value (“−1”).

It should be noted that the duty cycle of signal S_{Digital7} between times t₁ and t₂ is different than

the duty cycle of signal S_{Digital7} between times t₁ and t₂. In this example, the duty cycle of signal S_{Digital7} between times t₁ and t₂ is greater than the duty cycle of signal S_{Digital7} between times t₂ and t₃. In other examples, the duty cycle of signal S_{Digital7} between times t₁ and t₂ is less than or equal to the duty cycle of signal S_{Digital7} between times t₂ and t₃. In this way, the duty cycle of signal S_{Digital7} between times t₁ and t₂ and the duty cycle of signal S_{Digital7} between times t₂ and t₃ are adjustable.

FIG. 13b is a graph 149b of an example of a digital signal S_{Digital8} shown with signal S_{DC8c} (in phantom) and S_{DC8d} (in phantom) of FIG. 12a, wherein graph 149b corresponds to voltage verses time. It should be noted that digital signal S_{Digital8} can correspond to drive signal S_{Drive} of FIG. 10. Digital signal S_{Digital8} can include a positive one value (“+1”), a negative one value (“−1”) and/or a zero value (“0”). A positive one value corresponds to a voltage value that is greater than zero volts and a negative one value corresponds to a voltage value that is less than zero volts.

In this example, signal S_{Digital8} has

a zero value (“0”) between times t₃ and t₃ₐ,

a positive one value (“+1”) between times t₃ₐ and t_{3b},

a positive one value (“+1”) between times t_{3b} and t_{3c},

a zero value (“0”) between times t_{3c} and t_{3d},

a zero value (“0”) between times t_{3d} and t₃ₑ,

a positive one value (“+1”) between times t₃ₑ and t_{3f},

a zero value (“0”) between times t_{3f} and t_{3g}, and

a zero value (“0”) between times t_{3g} and t₄.

As mentioned above,

time t₃ₐ is greater than time t₃,

time t_{3b} is greater than time t₃ₐ,

time t_{3c} is greater than time t_{3b},

time t_{3d} is greater than time t_{3c},

time t₃ₑ is greater than time t_{3d},

time t_{3f} is greater than time t₃ₑ,

time t_{3g} is greater than time t_{3f} and

time t₄ is greater than time t_{3g}.

Between times t₃ and t₄, signal S_{Digital8} has a duty cycle less than fifty percent (50%) because the length of time of its active edge is the less than the length of time of its deactive edge. In this particular example, the active edge of signal S_{Digital8} between times t₃ and t₄ extends between times t₃ₐ and t_{3b}, times t_{3b} and t_{3c} and times t₃ₑ and t_{3f}.

In this example, signal S_{Digital8} has

a zero value (“0”) between times t₄ and t₄ₐ,

a negative one value (“−1”) between times t₄ₐ and t_{4b},

a zero value (“0”) between times t_{4b} and t_{4c},

a zero value (“0”) between times t_{4c} and t_{4d},

a zero value (“0”) between times t_{4d} and t₄ₑ,

a negative one value (“−1”) between times t₄ₑ and t_{4f},

a zero value (“0”) between times t_{4f} and t_{4g}, and

a zero value (“0”) between times t_{4g} and t₅.

As mentioned above,

time t₄ₐ is greater than time t₄,

time t_{4b} is greater than time t₄ₐ,

time t_{4c} is greater than time t_{4b},

time t_{4d} is greater than time t_{4c},

time t₄ₑ is greater than time t_{4d},

time t_{4f} is greater than time t₄ₑ,

time t_{4g} is greater than time t_{4f} and

time t₅ is greater than time t_{4g}.

Between times t₄ and t₅, signal S_{Digital8} has a duty cycle less than fifty percent (50%) because the length of time of its negative active edge is the less than the length of time of its deactive edge. In this particular example, the negative active edge of signal S_{Digital8} between times t₄ and t₅ extends between times t₄ₐ and t_{4b} and times t₄ₑ and t_{4f}, wherein the negative active edges correspond to a negative one value (“−1”).

It should be noted that the duty cycle of signal S_{Digital8} between times t₃ and t₄ is different than the duty cycle of signal S_{Digital8} between times t₄ and t₅. In this example, the duty cycle of signal S_{Digital8} between times t₃ and t₄ is greater than the duty cycle of signal S_{Digital8} between times t₄ and t₅. In other examples, the duty cycle of signal S_{Digital8} between times t₃ and t₄ is less than or equal to the duty cycle of signal S_{Digital8} between times t₄ and t₅. In this way, the duty cycle of signal S_{Digital8} between times t₃ and t₄ and the duty cycle of signal S_{Digital8} between times t₄ and t₅ are adjustable.

FIG. 13c is a graph 149c of an example of a digital signal S_{Digital9} shown with signal S_{DC8e} (in phantom) and S_{DC8f} (in phantom) of FIG. 12a, wherein graph 149c corresponds to voltage verses time. It should be noted that digital signal S_{Digital9} can correspond to drive signal S_{Drive} of FIG. 10. Digital signal S_{Digital9} can include a positive one value (“+1”), a negative one value (“−1”) and/or a zero value

(“0”). A positive one value corresponds to a voltage value that is greater than zero volts and a negative one value corresponds to a voltage value that is less than zero volts.

In this example, signal S_{Digital9} has

a zero value (“0”) between times t₅ and t₅ₐ,

a positive one value (“+1”) between times t₅ₐ and t_{5b},

a negative one value (“−1”) between times t_{5b} and t_{5c},

a zero value (“0”) between times t_{5c} and t_{5d},

a positive one value (“+1”) between times t_{5d} and t₅ₑ,

a positive one value (“+1”) between times t₅ₑ and t_{5f},

a zero value (“0”) between times t_{5f} and t_{5g}, and

a zero value (“0”) between times t_{5g} and

As mentioned above,

time t₅ₐ is greater than time t₅,

time t_{5b} is greater than time t₅ₐ,

time t_{5c} is greater than time t_{5b},

time t_{5d} is greater than time t_{5c},

time t₅ₑ is greater than time t_{5d},

time t_{5f} is greater than time t₅ₑ,

time t_{5g} is greater than time t_{5f} and

time t₆ is greater than time t_{5g}.

Between times t₅ and t₆, signal S_{Digital9} has a duty cycle equal to fifty percent (50%) because the length of time of its positive and negative active edges is the same as the length of time of its deactive edge. In this particular example, the positive active edge of signal S_{Digital9} between times t₅ and t₆ extends between times t₅ₐ and t_{5b}, times t_{5d} and t₅ₑ and times t₅ₑ and t_{5f}. Further, the negative active edge of signal S_{Digital9} between times t₅ and t₆ extends between times t_{5b} and t_{5c}.

In this example, signal S_{Digital9} has

a negative one value (“−1”) between times t₆ and t₆ₐ,

a negative one value (“−1”) between times t₆ₐ and t_{6b},

a zero value (“0”) between times t_{6b} and t_{6c},

a positive one value (“+1”) between times t_{6c} and t_{6d},

a zero value (“0”) between times t_{6d} and t₆ₑ,

a zero value (“0”) between times t₆ₑ and t_{6f},

a positive one value (“+1”) between times t_{6f} and t_{6g}, and

a zero value (“0”) between times t_{6g} and t₇.

As mentioned above,

time t₆ₐ is greater than time t₆,

time t_{6b}, is greater than time t₆ₐ,

time t_{6c} is greater than time t_{6b},

time t_{6d} is greater than time t_{6c},

time t₆ₑ is greater than time t_{6d},

time t_{6f} is greater than time t₆ₑ,

time t_{6g} is greater than time t_{6f} and

time t₇ is greater than time t_{6g}.

Between times t₆ and t₇, signal S_{Digital9} has a duty cycle equal to fifty percent (50%) because the length of time of its positive and negative active edges is the same as the length of time of its deactive edge. In this particular example, the positive active edge of signal S_{Digital9} between times t₆ and t₇ extends between times t_{6c} and t₆ₐ and times t₆ₑ and t_{6f}, wherein the positive active edges correspond to a positive one value (“+1”). Further, the negative active edge of signal S_{Digital9} between times t₆ and t₇ extends between times t₆ and t₆ₐ and times t₆ₐ and t_{6b}, wherein the negative active edges correspond to a negative one value (“−1”).

It should be noted that the duty cycle of signal S_{Digital9} between times t₅ and t₆ is the same as the duty cycle of signal S_{Digital9} between times t₆ and t₇. In other examples, the duty cycle of signal S_{Digital9} between times t₅ and t₆ is different from the duty cycle of signal S_{Digital9} between times t₆ and t₇. In other examples, the duty cycle of signal S_{Digital9} between times t₅ and t₆ is greater than or less than the duty cycle of signal S_{Digital6} between times t₆ and t₇. In this way, the duty cycle of signal S_{Digital9} between times t₅ and t₆ and the duty cycle of signal S_{Digital9} between times t₆ and t₇ are adjustable.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. An apparatus comprising:
a controller circuit;
a drive circuit configured to:
receive a control signal from the controller circuit, wherein the control signal includes a first portion for a first light intensity and a second portion for a second light intensity, and
generate a composite drive signal including a first waveform greater than a zero voltage and a second waveform less than a zero voltage, wherein the first waveform is based on the first portion of the control signal and the second waveform is based on the second portion of the control signal; and
a load circuit coupled to the drive circuit and configured to illumine a first portion of a light emitting device based on the first waveform and illumine a second portion of the light emitting device based on the second waveform.
